(19) United States
(12) Patent Application Publication
(10) Pub. No.: US 2018/0339950 A1
(43) Pub. Date: Nov. 29, 2018

(54) MINERAL COMPLEX, COMPOSITIONS, METHODS OF MAKING, AND USES THEREIN

(71) Applicant: Heart of Nature (NV), LLC, Henderson, NV (US)

(72) Inventors: W.L. Skip Tyler, Bakersfield, CA (US); Jerry Tyler, Bakersfield, CA (US)

(21) Appl. No.: 15/994,980

(22) Filed: May 31, 2018

Related U.S. Application Data
(63) Continuation of application No. 14/906,883, filed on Jan. 21, 2016, now abandoned.
(60) Provisional application No. 61/867,811, filed on Aug. 20, 2013.
(60) Provisional application No. 61/866,760, filed on Aug. 16, 2013.
(60) Provisional application No. 61/860,741, filed on Jul. 31, 2013.
(60) Provisional application No. 61/860,774, filed on Jul. 31, 2013.
(60) Provisional application No. 61/860,785, filed on Jul. 31, 2013.

(51) Int. Cl. C05D 1/02; C05G 3/02; C05G 3/00; C05D 3/00; C05F 11/08; C05G 1/00; A01N 59/02; C05C 9/00; C05B 17/02; A01N 63/00; A01N 61/00; C05D 9/00; C05D 9/02; C05F 11/00; A01N 25/12; A01N 59/16; A01N 59/20; A01N 25/04; A01N 65/00; A01N 65/26

(52) U.S. Cl. CPC C05D 1/02; C05G 3/02; A01N 65/26; C05D 3/00; C05F 11/08; C05G 1/00; A01N 59/02; C05C 9/00; C05B 17/02; A01N 63/00; A01N 61/00; C05D 9/00; C05D 9/02; C05F 11/00; A01N 25/12; A01N 59/16; A01N 59/20; A01N 2300/00; A01N 25/04; A01N 65/00; C05G 3/0011

(57) ABSTRACT

The present invention relates to agriculture and fertilization. In particular, compositions and methods relating to soil amendments, crop fertilization, plant fertilizers, organic waste management, and biocidal mixtures used to kill or inhibit fungi or fungal spores, molds, and mildews, and/or insect infestations applicable for treating crops are provided. In certain aspects, soil amendments, methods of making soil amendments, methods for improving crop yields, and methods for decreasing pathogens are provided. In certain aspects, compositions and methods relating to biocidal mixtures used inhibit, ameliorate, or treat a plant for insect infestation and/or fungal disease, such as scab, powdery mildew, downy mildew, rust, Roya Fungus, blight, brown rot, leaf spots, mites, flies, scales, psyllids are provided. In certain aspects compositions and methods relating to treating hazardous material, such as the release of a liquid petroleum hydrocarbon into the environment are provided.

### CROSS-REFERENCE TO RELATED APPLICATIONS

This application is a continuation application of U.S. patent application Ser. No. 14/906,883 filed Jan. 21, 2016, which is a continuation of International Patent Application No. PCT/US2014/048423 filed Jul. 28, 2014, which claims priority benefit of each of U.S. Provisional Patent Application No. 61/867,811 filed Aug. 20, 2013, U.S. Provisional Patent Application No. 61/866,760 filed Aug. 16, 2013, U.S. Provisional Patent Application No. 61/860,741 filed Jul. 31, 2013, U.S. Provisional Patent Application No. 61/860,774 filed Jul. 31, 2013, and U.S. Provisional Patent Application No. 61/860,785 filed Jul. 31, 2013, the disclosures of which are incorporated herein by reference in their entirety.

### FIELD OF THE INVENTION

Aspects of the present invention relate to agriculture, fertilization, and remediation of soil contaminated with petroleum products. In particular, compositions and methods relating to soil amendments, plant fertilizers, biocidal mixtures, which effectively kill or inhibit fungi or fungal spores, molds, and mildews, and/or insects, and approaches to treat and/or ameliorate the environmental impact caused by the release of a petroleum hydrocarbon product are described herein.

### BACKGROUND

Fertilizer is a material that is added to a plant or soil to supply one or more plant nutrients essential or helpful in plant growth. It is estimated that commercial fertilizer is responsible for 30% to 50% of crop yields. Fertilizers typically provide, in varying proportions macronutrients and micronutrients. Macronutrients are named because they are consumed in larger quantities and present in plant tissue in larger quantities than are micronutrients. Macronutrients typically include: Nitrogen (“N”); Phosphorus (“P”); Potassium (“K”); Calcium (“Ca”); Magnesium (“Mg”); and Sulfur (“S”). Macronutrients that are required by all plants but are not generally supplied through fertilization are: Carbon (“C”); Hydrogen (“H”) and Oxygen (“O”). These three macronutrients are supplied by Carbon Dioxide (CO₂) and water (“H₂O”) present in the atmosphere. Micronutrients typically include: Boron (“B”); Chlorine (“Cl”); Copper (“Cu”); Iron (“Fe”); Manganese (“Mn”); Molybdenum (“Mo”); Zinc (“Zn”); and Nickel (“Ni”). Certain ratios of these components provide nutrients that aid a plant's growth. Plants readily absorb their required nutrients if the nutrients are present in a bioavailable form and the soil is in a condition that supports plant growth (e.g., the soil has a pH appropriate for the assimilation of nutrients for the particular plant).

Traditional fertilizers are generally good for most plants, but the nutrients fertilizers provide to plants can also cause damage if the fertilizer is applied incorrectly. Fertilizer burn can occur, for example, when too much fertilizer is applied or the fertilizer is applied too close to the plant. Fertilizer burn stems from the accumulation of excess nitrogen salts (or other excess salts present in the soil). When fertilizer burn occurs, the plant may have orange or brown tinges on its leaf as if it were scorched. This is due to the desiccation of plant tissues resulting from osmotic stress, creating a state of hypertonicity. Additionally, misuse of fertilizer can result in a lower quality crop, can attract pests, and can promote the onset of many types of plant disease. Accordingly, there is a need for improved fertilizers or soil amendments and methods of applying such fertilizers or soil amendments to plants or soil.

Soil has many natural minerals or nutrients that are essential to plants. However, most of these nutrients are in a form that is inaccessible to plants. Additionally, fertilizers applied incorrectly may bind with substances in the soil, making the nutrients present in the fertilizer unavailable to plants. Accordingly, there is a need for improved fertilizers or soil amendments that increase the bioavailability of nutrients present in the soil and/or nutrients present in fertilizers and methods of applying such fertilizers or soil amendments to plants or soil.

Biocidal chemical compounds, also referred to as fungicides and pesticides, are used to kill or inhibit the proliferation of fungi, molds, mildews, and insects. Fungi and insect infestation cause tremendous damage to a plant's roots, stem, and leaves resulting in significant loss in yield, quality, and agricultural profit. Current biocidal mixtures are sold in liquid or powder form and one of the most common active ingredients is sulfur. Copper sulfate, for example, is a well-accepted fungicide for agricultural applications despite the fact that many fungi readily adapt to the elevated concentrations of copper. Other common active ingredients in biocidal mixtures include oils and soaps, such as, neem oil, rosemary oil, jojoba oil, or Potassium salts of fatty acids. Bacteria, such as Bacillus thuringiensis, also have insecticidal properties. Current biocidal mixtures used on crops, plants, and vegetation leave residues that is found on food for human consumption and some can be dangerous to human health. Additionally, many biocidal mixtures lose their efficacy in killing or inhibiting fungi or fungal spores because the targeted pathogens have developed a resistance to them. Accordingly, there is a need for improved biocidal mixtures and methods of applying biocidal mixtures to crops, plants, and/or vegetation.

An oil spill is the release of a liquid petroleum hydrocarbon product into the environment. Oil spills may be due to the byproduct of oil-powered automobiles, tractors, or other vehicles. Oil spills may also be due to releases of crude oil or refined petroleum products from machines such as tankers, offshore platforms, drilling rigs and oil wells, as well as, spills or leaks that occur during the oil or gas recovery process such as leaks caused by utilization of fracking procedures.

An oil spill is a form of pollution that has severe and harmful effects on the environment. Oil spills can harm animals by penetrating bird plumage and mammalian fur, reducing its insulating ability and making the animal more vulnerable to temperature fluctuations. Additionally, it can blind animals, confuse their sense of smell, and/or poison them leaving them defenseless and/or dead. An oil spill can also harm humans due to its poisonous nature. Human populations exposed to spilled oils, especially those individuals involved in the cleanup, experience severe and adverse health effects. If oil contacts the skin, it can cause irritation such as redness, swelling, or burning. The fumes released from the oil causes severe headaches, nausea, vomiting, confusion, dizziness, faintness, respiratory problems, shortness of breath, coughing, sore throat, and/or burning eyes. Additionally, if oil is ingested then it can cause nausea, vomiting, and diarrhea. Moreover, oil is incredibly bad for growth of plants, crops, and other vegetation. Oil spills can reduce crop yield and land productivity by rendering the soil toxic and unproductive. The oil reduces the amount of essential nutrients available for plant and crop utilization and/or renders the nutrients unavailable to the plants or crops. Additionally, the crops and vegetation can pick up heavy metals from the oil making them unsuitable for human consumption.

Traditional methods of cleaning oil spills are messy, hazardous, and environmentally threatening. For example, oil spills in water may be cleaned by containment and skimming, however this requires a significant amount of human labor and necessitates human exposure to toxic materials and gases. Oil spills on land or water may be cleaned by bioremediation, such as chemicals and biological agents, however, the current methods of bioremediation require a significant amount of time during which plants and/or animals may be harmed and many require disposal of toxic waste. Accordingly, there is a need for improved approaches for ameliorating and/or treating oil spills, preferably, which do not require disposal of toxic waste.

### SUMMARY

It has been discovered that by mixing or blending or, in some aspects coating, a granule, pellet, powder, prill, or a liquid suspension comprising a plant nutrient with a “mineral complex” (herein after referring to a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel), the release and absorption of the plant nutrient can be controlled, regulated (e.g., time released), and/or improved. Accordingly, the improved fertilizers and/or soil amendments described herein, which have reduced volatility or decomposition of the plant nutrients, provide for better distribution and absorption of the plant nutrients. The reduced volatility or decomposition of the fertilizer, as well as, the improved absorption of the plant nutrients afforded by aspects of the present invention also provides for better plant growth and higher plant yields and allows one to apply less fertilizer yet receive the same plant growth and crop yield as one would experience with greater amounts of fertilizer.

Some embodiments concern a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a plant nutrient, wherein said fertilizer or soil amendment is in a granule, pellet, powder, prill, or a liquid suspension. Preferably, the fertilizer or soil amendment is a granule, pellet, or prill comprising the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and the plant nutrient. Preferably, the aforementioned fertilizer or soil amendment and/or the granule, pellet, powder, prill, or liquid suspension comprising a plant nutrient does not contain a plant material, such as plant fiber, green waste, manure, and/or organic waste.

In more embodiments, the aforementioned granule, pellet, powder, prill, or liquid suspension comprising the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel also comprises urea, phosphate, phosphorous, humate, humic acid, humin and/or fulvic acid or any combination thereof. In more embodiments, the granule, pellet, powder, prill, or liquid suspension comprising the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel also comprises nitrogen (N), such as ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), such as potash or any combination thereof. In more embodiments, the fertilizer or soil amendment that comprises the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or liquid suspension comprising a plant nutrient further comprises a Thiobacillus species. The granule, pellet, powder, prill, or liquid suspension comprising the plant nutrient can be mixed or co-formulated with said mineral complex to form the fertilizer or soil amendment in certain embodiments.

Additionally, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel can be coated on or can be included within a granule, pellet, powder, or prill comprising the plant nutrient, such as nitrogen (N), including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, potassium (K), including potash, humate, humic acid, humin and/or fulvic acid or any combination thereof. In more embodiments, the fertilizer or soil amendment has a first coating, such as a polymer, surfactant, sugar, starch, fat, fatty acid, cellulose, soap, or wax. In some embodiments, the first coating prevents contact of the mineral complex with the granule, pellet, powder, prill, or liquid suspension comprising the plant nutrient. In more embodiments, the first coating covers the mineral complex and the granule, pellet, powder, prill, or the liquid suspension comprising the plant nutrient. In other embodiments, a second coating covers the mineral complex and the granule, pellet, powder, prill, or the liquid suspension comprising the plant nutrient. The second coating can be different from the first coating. The second coating can also be the same as the first coating.

In more embodiments, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or the liquid suspension comprising the plant nutrient is blended or coated in a w/w 1:1 mix, a w/w 1:2 mix, or a w/w 1:3 mix.

In more embodiments, the amount of the plant nutrient that is provided with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

In more embodiments, the granule, pellet, powder, prill, or the liquid suspension comprising the plant nutrient that is mixed blended or coated with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel further comprises Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. Additionally, in more embodiments, the granule, pellet, powder, prill, or the liquid suspension comprising the plant nutrient that is mixed blended or coated with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel further comprises urea. In some aspects of these embodiments, the aforementioned mineral complex is mixed with the urea, coated on the urea, or blended with the urea. In still more embodiments, the granule, pellet, powder, prill, or the liquid suspension comprising the plant nutrient that is mixed blended or coated with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel comprises humate, humic acid, humin, fulvic acid, nitro humic acid, potassium humate, sodium humate, and/or potassium fulvate or any combination thereof.

Some embodiments provide, a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension of Phosphorous (P), Phosphate (P₂O₅), urea, humate, humic acid, humin, fulvic acid, nitro humic acid, potassium humate, sodium humate, and/or potassium fulvate or any combination thereof, wherein said fertilizer or soil amendment is, preferably but not necessarily, in a granule, pellet, powder, prill, or a liquid suspension.

In some embodiments, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is provided with a Phosphorous (P), Phosphate (P₂O₅), urea, humate, humic acid, humin, fulvic acid, nitro humic acid, potassium humate, sodium humate, and/or potassium fulvate or any combination thereof that is in an isolated form or a free form or is in a form free from plant material, such as plant fiber, green waste, manure, and/or organic waste. In more embodiments, the fertilizer or soil amendment comprising the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and a granule, pellet, powder, prill, or a liquid suspension of Phosphorous (P), Phosphate (P₂O₅), urea, humate, humic acid, humin, fulvic acid, nitro humic acid, potassium humate, sodium humate, and/or potassium fulvate or any combination thereof does not contain a plant material, such as plant fiber, green waste, manure, and/or organic waste. In more embodiments, the aforementioned fertilizer or soil amendment that comprise the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or the liquid suspension of Phosphorous (P), Phosphate (P₂O₅), urea, humate, humic acid, humin, fulvic acid, nitro humic acid, potassium humate, sodium humate, and/or potassium fulvate or any combination thereof further comprises a Thiobacillus species.

In some embodiments, urea is mixed, blended, or co-formulated with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. In other embodiments, the aforementioned mineral complex is coated on the Phosphorous (P), Phosphate (P₂O₅), urea, humate, humic acid, humin, fulvic acid, nitro humic acid, potassium humate, sodium humate, and/or potassium fulvate, such as by tumbling the Phosphorous (P), Phosphate (P₂O₅), urea, humate, humic acid, humin, fulvic acid, nitro humic acid, potassium humate, sodium humate, and/or potassium fulvate or any combination thereof e.g., by spray drying the urea with the mineral complex e.g., during a tumbling procedure. In more embodiments, the fertilizer or soil amendment comprising the mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel also comprises has a first coating, such as a polymer, surfactant, sugar, starch, fat, fatty acid, cellulose, soap, or wax e.g., a first coating configured to allow for water resistance and/or time delayed dissentigration. In more embodiments, a first coating of the mineral complex, such as by a polymer, surfactant, sugar, starch, fat, fatty acid, cellulose, soap, or wax, is configured to prevent contact of said mineral complex with a plant nutrient comprising Phosphorous (P), Phosphate (P₂O₅), urea, humate, humic acid, humin, fulvic acid, nitro humic acid, potassium humate, sodium humate, and/or potassium fulvate or any combination thereof. In different embodiments, the first coating covers both said mineral complex and urea and said mineral complex and said urea are mixed and/or co-formulated. In more embodiments, a first coating covers both said mineral complex and a plant nutrient comprising Phosphorous (P), Phosphate (P₂O₅), urea, humate, humic acid, humin, fulvic acid, nitro humic acid, potassium humate, sodium humate, and/or potassium fulvate or any combination thereof. In different embodiments, a first coating covers a portion of said mineral complex and urea and a second coating covers a second portion of said mineral complex and said urea and both portions of mineral complex and urea are mixed and/or co-formulated into a unitary or single granule, pellet, powder, prill, or a liquid suspension. In different embodiments, a first coating covers a portion of said mineral complex and a plant nutrient comprising Phosphorous (P), Phosphate (P₂O₅), urea, humate, humic acid, humin, fulvic acid, nitro humic acid, potassium humate, sodium humate, and/or potassium fulvate or any combination thereof and a second coating covers a second portion of said mineral complex and said plant nutrient comprising Phosphorous (P), Phosphate (P₂O₅), urea, humate, humic acid, humin, fulvic acid, nitro humic acid, potassium humate, sodium humate, and/or potassium fulvate or any combination thereof and both portions of mineral complex and plant nutrient are mixed and/or co-formulated into a unitary or single granule, pellet, powder, prill, or a liquid suspension. In some embodiments, the second coating is different from the first coating. In some embodiments, the second coating is the same as the first coating. In more embodiments, a first coating covers both said mineral complex and a plant nutrient comprising Phosphorous (P), Phosphate (P₂O₅), urea, humate, humic acid, humin, fulvic acid, nitro humic acid, potassium humate, sodium humate, and/or potassium fulvate or any combination thereof. In some embodiments, the second coating is different from the first coating. In some embodiments, the second coating is the same as the first coating.

In other embodiments, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or the liquid suspension of Phosphorous (P), Phosphate (P₂O₅), urea, humate, humic acid, humin, fulvic acid, nitro humic acid, potassium humate, sodium humate, and/or potassium fulvate or any combination thereof are blended or coated in a w/w 1:1 mix, a w/w 1:2 mix, or a w/w 1:3 mix.

In other embodiments, the amount of Phosphorous (P), Phosphate (P₂O₅), urea, humate, humic acid, humin, fulvic acid, nitro humic acid, potassium humate, sodium humate, and/or potassium fulvate or any combination thereof provided with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel comprises at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of the fertilizer or soil amendment.

In some embodiments, the fertilizer or soil amendment comprising the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or the liquid suspension of urea further includes humate, humic acid, humin, fulvic acid, and/or phosphorous (P) or phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof.

Aspects of the invention also include methods of making the fertilizer or soil amendment of any of the aforementioned compositions including, for example, methods practiced by providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; providing a plant nutrient, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin and/or fulvic acid or any combination thereof contacting said mineral complex with said plant nutrient; and generating a granule, pellet, prill, powder, or a liquid suspension that comprises said mineral complex and said plant nutrient. Optionally, during formation of such a granule, pellet, or prill or after such a granule, pellet, or prill is formed, a first and/or second coating, such as a polymer, surfactant, sugar, starch, fat, fatty acid, cellulose, soap, or wax is added. In some embodiments, once the coated granules are formed, they are added to a liquid formulation.

In some embodiments, these methods further include or are characterized by coating the granule, pellet, powder, or prill comprising a plant nutrient with the mineral complex. In more embodiments, the methods include or are characterized by coating a granule, pellet, powder, or prill comprising said mineral complex with a plant nutrient. In still more embodiments, the methods include or are characterized by contacting said mineral complex and/or the plant nutrient with a first coating, such as a polymer, surfactant, sugar, starch, fat, fatty acid, cellulose, soap, or wax.

In some embodiments, the methods include or are characterized by coating the plant nutrient with a first coating, such as a polymer, surfactant, sugar, starch, fat, fatty acid, cellulose, soap, or wax. In some embodiments, the aforementioned mineral complex is coated with the first coating, such as a polymer, surfactant, sugar, starch, fat, fatty acid, cellulose, soap, or wax. In some embodiments, the methods include or are characterized by coating said mineral complex and the granule, pellet, powder, prill or liquid suspension comprising the plant nutrient with a second coating that covers both the mineral complex and the plant nutrient. In more embodiments, the second coating is different from the first coating. In more embodiments, the second coating is the same as the first coating.

In some embodiments, the method includes or is characterized by having a granule, pellet, powder, prill or liquid suspension comprising the plant nutrient that comprises nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin and/or fulvic acid or any combination thereof.

Still more embodiments relate to methods or uses of any one or more of the fertilizers or soil amendments provided above (e.g., a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising a plant nutrient, such as Phosphorous (P), Phosphate (P₂O₅), urea, humate, humic acid, humin, fulvic acid, nitro humic acid, potassium humate, sodium humate, and/or potassium fulvate, or any combination thereof wherein said fertilizer or soil amendment is, preferably but not necessarily, in a granule, pellet, powder, prill, or a liquid suspension) to promote plant growth or to improve crop yield. These methods or uses can be practiced by providing a fertilizer or soil amendment as set forth above, for example, and contacting a soil or plant with said fertilizer or soil amendment.

It has been discovered that by mixing or blending or, in some aspects coating, a granule, pellet, powder, prill, or a liquid suspension comprising Humate, Humic acid, Humin, and/or Fulvic acid with a mineral complex (e.g., a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel), the ability of the plant to absorb nutrients present in the soil is improved resulting in an improved plant yield, as determined by sugar content, crop weight, etc. Accordingly, improved fertilizers or soil amendments having increased absorption of nutrients are obtained. The reduced volatility or decomposition of the fertilizer, as well as, the improved absorption of nutrients present in the soil afforded by aspects of the present invention allows for better plant growth and higher plant yields and enables one to apply less fertilizer yet receive the same plant growth and crop yield as one would experience with greater amounts of fertilizer.

According to the present invention, there is provided a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof, wherein said fertilizer or soil amendment is in a granule, pellet, powder, prill, or a liquid suspension.

In more embodiments, the fertilizer or soil amendment and/or granule, pellet, powder, prill, or a liquid suspension comprising Humate, Humic acid, Humin, and/or Fulvic acid does not contain a plant material, such as plant fiber, cellulose, green waste, manure, and/or organic waste or said granule, pellet, powder, prill, or a liquid suspension comprising Humate, Humic acid, Humin, and/or Fulvic acid or any combination thereof is in an isolated form.

In more embodiments, the fertilizer or soil amendment also comprises nitrogen (N), such as Ammonium Nitrate (33.5-0-0), Ammonium Sulfate (21-0-0), Urea Nitrogen (46-0-0), Sodium Nitrate (16-0-0); Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or Potassium, such as Potash.

In more embodiments, the fertilizer or soil amendment that comprises the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate or any combination thereof, further comprises a Thiobacillus species.

In one embodiment, the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate is mixed with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel to form the fertilizer or soil amendment. In another embodiment, said mineral complex is coated on the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate and/or the granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof is coated on said mineral complex.

In more embodiments, the fertilizer or soil amendment has a first coating, such as a polymer, surfactant, sugar, starch, fat, fatty acid, cellulose, soap, or wax. The first coating prevents contact of the mineral complex with the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof. In more embodiments, the first coating covers the mineral complex and the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof.

In other embodiments, a second coating covers both the mineral complex and the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof. In another embodiment, the second coating is different from the first coating. In some embodiments the second coating is the same as the first coating.

In more embodiments, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof are blended or coated in a w/w 1:1 mix, in a w/w 1:2 mix, or in a w/w 1:3 mix.

In more embodiments, the amount of the Humate, Humic acid, Humin, and/or Fulvic acid, such as humate, humic acid, humin, fulvic acid, nitro humic acid, potassium humate, sodium humate, and/or potassium fulvate or any combination thereof that is provided with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

In more embodiments, the granule, pellet, powder, prill, or liquid suspension comprising Humate, Humic acid, Humin, and/or Fulvic acid comprises humate, humic acid, humin, fulvic acid, nitro humic acid, potassium humate, sodium humate, and/or potassium fulvate or any combination thereof.

Aspects of the invention also comprise methods of making the fertilizer or soil amendments of any of the aforementioned compositions including, for example, methods practiced by providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; providing a granule, pellet, powder, prill, or a liquid suspension comprising Humate, Humic acid, Humin, and/or Fulvic acid including humate, humic acid, humin, fulvic acid, nitro humic acid, potassium humate, sodium humate, and/or potassium fulvate or any combination thereof, contacting the mineral complex with the granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof; and generating a granule, pellet, powder, or a liquid suspension that comprises the mineral complex and the granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof.

In some embodiments, these methods further comprise or are characterized by coating the granule, pellet, powder, or prill comprising Humate, Humic acid, Humin, and/or Fulvic acid, such as humate, humic acid, humin, fulvic acid, nitro humic acid, potassium humate, sodium humate, and/or potassium fulvate or any combination thereof with the mineral complex. In more embodiments, the methods comprise or are characterized by coating the mineral complex with the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof. In still more embodiments, the methods comprise or are characterized by contacting said mineral complex and/or said granule, pellet, powder, prill or liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof with a first coating, such as a polymer, surfactant, sugar, starch, fat, fatty acid, cellulose, soap, or wax.

In some embodiments, the methods comprise or are characterized by coating the mineral complex with the first coating, such as a polymer, surfactant, sugar, starch, fat, fatty acid, cellulose, soap, or wax. In some embodiments, the aforementioned mineral complex is coated with the first coating, such as a polymer, surfactant, sugar, starch, fat, fatty acid, cellulose, soap, or wax. In some embodiments, the methods comprise or are characterized by coating said mineral complex and the granule, pellet, powder, prill or liquid suspension comprising the Humate, Humic acid, Humin, and/or Fulvic acid, such as humate, humic acid, humin, fulvic acid, nitro humic acid, potassium humate, sodium humate, and/or potassium fulvate or any combination thereof with a second coating that covers both the mineral complex and granule, pellet, powder, prill or liquid suspension comprising the Humate, Humic acid, Humin, and/or Fulvic acid, such as humate, humic acid, humin, fulvic acid, nitro humic acid, potassium humate, sodium humate, and/or potassium fulvate or any combination thereof. In more embodiments, the second coating is different from the first coating. In more embodiments, the second coating is the same as the first coating.

In some embodiments, the method comprises or is characterized by adding a granule, pellet, powder, prill or liquid suspension comprising Humate, Humic acid, Humin, and/or Fulvic acid, such as humate, humic acid, humin, fulvic acid, nitro humic acid, potassium humate, sodium humate, and/or potassium fulvate that comprises nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate and/or potassium, including potash, or any combination thereof the forementioned compositions to the soil or a soil amendment.

Still more embodiments relate to methods or uses of any one or more of the fertilizers or soil amendments provided above (e.g., a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof, wherein said fertilizer or soil amendment is, preferably but not necessarily, in a granule, pellet, powder, prill, or a liquid suspension) to amend a soil, to increase the bioavailability of plant nutrients in a soil, and/or to promote plant growth. These methods or uses can be practiced by providing a fertilizer or soil amendment as set forth above, for example, and contacting a soil or plant with the fertilizer or soil amendment.

Some embodiments relate to methods or uses of any one or more of the fertilizers or soil amendments provided above (e.g., a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate or any combination thereof, wherein said fertilizer or soil amendment is, preferably but not necessarily, in a granule, pellet, powder, prill, or a liquid suspension) to amend a soil, to reduce pathogens and/or odor in a poultry house or swine pen. These methods or uses can be practiced by providing a fertilizer or soil amendment as set forth above, for example, and contacting a soil or plant with the fertilizer or soil amendment.

It has also been discovered that by mixing or blending or, in some aspects coating, a granule, pellet, powder, prill, or a liquid suspension comprising Phosphorous (P) or Phosphate (P₂O₅) (e.g., soft rock Phosphate, monoammonium Phosphate, or diammonium Phosphate) or any combination thereof with a mineral complex (e.g., a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel), the ability of the plant to absorb the Phosphorus is improved resulting in improved plant growth and/or crop yield, as determined by e.g., sugar content, crop yield or fruit weight, leafing, or plant size. Accordingly, improved fertilizers or soil amendments comprising, consisting of, or consisting essentially of a Phosphorous or Phosphate (e.g., soft rock Phosphate, Monoammonium Phosphate, or Diammonium Phosphate) or any combination thereof and a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel are provided herein. These fertilizer or soil amendments are embodiments of the present invention and can be used to increase the absorption of Phosphorus by a plant or to increase the bioavailability of Phosphorous in a soil thereby increasing plant growth and/or crop yield, as determined by e.g., sugar content, crop yield or fruit weight, leafing, or plant size. It is contemplated that the reduced volatility or decomposition of the Phosphate in the fertilizer or soil amendment embodiments described herein (e.g., conversion of the Phosphate to compounds that are not bioavailable to plants), results from the complex of the Phosphorous or Phosphate with said mineral complex and it is thought that this reduced volatility or decomposition of the Phosphorous or Phosphate contributes to the improved absorption of the Phosphorus by the plant, which allows for improved plant growth, improved disease resistance, improved flowering, and higher crop yields. The reduced volatility or decomposition of Phosphorous or Phosphate afforded by the fertilizers or soil amendments described herein also allow a user to apply less phosphate to the soil and/or plant yet obtain a level and quality of plant growth and crop yield one would experience with greater amounts of conventional phosphate fertilizers.

Phosphorous is an important macronutrient for plant health and plant growth. Thus, using phosphorous as a soil amendment or fertilizer is well known. For example, various patent documents describe mixing and using phosphate fertilizers with as a soil amendment or fertilizer (U.S. Pat. No. 4,248,617, U.S. Pat. No. 4,133,670). These references are hereby expressly incorporated by reference in their entireties.

Accordingly, some embodiments include a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, wherein said fertilizer or soil amendment is in a granule, pellet, powder, prill, or a liquid suspension.

In more embodiments, the fertilizer or soil amendment and/or granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, does not contain a plant material, such as plant fiber, cellulose, green waste, manure, and/or organic waste or said granule, pellet, powder, prill, or a liquid suspension comprising Phosphorous (P) or Phosphate (P₂O₅) is in an isolated form or free form.

In more embodiments, the fertilizer or soil amendment described herein also comprises a nitrogen (N) containing compound or nitrogen source, such as Ammonium Nitrate (33.5-0-0), Ammonium Sulfate (21-0-0), Urea Nitrogen (46-0-0), Sodium Nitrate (16-0-0); or a Humate, Humic acid, Humin, Fulvic acid and/or Potassium, such as Potash or any combination thereof.

In more embodiments, the fertilizer or soil amendment that comprises the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof and the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel further comprises a Thiobacillus species.

In one embodiment, the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, or any combination thereof is mixed with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel to form the fertilizer or soil amendment. In another embodiment, said mineral complex is coated on a granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, or any combination thereof and/or the granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, or any combination thereof is coated on said mineral complex.

In more embodiments, the fertilizer or soil amendment described herein has a first coating, such as a polymer, surfactant, sugar, starch, fat, fatty acid, cellulose, soap, or wax. The first coating prevents contact of the mineral complex with the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. In more embodiments, the first coating covers the mineral complex and the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof.

In other embodiments, a second coating covers both the mineral complex and the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. In another embodiment, the second coating is different from the first coating. In some embodiments the second coating is the same as the first coating.

In more embodiments, the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, are blended or coated in a w/w 1:1 mix, in a w/w 1:2 mix, or in a w/w 1:3 mix.

In more embodiments, the amount of the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, that is provided with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

Aspects of the invention also include methods of making the fertilizer or soil amendments of any of the aforementioned compositions including, for example, methods practiced by providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; providing a granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof contacting the mineral complex with the granule, pellet, powder, prill, or a liquid suspension comprising Phosphorous (P) or Phosphate (P₂O₅); and generating a granule, pellet, powder, or a liquid suspension that comprises said mineral complex and the granule, pellet, powder, prill, or a liquid suspension comprising said Phosphorous (P) or Phosphate (P₂O₅).

In some embodiments, these methods further include or are characterized by coating the granule, pellet, powder, or prill comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, with the mineral complex. In more embodiments, the methods include or are characterized by coating the mineral complex with the granule, pellet, powder, prill, or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. In still more embodiments, the methods include or are characterized by contacting said mineral complex and/or said granule, pellet, powder, prill or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, with a first coating, such as a polymer, surfactant, sugar, starch, fat, fatty acid, cellulose, soap, or wax.

In some embodiments, the methods include or are characterized by coating the mineral complex with the first coating, such as a polymer, surfactant, sugar, starch, fat, fatty acid, cellulose, soap, or wax. In some embodiments, the aforementioned mineral complex is coated with the first coating, such as a polymer, surfactant, sugar, starch, fat, fatty acid, cellulose, soap, or wax. In some embodiments, the methods include or are characterized by coating said mineral complex and the granule, pellet, powder, prill or liquid suspension comprising the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, with a second coating that covers both the mineral complex and the Phosphorous (P) or Phosphate (P₂O₅). In more embodiments, the second coating is different from the first coating. In more embodiments, the second coating is the same as the first coating.

In some embodiments, the method includes or is characterized by having a granule, pellet, powder, prill or liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, that further comprises nitrogen, including ammonium nitrate (33.5-0-0), ammonium sulfate (21-0-0), urea nitrogen (46-0-0), sodium nitrate (16-0-0), potassium, including potash, humate, humic acid, humin and/or fulvic acid or any combination thereof.

Still more embodiments relate to methods or uses of any one or more of the fertilizers or soil amendments provided above (e.g., a fertilizer or soil amendment comprising, consisting of, or consisting essentially of: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and a granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof, wherein said fertilizer or soil amendment is, preferably but not necessarily, in a granule, pellet, powder, prill, or a liquid suspension) to amend a soil, to increase the bioavailability of phosphorous in a soil, and/or to promote plant growth or crop yield. These methods or uses can be practiced by providing a fertilizer or soil amendment as set forth above, for example, and contacting a soil or plant with the fertilizer or soil amendment.

It has also been discovered that a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and, optionally, a Thiobacillus spp., inhibits, prevents, ameliorates, or treats a wide range of insect infestations or fungal diseases on plants and/or soil. Utilization of the aforementioned mineral complex to inhibit, prevent, treat or ameliorate insect proliferation and/or fungus proliferation on plants or soil are embodiments of the invention.

Some embodiments, for example, include a biocidal mixture comprising: a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp; and a liquid surfactant, adjuvant, oil, or fatty acid, so as to form a liquid suspension of said biocidal mixture. Methods of making this biocidal mixture comprising providing said mineral complex and said liquid surfactant, adjuvant, oil, or fatty acid and mixing said mineral complex and said liquid surfactant, adjuvant, oil, or fatty acid so as to form said biocidal mixture are also embodiments.

In more embodiments, the biocidal mixture and methods of making the biocidal mixture further comprise mixing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus species, with an esterified seed oil, neem oil, a petroleum oil, or an essential oil.

In more embodiments, the biocidal mixture and methods of making the biocidal mixture further comprise mixing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., with Potassium salts of fatty acids, neem oil fatty acids, essential oil fatty acids, petroleum fatty acids, or paraffin fatty acids.

In more embodiments, the biocidal mixture and methods of making the biocidal mixture further comprise mixing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., with a non-ionic surfactant, an anionic surfactant, or a cationic surfactant, preferably, akyl aryl polyethoxylate, a silicone-based surfactant, or a polysorbate, such as polysorbate 20.

In more embodiments, the biocidal mixture and methods of making the biocidal mixture further comprise mixing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., with Pinene (terpene) polymers, petrolatum a-(p-Dodecylphenyl-Omega-hydroxypoly (oxyethylene), also known as Sustain.

In more embodiments, the biocidal mixture and methods of making the biocidal mixture further comprise mixing a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., with a pesticide. In some embodiments, the pesticide comprises Benlate, Captan, Malathion, Pyrethrin, Azadirachtin, Abamectin, Acephate, or Bacillus thuringiensis or any combination thereof.

In more embodiments, the biocidal mixture and methods of making the biocidal mixture further comprise mixing s a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., with a fertilizer. The fertilizer mixed with said biocidal mixture comprising any of the combinations described herein comprises nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate or any combination thereof.

In more embodiments, the biocidal mixture and methods of making the biocidal mixture comprise utilization of a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., wherein the mineral complex comprises a screen size of less than, or equal to or any size in between 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In preferred embodiments, the methods of making the aforementioned biocidal mixtures comprise mixing said biocidal mixtures comprising any of the combinations described herein with a Thiobacillus spp, which may be resident to said mineral complex or may be exogenously added.

In other embodiments, methods are provided for using the biocidal mixture comprising any of the combinations described herein to inhibit, ameliorate, prevent, or treat a plant for insect infestation and/or fungal disease, such as scab, powdery mildew, downy mildew, rust, Roya Fungus, blight, brown rot, leaf spots, mites, flies, scales, psyllids, or thrips, comprising e.g., providing a biocidal mixture that comprises a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp.; and applying, such as by spraying soaking, dusting, or sprinkling said biocidal mixture on the plant, such as on the leaves, stems, roots, or flowers or on soil in proximity to a plant or on soil having insects or fungus.

In some embodiments, the method for using the biocidal mixture comprising any of the combinations described herein to inhibit, ameliorate, prevent, or treat a plant for insect infestation and/or fungal disease, such as scab, powdery mildew, downy mildew, rust, Roya Fungus, blight, brown rot, leaf spots, mites, flies, scales, psyllids, or thrips, further comprises determining or monitoring a reduction or inhibition of insects and/or fungus after applying said biocidal mixture e.g., after 1, 2, 3, 4, 5, 6, or 7 days after application.

In some embodiments, the method for using the biocidal mixture comprising any of the combinations described herein to inhibit, ameliorate, or treat a plant for insect infestation and/or fungal disease, such as scab, powdery mildew, downy mildew, rust, Roya Fungus, blight, brown rot, leaf spots, mites, flies, scales, psyllids, or thrips, further comprises identifying, selecting, or classifying a plant or part thereof and/or soil for a reduction or prevention of insect and/or a fungus infestation.

In other embodiments, methods are provided for inhibiting, preventing, ameliorating, or treating a plant and/or soil for insect infestation and/or fungal disease, such as scab, powdery mildew, downy mildew, rust, Roya Fungus, blight, brown rot, leaf spots, mites, flies, scales, psyllids, or thrips, comprising: providing a biocidal mixture that comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension; and applying, such as by spraying, wetting, or soaking, said biocidal mixture on the plant, such as on the leaves, roots, stems, or flowers or on soil in proximity to a plant or on soil having insects and/or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, such as by spraying, wetting, or soaking, said biocidal mixture on the plant, such as on the leaves, roots, stems, or flowers or on soil in proximity to a plant or on soil having insects and/or fungus and, optionally, determining or monitoring the reduction, prevention, or inhibition of insects and/or fungus after applying said biocidal mixture e.g., after 1, 2, 3, 4, 5, 6, or 7 days after application of said biocidal mixture.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a powder, granule, or dust, such as by dusting, blowing, or sprinkling, said biocidal mixture on the plant, such as on the leaves, roots, stems, or flowers or on soil in proximity to a plant or on soil having insects and/or fungus and, optionally, identifying, selecting, or classifying a plant and/or soil for a reduction, prevention, or treatment of insects and/or a fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, which further comprises an esterified seed oil, neem oil, a petroleum oil, or an essential oil, such as by spraying, wetting, or soaking, said biocidal mixture on the plant, such as on the leaves, roots, stems, or flowers or on soil in proximity to a plant or on soil having insects and/or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, which further comprises Potassium salts of fatty acids, neem oil fatty acids, essential oil fatty acids, petroleum fatty acids, or paraffin fatty acids, such as by spraying, wetting, or soaking, said biocidal mixture on the plant, such as on the leaves, roots, stems, or flowers or on soil in proximity to a plant or on soil having insects and/or fungus.

In some embodiments, the methods for inhibiting, ameliorating, preventing or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, which comprises a non-ionic surfactant, an anionic surfactant, or a cationic surfactant, preferably, akyl aryl polyethoxylate, a silicone-based surfactant, a polysorbate, or polysorbate 20, such as by spraying, wetting, or soaking, said biocidal mixture on the plant, such as on the leaves, roots, stems, or flowers or on soil in proximity to a plant or on soil having insects and/or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, which further comprises a Pinene (terpene) polymer, or petrolatum a-(p-Dodecylphenyl-Omega-hydroxypoly (oxyethylene), also known as Sustain, such as by spraying, wetting, or soaking, said biocidal mixture on the plant, such as on the leaves, roots, stems, or flowers or on soil in proximity to a plant or on soil having insects and/or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips is practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, powder, granule, or dust, which further comprises a pesticide, such as, Benlate, Captan, Malathion, Pyrethrin, Azadirachtin, Abamectin, Acephate, or Bacillus thuringiensis, or any combination thereof and which is applied e.g., by spraying, wetting, soaking, dusting, or sprinkling said biocidal mixture on the plant, such as on the leaves, roots, stems, or flowers or on soil in proximity to a plant or on soil having insects and/or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips is practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, powder, granule, or dust, which further comprises a fertilizer and which is applied e.g., by spraying, wetting, soaking, dusting, or sprinkling said biocidal mixture on the plant, such as on the leaves, roots, stems, or flowers or on soil in proximity to a plant or on soil having insects and/or fungus. In some embodiments the fertilizer comprises nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate or any combination thereof.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips is practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., in a liquid suspension, powder, granule, or dust, wherein said mineral complex has a screen size of less than, or equal to or any size in between 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

Preferably, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips is practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and a Thiobacillus spp.

It has been discovered that the application of a mineral complex (e.g. a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel) to a petroleum hydrocarbon product, such as oil, promotes the decomposition of the petroleum hydrocarbon product to a non-hazardous organic matter, which supports new plant growth, in some cases within 72 hours. Accordingly, an improved method for treating, remediating, degrading, and/or ameliorating the presence of a petroleum product, such as oil or gas, has been obtained.

Some embodiments concern methods for using a mineral complex to remove, remediate, ameliorate, and/or clean-up a petroleum-containing material, e.g., an oil spill, comprising: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and contacting said mineral complex with said petroleum-containing material, such as oil, preferably for at least or equal to or any number in between 24, 36, 48, 60, or 72 hours.

In more embodiments, the aforementioned methods comprise applying or contacting said mineral complex with said petroleum-containing material, e.g., an oil spill, wherein said mineral complex is provided in a liquid suspension, granule, or powder.

In more embodiments, the methods for using said mineral complex to remove, remediate, ameliorate, or clean-up said petroleum-containing material, e.g., oil, comprise contacting said petroleum-containing material with said mineral complex, which has a screen size of less than, or equal to or any number in between a 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or a 632 mesh and can, optionally, be provided in a liquid suspension, granule, or powder.

In more embodiments, the methods for using said mineral complex to remove, remediate, ameliorate or clean-up said petroleum-containing material, e.g., oil, comprise contacting said petroleum-containing material, e.g., oil, with a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and a Thiobacillus spp.

In more embodiments, said petroleum-containing material, e.g., oil, does not need to be removed from the site or location after contact with said mineral complex, which may optionally contain a Thiobacillus spp. That is, in some embodiments, the amelioration and/or treatment of said petroleum-containing material, e.g., oil, is performed by contacting said petroleum-containing material, e.g., oil, with said mineral complex with or without a Thiobacillus spp, wherein the remediation, amelioration, treatment or removal of the petroleum-containing material, e.g., oil, is performed in situ such that the mixture of said petroleum-containing material and said mineral complex, which may optionally contain a Thiobacillus spp, is not removed from the contaminated site after contact with the mineral complex.

In more embodiments, said petroleum-containing material, e.g., oil, is degraded in situ to a non-hazardous and/or a non-toxic organic matter after contact with said mineral complex with or without a Thiobacillus spp, preferably at least or equal to or any number in between 24, 36, 48, 60, or 72 hours.

In more embodiments, said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, with or without a Thiobacillus spp. is allowed to contact said petroleum-containing material, e.g., oil, for at least 3, 4, 5, 6, 7, 8, 9, or 10 days.

In more embodiments, the contaminated site having the petroleum-containing material, e.g., oil, is able to support seed germination and/or plant growth after said mineral complex is left in contact with said petroleum-containing material, e.g., oil, for at least 3, 4, 5, 6, 7, 8, 9, or 10 days.

Other embodiments, concern methods for restoring fertile soil after said soil has been contaminated with a petroleum-containing material, e.g., oil, wherein said approaches are practiced by providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, with or without a Thiobacillus spp.; and contacting said contaminated soil with said mineral complex for a time sufficient to allow for decomposition of the petroleum-containing material, e.g., oil, such that the soil is fertile and supports germination of seeds and/or supports plant growth.

In more embodiments, the methods for restoring fertile soil after contamination with a petroleum-containing material, e.g., oil, comprise: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, with or without a Thiobacillus spp.; and contacting soil that has been contaminated with a petroleum-containing material, e.g., oil, with said mineral complex, wherein the mineral complex, with or without a Thiobacillus spp. is provided in a liquid suspension, granule, or powder. In some embodiments, the mineral complex employed in these approaches has a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In more embodiments, the methods for restoring fertile soil after contamination with a petroleum-containing material, e.g., oil, comprise: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; contacting soil that has been treated with oil with said mineral complex; and contacting said oil with a Thiobacillus spp.

In more embodiments, the methods for restoring fertile soil after contamination with a petroleum-containing material, e.g., oil, does not require the petroleum-containing material, e.g., oil, to be removed from a site of the oil spill after contact with said mineral complex.

In more embodiments, the aforementioned methods for restoring fertile soil after contamination with a petroleum-containing material, e.g., oil, results in the petroleum-containing material, e.g., oil, being degraded to a non-hazardous and/or a non-toxic organic matter after contact with said mineral complex.

In more embodiments, the methods for restoring fertile soil after contamination with a petroleum-containing material, e.g., oil, comprises leaving the mineral complex in contact with said petroleum-containing material, e.g., oil, for at least 3, 4, 5, 6, 7, 8, 9, or 10 days.

In more embodiments, the methods for restoring fertile soil after contamination with a petroleum-containing material, e.g., oil, produces a soil that supports seed germination and/or plant growth after the mineral complex is left in contact with said petroleum-containing material, e.g., oil, for at least 3, 4, 5, 6, 7, 8, 9, or 10 days.

More embodiments concern methods for growing a plant on a soil that is contaminated with a petroleum-containing material, e.g., oil, comprising: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, optionally also containing a Thiobacillus spp.; and germinating a seed or growing a plant in said soil after contacting said soil with said mineral complex.

In more embodiments, the methods for growing a plant on soil that has been contaminated with a petroleum-containing material, e.g., oil, comprises: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, optionally also containing a Thiobacillus spp.; and germinating a seed or growing a plant in said soil after contacting said soil with said mineral complex, wherein said mineral complex is provided in a liquid suspension, granule, or powder.

In more embodiments, the aforementioned methods for growing a plant on petroleum contaminated soil comprises utilization of a mineral complex that has a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In more embodiments, the methods for growing a plant on soil contaminated with a petroleum-containing material, e.g., oil, comprises: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and germinating a seed or growing a plant in said soil after contacting said soil with said mineral complex, wherein said method further comprises contacting said contaminated soil with a Thiobacillus spp.

In more embodiments, the methods for growing a plant on soil contaminated with a petroleum-containing material, e.g., oil, does not require the contaminated soil to be removed from the contaminated site after contact with said mineral complex.

In more embodiments, the aforementioned methods for growing a plant on soil contaminated with a petroleum-containing material, e.g., oil, produces a fertile soil such that the petroleum-containing material, e.g., oil, has been degraded to non-hazardous and/or non-toxic organic matter after contact with said mineral complex.

In more embodiments, the aforementioned methods are practiced by contacting the contaminated soil with the mineral for at least 3, 4, 5, 6, 7, 8, 9, or 10 days before planting a seed or plant.

### DETAILED DESCRIPTION

It has been discovered that fertilization, soil amendment, disease treatment and petroleum chemical remediation of soil can be significantly improved by combining the mineral complex described herein with fertilizers or components thereof, and/or applying the mineral complex described herein to diseased plants or soil, and/or by contacting petroleum contaminated soil with the mineral complex described herein. The following section provides greater detail on the fertilizers and soil amendments described herein.

### Fertilizers or Soil Amendments

In some embodiments, fertilzation and the health, growth, disease resistance, and crop yield of plants are improved by providing a plant nutrient, such as urea, phosphate, phosphorous, humate, humic acid, humin, and/or fulvic acid or any combination thereof, mixed or blended with or, in some embodiments, coated with, a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. Preferably, the plant nutrient is provided in a granule, pellet, powder, prill, or a liquid suspension and desirably, the fertilizer or soil amendment comprising the mineral complex is formulated into a granule, pellet, powder, prill, or a liquid suspension. The resultant fertilizer or soil amendment promotes improved crop yield, better crop quality, and improved disease resistance. The resultant fertilizer or soil amendment also reduces fertilizer burn and increases the bioavailability of said plant nutrients. Accordingly, aspects of the present invention concern the aforementioned fertilizers and soil amendments, methods of making the same, and methods of use or uses of said fertilizers or soil amendments to improve: plant growth, crop yield or quality, disease resistance, bioavailability of plant nutrients, or to reduce, inhibit, or ameliorate fertilizer burn. Such methods of use or use of said fertilizers or soil amendments to improve: plant growth, crop yield or quality, disease resistance, bioavailability of plant nutrients, or to reduce, inhibit, or ameliorate fertilizer burn can be practiced by applying the aforementioned fertilizers or soil amendments to the soil or to portions of a plant (e.g., roots, stems or leaves of said plants).

The fertilizers or soil amendments provided herein include a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel blended, mixed, or coated with (or vice versa) a plant nutrient, such as urea, phosphate, phosphorous, humate, humic acid, humin, and/or fulvic acid. In preferred embodiments, the resultant soil amendment or fertilizer can be in a form suitable for fertilization, such as a granule, pellet, powder, prill, or a liquid suspension. As used herein, “fertilization” or “fertilizer” and grammatical equivalents thereof, can refer to a material or soil amendment, preferably lacking organic plant material, such as manure or compost, which is added to a plant or soil to supply one or more plant nutrients essential or helpful for plant growth. In desired embodiments, the fertilizer or soil amendment does not contain a plant material. As used herein “plant material” and grammatical equivalents thereof, can refer to plant fiber, cellulose, green waste, manure, and/or organic waste. In further embodiments, the fertilizer or soil amendment comprises Thiobacillus species, which may be resident to said mineral complex or added exogenously thereto.

With respect to the mineral complex used in the embodiments described herein, the mineral complex includes at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further include one or more minerals selected from Zinc, Iron, Iron Sulfate, Manganese, Copper, Boron, Molybdenum, Selenium, and Nickel.

In more embodiments, a mineral complex used in the embodiments described herein comprises at least, greater than, or equal to 8% Potassium, at least, greater than, or equal to 50% Sulfur, at least, greater than, or equal to 17% Calcium Sulfate. Some such mineral complexes can also comprise at least, greater than, or equal to 2% micronutrients, where the micronutrients can comprise one or more minerals selected from the group consisting of Iron, Zinc, Copper, Manganese, Boron, Magnesium, Sodium, and Molybdenum. In even more embodiments, a mineral complex used in the embodiments described herein comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and at least, greater than, or equal to 3.4% Thiosulfite. Some of the mineral complexes used in the embodiments described herein further comprise a Thiobacillus species, which may be resident to said mineral complex or added exogenously thereto.

A variety of plant nutrients can be blended or mixed with or, in some embodiments, coated on the mineral complexes described herein so as to provide improved soil amendments or fertilizers. As used herein “plant nutrients” and grammatical equivalents thereof, can refer to nutrients that supply one or more chemicals or substances essential or helpful in plant growth and/or plant health and are not generally supplied through carbon dioxide or water. In preferred embodiments, the plant nutrients used in the embodiments described herein comprise one or more or a combination of urea, phosphate, phosphorous, humate, humic acid, humin, and/or fulvic acid. In preferred embodiments, the plant nutrients used in the embodiments described herein comprise one or more or a combination of nitrogen, such as ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), such as potash. In more embodiments, the plant nutrients used in the embodiments described herein comprise one or more or a combination of Nitrogen (“N”); Phosphorus (“P”); Potassium (“K”); Calcium (“Ca”); Magnesium (“Mg”); Sulfur (“S”); Boron (“B”); Chlorine (“Cl”); Copper (“Cu”); Iron (“Fe”); Manganese (“Mn”); Molybdenum (“Mo”); Zinc (“Zn”); and Nickel (“Ni”). Certain ratios of the aforementioned components are in a form and amount that provides nutrients that aid a plants growth.

In some embodiments, a granule, pellet, powder, prill, or a liquid suspension comprising the plant nutrients and/or the mineral complex is used in the embodiments described herein and said plant nutrients comprise Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. In other embodiments, the granule, pellet, powder, prill, or the liquid suspension comprising the plant nutrients comprise urea, and the mineral complex is mixed with the urea, coated on the urea, or blended with the urea. In still other embodiments, the granule, pellet, powder, prill, or the liquid suspension comprising the plant nutrients comprises humate, humic acid, humin, fulvic acid, nitro humic acid, potassium humate, sodium humate, and/or potassium fulvate.

In preferred embodiments, a granule, pellet, powder, prill, or a liquid suspension comprising the plant nutrient that is mixed or blended with the aforementioned mineral complex is urea. Urea is a well-known nitrogen fertilizer. Nitrogen fertilizers are often made using the Haber-Bosch process described in detail in Ammonia IN ULLMANN'S ENCYCLOPEDIA OF INDUSTRIAL CHEMISTRY (2006), hereby expressly incorporated by reference in its entirety. Urea (46-0-0) accounts for more than fifty percent of the world's nitrogenous fertilizers. It is typically found in granular or prill form, which allows urea to be easily stored, transported, and applied in agricultural settings but it can reach a liquid state quite easily with slight heating. For plants to absorb nitrogen from urea it must first undergo chemical decomposition according to the following reaction:

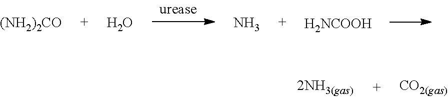

urease is a naturally occurring enzyme that catalyzes the hydrolysis of urea to unstable carbamic acid. Rapid decomposition of carbamic acid occurs without enzyme catalysis to form ammonia and carbon dioxide. The ammonia will likely escape to the atmosphere unless it reacts with water to form ammonium (NH₄+) according to the following reaction:

NH_{3(gas)}+H₂O→NH₄⁺+OH⁻

this is important because ammonium is a plant available source of nitrogen while ammonia is not. Urea decomposition begins as soon as the fertilizer is applied to the soil. If the soil has no moisture content then the reaction may be slowed or may not happen at all. This reaction can occur quickly and can cause the nitrogen burn of plants. The formation of the hydroxide ion may cause soils around the applied urea particle to have a pH around 9.0 which increases ammonia volatilization. This area is also highly toxic due to elevated ammonia concentration so it is recommended that urea based fertilizers not be applied or banded with planted seed at a rate that exceeds 10-20 kg/ha, depending on the crop species. Nitrogen from urea can also be lost to the atmosphere if the urea remains on the soil surface for extended periods and the ammonia is allowed to dissipate into the air. In some embodiments, the urea that is added to the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is in an isolated form free from plant material, such as plant fiber, green waste, manure, and/or organic waste.

With respect to plant nutrients, in certain embodiments, the plant nutrients provided in the fertilizer or soil amendment that comprises the mineral complex are present as at least, greater than, or equal to 1%, 2%, 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% of the fertilizer or soil amendment.

In other embodiments, the granule, pellet, powder, prill, or the liquid suspension comprising the plant nutrient is present in the fertilizer or soil amendment that comprises the mineral complex in an amount that is at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

The mineral complex described herein may be mixed, blended, coated with or coated on the granule, pellet, powder, prill, or liquid suspension of the plant nutrients at a variety of rates and ratios so as to produce soil amendments or fertilizers. In certain embodiments, soil amendments or fertilizers may be produced by mixing, blending, or coating a mineral complex at a rate of at least or equal to 1, 2, 3, 4, 5, 6, 7, 8, 9, 10, 11, or 12 tons per 24 ton portion of the soil amendment or fertilizer. In particular embodiments, soil amendments or fertilizers may be produced by mixing, blending, contacting, or coating the mineral complex and a granule, pellet, powder, prill, or liquid suspension of a plant nutrient at a ratio of at least or equal to 1:200, 1:100, 1:50 1:20, 1:10, 1:9, 1:8, 1:7, 1:6, 1:5, 1:4, 1:3, 1:2, and 1:1. In preferred embodiments, the mineral complex can be mixed, blended, contacted, or coated with a granule, pellet, powder, prill, or liquid suspension of a plant nutrient at a ratio of at least or equal to 1:5, 1:4, 1:3, 1:2, and 1:1. In another embodiment, a granule, pellet, powder, prill, or liquid suspension of a plant nutrient is mixed, blended, contacted, or coated with the mineral complex at a ratio of at least or equal to 1:200, 1:100, 1:50 1:20, 1:10, 1:9, 1:8, 1:7, 1:6, 1:5, 1:4, 1:3, 1:2, and 1:1. In preferred embodiments, a granule, pellet, powder, prill, or liquid suspension of a plant nutrient is mixed, blended, contacted, or coated with the mineral complex at a ratio of at least or equal to 1:5, 1:4, 1:3, 1:2, and 1:1.

In a certain embodiments, the mineral complex is coated on a granule, pellet, powder, or prill comprising the plant nutrient, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid or any combination thereof.

In another embodiment, the fertilizer or soil amendment is coated by a first coating, such as a polymer, surfactant, sugar, starch, fat, fatty acid, cellulose, soap, or wax. In one embodiment, the first coating prevents contact of the mineral complex with the granule, pellet, powder, prill, or liquid suspension comprising the plant nutrient. In another embodiment, the first coating covers the mineral complex and the granule, pellet, powder, prill, or liquid suspension comprising the plant nutrient. In still another embodiment, there is a second coating that covers the mineral complex and the granule, pellet, powder, prill, or liquid suspension comprising the plant nutrient. In some embodiments, the second coating is different than the first coating.

Typically, the soil amendments and/or fertilizers provided have an increased Ammonium Nitrate and/or Ammonium Sulfate content that is particularly beneficial for plant growth. In certain embodiments, the fertilizer or soil amendments comprising the mineral complex have an available nitrogen content of at least, greater than, or equal to 15 lb/yard³, 16 lb/yard³, 17 lb/yard³, 18 lb/yard³, 19 lb/yard³, 20 lb/yard³, 21 lb/yard³, 22 lb/yard³, 23 lb/yard³, 24 lb/yard³, 25 lb/yard³, 26 lb/yard³, 27 lb/yard³, 28 lb/yard³, 29 lb/yard³, 30 lb/yard³, 31 lb/yard³, 32 lb/yard³, 33 lb/yard³, 34 lb/yard³, or 35 lb/yard³.

Certain embodiments include containers comprising the soil amendments and/or fertilizers provided herein. Examples of containers include, but are not limited to, boxes, crates, and bags. Containers can comprise soil amendment, wherein the amount of soil amendment is less than, greater than, equal to or any number at least, greater than, or equal 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb. The following section provides more disclosure on a method of making the soil amendments or fertilizers discussed herein.

Methods for making the soil amendments or fertilizers described herein include providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel (referred to throughout this disclosure as “the mineral complex”); providing a granule, pellet, powder, prill, or a liquid suspension comprising one or more plant nutrients, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid or any combination thereof; contacting the plant nutrient with the granule, pellet, powder, prill, or a liquid suspension comprising the plant nutrient, and generating a granule, pellet, powder, or a liquid suspension comprising the plant nutrient to produce a soil amendment or fertilizer.

Some embodiments include pre-processing the mineral complex and/or plant nutrients prior to bringing them in contact with one another. In certain embodiments, a mineral complex that may be used to make soil amendments or fertilizer includes at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further include one or more minerals selected from the group consisting of Zinc, Iron, Iron Sulfate, Manganese, Copper, Boron, Molybdenum, Selenium, and Nickel. In more embodiments, the mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, the mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes described herein further comprise a Thiobacillus species.

The mineral complexes can undergo a pre-processing by, for example, grinding, milling and sizing the material. Finer particles of the mineral complex provide a larger surface area for the minerals in the complex to interact with plant nutrients, allowing more efficient dispersion and dissolution of soluble components in blending. In some embodiments, ore samples can be crushed using an impact crusher to material <3 inches, further ground, and screened for material <⅛^{th} inch. In some embodiments, mineral complexes can be further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

Pre-processing of plant nutrients will depend on the nature of the plant nutrient. Sources of plant nutrients are described herein. Considerations for plant nutrients used in soil amendment and fertilizers are provided in the following book: HENRY D. FOTH AND BOYD G. ELLIS, SOIL FERTILITY (2d ed. 1997), hereby expressly incorporated by reference in its entirety. In some embodiments, additional materials may be added to the plant nutrients to transform the nutrient into a form that is easily bioavailable to plants.

In a preferred embodiment, the granule, pellet, powder, prill, or the liquid suspension comprising the plant nutrient will be in the form of urea or anhydrous ammonium nitrate. Urea is a nitrogen fertilizer. Nitrogen fertilizers are well known in the art and are often made using the Haber-Bosch process described in: Erisman, Jan Willem, et. al, How a Century of Ammonia Synthesis Changed the World, 1 NATURE GEOSCIENCE 636 (2008), hereby expressly incorporated by reference. The Haber-Bosch process uses natural gas (CH₄+) for the hydrogen and nitrogen gas (N₂) from the air at an elevated temperature and pressure in the presence of a catalyst to form ammonia (NH₃) as the end product. This ammonia is used as a feedstock for other nitrogen fertilizers, such as anhydrous ammonium nitrate (NH₄NO₃) and urea (CO(NH₂)₂). These concentrated products may be diluted with water to form a concentrated liquid fertilizer.

Plant nutrients and mineral complexes can be blended, mixed, or coated by a variety of methods. In certain embodiments, the mineral complex described herein may be mixed, blended, coated with or coated on the granule, pellet, powder, prill, or liquid suspension of the plant nutrients at a variety of rates and ratios so as to produce soil amendments or fertilizers. In certain embodiments, soil amendments or fertilizers are produced by blending a mineral complex at a rate of 1, 2, 3, 4, 5, 6, 7, 8, 9, 10, 11, or 12 tons per 24 ton portion of the soil amendment or fertilizer. In particular embodiments, soil amendments or fertilizers are produced by mixing, blending, contacting, or coating a mineral complex and a granule, pellet, powder, prill, or liquid suspension of a plant nutrient at a ratio of about 1:200, 1:100, 1:50 1:20, 1:10, 1:9, 1:8, 1:7, 1:6, 1:5, 1:4, 1:3, 1:2, or 1:1. In preferred embodiments, the mineral complex are mixed, blended, contacted, or coated with a granule, pellet, powder, prill, or liquid suspension of a plant nutrient at a ratio of about 1:5, 1:4, 1:3, 1:2, and 1:1. In another embodiment, a granule, pellet, powder, prill, or liquid suspension of a plant nutrient are mixed, blended, contacted, or coated with the mineral complex at a ratio of about 1:200, 1:100, 1:50 1:20, 1:10, 1:9, 1:8, 1:7, 1:6, 1:5, 1:4, 1:3, 1:2, and 1:1. In preferred embodiments, a granule, pellet, powder, prill, or liquid suspension of a plant nutrient is mixed, blended, contacted, or coated with the mineral complex at a ratio of about 1:5, 1:4, 1:3, 1:2, and 1:1.

In a certain embodiment, the method comprises coating a granule, pellet, powder, or prill comprising a plant nutrient, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid or any combination thereof with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. In another embodiment, the method comprises coating the aforementioned mineral complex with a granule, pellet, powder, or prill comprising the plant nutrient, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid or any combination thereof.

In a further embodiment, the method includes contacting or coating the aforementioned mineral complex and/or the granule, pellet, powder, or prill comprising the plant nutrient with a first coating such as a polymer, surfactant, sugar, starch, fat, fatty acid, cellulose, soap, or wax. In one embodiment the first coating prevents contact of the mineral complex with the granule, pellet, powder, prill, or liquid suspension comprising the plant nutrient. In another embodiment, the first coating covers the mineral complex and the granule, pellet, powder, prill, or liquid suspension comprising the plant nutrient. In still another embodiment, the method includes coating the aforementioned mineral complex and the granule, pellet, powder, prill, or liquid suspension comprising the plant nutrient with a second coating. In some embodiments, the second coating is different than the first coating.

Methods for making soil amendments or fertilizers described herein can be applied to various farming methods and systems. It should be understood that the methods can be performed at any scale, for example, methods for making soil amendments or fertilizers can be carried out at industrial scales where many tons are processed, to non-commercial scales where tens of pounds may be processed. Examples of several systems for manufacturing fertilizers are found in HENRY D. FOTH AND BOYD G. ELLIS, SOIL FERTILITY (2d ed. 1997), hereby expressly incorporated by reference in its entirety. More systems and methods of fertilizing are well known in the art.

The methods provided above can further comprise bagging and/or packaging the resultant soil amendments or fertilizers. Soil amendments or fertilizers can be bagged or packaged into containers, for instance. Examples of containers include, but are not limited to, boxes, crates, and bags. Containers can comprise soil amendment or fertilizers, wherein the amount of soil amendment or fertilizer can be less than, greater than, equal to or any number in between 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb.

Some methods for making the soil amendments or fertilizers described herein can be particularly useful for reducing odors associated with fertilization. Odors may be particularly significant where fertilization occurs anaerobically. Where anaerobic composting occurs, metabolic end products can include methane, carbon dioxide and numerous low molecular weight intermediates such as organic acids and alcohols. However, some of the methods provided herein reduce the amount of odor produced during fertilizing. In particular embodiments, the volume of gases such as ammonia is significantly reduced. In more embodiments, the volume of methane produced during fertilizing is significantly reduced. The following section provides more detail on methods to increase plant growth.

Some embodiments include methods for improving plant growth by applying one or more of the fertilizers or soil amendments described herein. The soil amendments or fertilizers provided herein increase amounts of plant nutrients that are in a bioavailable form, which improves plant growth. Particular methods comprise contacting a plant or part thereof (e.g., leaf, roots, or stem) or soil, with one or more of the soil amendments or fertilizers described herein. In some embodiments, a soil amendment or fertilizer is applied to a field, garden, lawn, and/or flower bed. In other embodiments, the soil amendment or fertilizer is provided in a pre-emergence fertilization protocol.

Some methods include, for example, identifying and/or selecting a soil that may benefit from an application of a soil amendment to improve plant growth. Such an identification or selection can include testing the nutrient content of a soil, such as the amount of available nitrogen and/or the pH of the soil. Measuring the available nitrogen content of a soil and a soil amendment or fertilizer can be used to determine the amount and rate at which a soil amendment or fertilizer may be applied to a soil. Testing the pH of the soil can be used to identify basic soils that would require a fertilizer or soil amendment, as described herein, having a greater amount of the mineral complex than the fertilizer or soil amendment that would be beneficial for an acidic soil, for example. Other factors can include the type of plant that will be grown and its particular nutrient and pH requirements. For example, particular crops may require different levels of available nitrogen, phosphorus, or potassium for an increase in growth to be observed. In certain embodiments, the pH of a soil will also determine the amount and rate at which a particular soil amendment, as described herein, will be applied to the soil. For example, the amount and application rate of a fertilizer or soil amendment comprising a mineral complex and a plant nutrient, such as urea may involve determining soil characteristics, such as particle size, soil temperature, moisture content, and soil pH of the fertilizing material and/or resulting soil amendment. In certain embodiments, pH is measured before, during and/or subsequent to fertilization. In certain embodiments, the soil amendment or fertilizer will adjust the pH of the soil to 3, 4, 5, 6, 7, 8, and 9. In a preferred embodiment, the soil amendment or fertilizer will adjust the pH of the soil a pH to 6.3-7.

In particular embodiments, a soil amendment as described herein is applied at a rate of at least, greater than, or equal to 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, or 900 lb/acre to a soil, wherein the soil has a pH of about 6.3-6.8.

In more embodiments, a soil amendment, as described herein, is applied at a rate of 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, or 1100 lb/acre to a soil, wherein the soil has a pH of about 6.8-7.3.

In more embodiments, a soil amendment, as described herein, is applied at a rate of 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, or 2100 lb/acre to a soil, wherein the soil has a pH of about 7.3-7.7.

In more embodiments, a soil amendment, as described herein is applied at a rate of 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, or 3100 lb/acre to a soil, wherein the soil has a pH of about 7.8-8.9.

Methods to apply a soil amendment or fertilizers to a plant or soil are well known. In one example, drop spreaders and spinner spreaders can be used. In some embodiments, soil amendments or fertilizers are applied with plow-down, disking, injection, chiseling or knifing into the soil. In some embodiments, soil amendment or fertilizers are applied in bands at the bottom of plough furrows, or broadcast, or spread on top of ploughed soil. For deep soil application, this can then be worked into the soil with a harrow before planting. In some embodiments the fertilizer or soil amendment will be liquid and is applied with spray cans, sprinklers, or furrow irrigation or foliar application.

Some methods for improving plant growth comprise measuring an increase in plant growth or crop yield. For example, an increase in crop yield, crop quality, and/or cell integrity can be readily measured. The improvement of plant growth and crop yield of plants (e.g., potatoes or sugar beets) fertilized with a soil amendment or fertilizer made by the approaches described herein is compared to the plant growth and crop yield of plants (e.g., potatoes or sugar beets) fertilized with a urea fertilizer alone, or plants fertilized with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. Ideally, the three fertilizer or soil amendments are applied to the soil near the plants in separate field trials and the rate of application of the fertilizer or soil amendment made in accordance with the teachings provided herein is adjusted to match the rate of application of the urea fertilizer. That is, preferably, the amount of urea provided by either the fertilizer or soil amendment made in accordance with the teachings herein and the urea fertilizer are the same. Similarly, the rate of application of the mineral complex is adjusted to match the rate of application of the fertilizer or soil amendment made in accordance with the teachings herein so that the amount of the mineral complex applied to the plants in the separate field trials are the same. Growth characteristics, disease resistance, and crop yield and quality are monitored.

It will be observed that the fertilizer or soil amendment made in accordance with the teachings provided herein allows for greater plant growth, plant quality, and larger crop yield, characterized by for example, greater weight and/or greater sugar content, as compared to the urea fertilizer alone or the mineral complex alone. It will also be seen that the fertilizer or soil amendment made in accordance with the teachings provided herein will give less nitrogen burning than the urea fertilizer alone despite having applied the same amount of urea. In separate experiments, wherein the amount of urea provided by the fertilizer or soil amendment made in accordance with the teachings herein is varied and compared to the same amount of urea provided by the urea fertilizer alone, it will be seen that equivalent plant growth, plant quality, and crop yield, characterized by for example, greater weight and/or greater sugar content, is obtained with the fertilizer or soil amendment made in accordance with the teachings herein despite having significantly lower amounts of urea than that provided by the urea fertilizer. Thus, it will be determined that the fertilizer or soil amendment made in accordance with the teachings herein will be subject to less decomposition or volatilization of urea than conventional urea fertilizer when it is applied to the soil. Accordingly, embodiments also include methods of reducing the volatilization of urea comprising providing a mixture or blend of urea that comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. The following examples are not intended to limit the invention but rather to provide exemplary embodiments.

### Humate Containing Mineral Complex and Plant Nutrient Compositions

It has been discovered that fertilization and soil amendment can be significantly improved and the health, growth, disease resistance, bioavailability of nutrients in a soil, and crop yield of plants can be improved by providing Humate, Humic acid, Humin, and/or Fulvic acid, such as humate, humic acid, humin, fulvic acid, nitro humic acid, potassium humate, sodium humate, and/or potassium fulvate mixed or blended with or, in some embodiments, coated with, a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. Preferably, the Humate, Humic acid, Humin, and/or Fulvic acid, such as humate, humic acid, humin, fulvic acid, nitro humic acid, potassium humate, sodium humate, and/or potassium fulvate is provided in a granule, pellet, powder, prill, or a liquid suspension and desirably, the fertilizer or soil amendment is formulated into a granule, pellet, powder, prill, or a liquid suspension. The resultant fertilizer or soil amendment promotes improved crop yield, better crop quality, and improved disease resistance. The resultant fertilizer or soil amendment also reduces fertilizer burn and increases the bioavailability of plant nutrients present in the soil. Accordingly, aspects of the present invention concern the aforementioned fertilizers and soil amendments, methods of making the same, and methods of use or uses of said fertilizers or soil amendments to improve: plant growth, crop yield or quality, disease resistance, bioavailability of plant nutrients, or to reduce, inhibit, or ameliorate fertilizer burn. Such methods of use or use of said fertilizers or soil amendments to improve: plant growth, crop yield or quality, disease resistance, bioavailability of plant nutrients, or to reduce, inhibit, or ameliorate fertilizer burn can be practiced by applying the aforementioned fertilizers or soil amendments to the soil or plants (e.g., roots, stems or leaves of said plants). The following section provides greater detail on the fertilizers or soil amendments described herein.

The soil amendments and/or fertilizers provided herein comprise a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, blended, mixed, or coated with (or vice versa) a granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate. In preferred embodiments, the resultant soil amendment or fertilizer is in a form suitable for fertilization, such as a granule, pellet, powder, prill, or a liquid suspension. In further embodiments, the fertilizer or soil amendment and/or the granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate does not contain a plant material. In certain embodiments, the granule, pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate is in isolated form. In further embodiments, the fertilizer or soil amendment comprises a Thiobacillus spp, which may be resident to said fertilizer or soil amendment or added exogenously thereto.

With respect to mineral complexes, in certain embodiments, mineral complexes can comprise at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes further comprise one or more minerals selected from the group consisting of Zinc, Iron, Iron Sulfate, Manganese, Copper, Boron, Molybdenum, Selenium, and/or Nickel.

In more embodiments, a mineral complex can contain at least, greater than, or equal to 8% Potassium, at least, greater than, or equal to 50% Sulfur, at least, greater than, or equal to 17% Calcium Sulfate. Some such mineral complexes can also contain at least, greater than, or equal to 2% micronutrients, where the micronutrients can comprise one or more minerals selected from the group consisting of Iron, Zinc, Copper, Manganese, Boron, Magnesium, Sodium, and Molybdenum. In even more embodiments, a mineral complex can contain at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and at least, greater than, or equal to 3.4% Thiosulfite. It will be understood that some of the mineral complexes described herein further comprise a Thiobacillus spp, which may be resident to said mineral complex or added exogenously thereto.

Humate, Humic acid, Humin, and/or Fulvic acids, such as humate, humic acid, humin, fulvic acid, nitro humic acid, potassium humate, sodium humate, and/or potassium fulvate contain humic, fulvic, and mycrorrhizal fungi and bacteria that are involved in chemical reactions such as (1) electrostatic (columbic) attraction, (2) complex formation or chelation, and (3) water bridging. Electrostatic attraction of trace minerals leaves the cation readily available in the soil environment for transport into the plant roots or for exchange with another metal cation. Chelation occurs when electrically charged sites on humic substances function to dissolve and bind trace minerals. Evidence for the dissolution of minerals can be supported by x ray diffraction and infrared analysis. Chelation of plant nutrients such as iron (Fe), copper (Cu), zinc (Zn), magnesium (Mg), manganese (Mn), and calcium (Ca) reduces their toxicity as cations, prevents their leaching, and increases their uptake rate by plant roots. The chelation process also increases the mass flow of micronutrient mineral elements to the roots. Additionally, toxic heavy metals such as mercury (Hg), lead (Pb), and cadmium (Cd) can be chelated by Humate making them less available for plant uptake. Water bridging is believed to improve the mobility of nutrient ions through the soil solution to the root. These mechanisms also help reduce leaching of plant nutrients into the subsoil. The humic will grab and hold newly applied fertilizer just as it frees up and holds minerals already in the soil. In this way, less is lost to the environment and more is made available to the plant. Fungi and fulvic in Humates also greatly increase the transfer of minerals into the plant.

With respect to Humate, Humic acid, Humin, and/or Fulvic acid, in certain embodiments, Humate, Humic acid, Humin, and/or Fulvic acid comprise humate, humic acid, humin, fulvic acid, nitro humic acid, potassium humate, sodium humate, and/or potassium fulvate.

With respect to the soil amendments and/or fertilizers described herein, the amount of Humate, Humic acid, Humin, and/or Fulvic acid, such as humate, humic acid, humin, fulvic acid, nitro humic acid, potassium humate, sodium humate, and/or potassium fulvate, is least, greater than, or equal to 1%, 2%, 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% of the fertilizer or soil amendment.

In other embodiments, the amount of Humate, Humic acid, Humin, and/or Fulvic acid, such as humate, humic acid, humin, fulvic acid, nitro humic acid, potassium humate, sodium humate, and/or potassium fulvate in the fertilizer and/or soil amendment comprises at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

In certain embodiments, the fertilizer or soil amendment containing the mineral complex and the Humate, Humic acid, Humin, and/or Fulvic acid, such as humate, humic acid, humin, fulvic acid, nitro humic acid, potassium humate, sodium humate, and/or potassium fulvate also comprises nitrogen (N), such as Ammonium Nitrate (33.5-0-0), Ammonium Sulfate (21-0-0), Urea Nitrogen (46-0-0), Sodium Nitrate (16-0-0); Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or Potassium, such as Potash.

In different embodiments, the mineral complex is mixed, blended, or coated with the granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate at a variety of rates and ratios to produce soil amendments or fertilizers. In a preferred embodiment, the mineral complex is mixed with the granule, pellet, powder, prill, or liquid suspension of Humate, Humic acid, Humin, and/or Fulvic acid. In certain embodiments, soil amendments or fertilizers are produced by mixing, blending, or coating a mineral complex at a rate of 1, 2, 3, 4, 5, 6, 7, 8, 9, 10, 11, or 12 tons per 24 ton portion of the soil amendment or fertilizer. In particular embodiments, soil amendments or fertilizers are produced by mixing, blending, contacting, or coating a mineral complex and a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate at a ratio of 1:200, 1:100, 1:50 1:20, 1:10, 1:9, 1:8, 1:7, 1:6, 1:5, 1:4, 1:3, 1:2, or 1:1. In preferred embodiments, the mineral complex is mixed, blended, contacted, or coated with a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate at a ratio of 1:5, 1:4, 1:3, 1:2, or 1:1. In other embodiments, a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate is mixed, blended, contacted, or coated with the mineral complex at a ratio of 1:200, 1:100, 1:50 1:20, 1:10, 1:9, 1:8, 1:7, 1:6, 1:5, 1:4, 1:3, 1:2, or 1:1. In preferred embodiments, a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate is mixed, blended, contacted, or coated with the mineral complex at a ratio of 1:5, 1:4, 1:3, 1:2, or 1:1.

Controlled release fertilizers can be more efficient in the utilization of applied nutrients and can reduce the impact on the environment and the contamination of the subsurface water. Sulfur has been used as a controlled-release coating, usually comprising another wax or polymer which seals the sulfur. The slow release properties depend on the degradation of the secondary sealant by soil microbes as well as mechanical imperfections (cracks, etc.) in the sulfur. Other coated products use thermoplastics (and sometimes ethylene-vinyl acetate and surfactants, etc.) to produce diffusion-controlled release of soluble inorganic fertilizers. “Reactive Layer Coating” can produce thinner, hence cheaper, membrane coatings by applying reactive monomers simultaneously to the soluble particles. “Multicote” is a process applying layers of low-cost fatty acid salts with a paraffin topcoat. A secondary coating can be applied to control the release of the same nutrient or a separate nutrient. The secondary coating can be a polymer, surfactant, sugar, starch, fatty acid, soap, or wax, etc. If a hard polymer is used as a secondary coating, the properties are a cross between diffusion-controlled particles and traditional coated particles. Accordingly, one preferred embodiment is controlled release fertilizers of varying types comprising the mineral complex and one or more plant nutrients.

In a certain embodiment, the mineral complex is coated on a granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In another embodiment, the granule, pellet, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate is coated on the mineral complex. Many of these formulations comprise a reactive layer coating and/or a multicote.

In another embodiment, the fertilizer or soil amendment is coated by a first coating such as a polymer, surfactant, sugar, starch, fat, fatty acid, cellulose, soap, or wax. In one embodiment the first coating prevents contact of the mineral complex with the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In another embodiment, the first coating covers the mineral complex and the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In still another embodiment, there is a second coating that covers the mineral complex and the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In some embodiments the second coating is different than the first coating. The second coating is also the same as the first coating in different embodiments.

In some embodiments, the soil amendments provided herein have an increased Ammonium Nitrate and/or Ammonium Sulfate content that can be particularly beneficial to plant growth. In certain embodiments, soil amendments comprise an available nitrogen content of at least, greater than, or equal to 15 lb/yard³, 16 lb/yard³, 17 lb/yard³, 18 lb/yard³, 19 lb/yard³, 20 lb/yard³, 21 lb/yard³, 22 lb/yard³, 23 lb/yard³, 24 lb/yard³, 25 lb/yard³, 26 lb/yard³, 27 lb/yard³, 28 lb/yard³, 29 lb/yard³, 30 lb/yard³, 31 lb/yard³, 32 lb/yard³, 33 lb/yard³, 34 lb/yard³, or 35 lb/yard³.

Certain embodiments comprise containers comprising the soil amendments provided herein. Examples of containers include, but are not limited to, boxes, crates, and bags. Containers can comprise soil amendment, wherein the amount of soil amendment is less than, greater than, equal to or any number at least, greater than, or equal 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb. The following section provides more disclosure on methods to improve crop yield and better tasting fruits and vegetables.

Some of the fertilizers or soil amendments provided herein relate to a mineral complex blended with Humate, Humic acid, Humin, and/or Fulvic acid, such as humate, humic acid, humin, fulvic acid, nitro humic acid, potassium humate, sodium humate, and/or potassium fulvate for plant fertilization. Accordingly, methods for making soil amendments or fertilizers comprise providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; providing a granule pellet, powder, prill, or a liquid suspension comprising Humate, Humic acid, Humin, and/or Fulvic acid, such as humate, humic acid, humin, fulvic acid, nitro humic acid, potassium humate, sodium humate, and/or potassium fulvate, contacting the mineral complex with the granule, powder, prill, or liquid suspension comprising Humate, Humic acid, Humin, and/or Fulvic acid, such as humate, humic acid, humin, fulvic acid, nitro humic acid, potassium humate, sodium humate, and/or potassium fulvate; and generating a granule, pellet, powder, or a liquid suspension that contains the mineral complex and the Humate, Humic acid, Humin, and/or Fulvic acid, such as humate, humic acid, humin, fulvic acid, nitro humic acid, potassium humate, sodium humate, and/or potassium fulvate.

Methods provided reduce the production of particular gases during composting. For example, in some methods, the volume of Ammonia produced is reduced. Without wishing to be bound by any one theory, the low pH during composting may promote the conversion of Ammonia to Ammonium, thus reducing volatilization of Ammonia, reducing noxious odors, and increasing available nitrogen.

Some embodiments comprise pre-processing mineral complexes and/or Humate, Humic acid, Humin, and/or Fulvic acid, such as humate, humic acid, humin, fulvic acid, nitro humic acid, potassium humate, sodium humate, and/or potassium fulvate prior to contacting. In certain embodiments, a mineral complex that is used to make soil amendments or fertilizer comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from Zinc, Iron, Iron Sulfate, Manganese, Copper, Boron, Molybdenum, Selenium, and/or Nickel. In more embodiments, a mineral complex contains at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, where the micronutrients comprise one or more minerals selected from Iron, Zinc, Copper, Manganese, Boron, Magnesium, Sodium, and/or Molybdenum. In even more embodiments, a mineral complex contains at least, greater than, or equal to 8% Sulfate, at least, greater than, or equal to 7% Sulfur Trioxide, at least, greater than, or equal to 16% elemental Sulfur, at least, greater than, or equal to 9% Potash, a at least, greater than, or equal to 2% Bisulfite, and at least, greater than, or equal to 3.4% Thiosulfite. Some of the mineral complexes described herein further comprise a Thiobacillus spp.

Mineral complexes undergo pre-processing by grinding, milling and sizing the material. As will be understood, finer particles provide a larger surface area for mineral complexes to interact with plant nutrients, allowing more efficient dispersion and dissolution of soluble components in blending. In some embodiments, ore samples are crushed using an impact crusher to material <3 inches, further ground, and screened for material <⅛^{th} inch. In some embodiments, mineral complexes are further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

Pre-processing of Humate, Humic acid, Humin, and/or Fulvic acid, such as humate, humic acid, humin, fulvic acid, nitro humic acid, potassium humate, sodium humate, and/or potassium fulvate will depend on the source of the Humate, Humic acid, Humin, and/or Fulvic acid. Considerations for Humate, Humic acid, Humin, and/or Fulvic acid used in soil amendment and fertilizers are provided in the following: KIM H. TAN, HUMIC MATTER IN SOIL AND THE ENVIRONMENT PRINCIPLES AND CONTROVERSIES (2003), hereby expressly incorporated by reference in its entirety. In some embodiments, additional materials may be added to the Humate, Humic acid, Humin, and/or Fulvic acid, such as humate, humic acid, humin, fulvic acid, nitro humic acid, potassium humate, sodium humate, and/or potassium fulvate to increase the nutrient content and/or to transform nutrients into a form that is easily accessible by plants.

Humate, Humic acid, Humin, and/or Fulvic acid, such as humate, humic acid, humin, fulvic acid, nitro humic acid, potassium humate, sodium humate, and/or potassium fulvate and mineral complexes can be blended by a variety of methods. Mineral complexes may be blended with Humate, Humic acid, Humin, and/or Fulvic acid, such as humate, humic acid, humin, fulvic acid, nitro humic acid, potassium humate, sodium humate, and/or potassium fulvate at a variety of rates and ratios to produce soil amendments. In certain embodiments, soil amendments may be produced by blending a mineral complex at a rate of 1, 2, 3, 4, 5, 6, 7, 8, 9, 10, 11, or 12 tons per 24 ton portion of the soil amendment. In particular embodiments, soil amendments or fertilizers are produced by mixing, blending, contacting, or coating a mineral complex and a granule, pellet, powder, prill, or liquid suspension of a Humate, Humic acid, Humin, and/or Fulvic acid, such as humate, humic acid, humin, fulvic acid, nitro humic acid, potassium humate, sodium humate, and/or potassium fulvate at a ratio of 1:200, 1:100, 1:50 1:20, 1:10, 1:9, 1:8, 1:7, 1:6, 1:5, 1:4, 1:3, 1:2, or 1:1. In preferred embodiments, the mineral complex is mixed, blended, contacted, or coated with a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate at a ratio of 1:5, 1:4, 1:3, 1:2, or 1:1. In another embodiment, a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate is mixed, blended, contacted, or coated with the mineral complex at a ratio of 1:200, 1:100, 1:50 1:20, 1:10, 1:9, 1:8, 1:7, 1:6, 1:5, 1:4, 1:3, 1:2, or 1:1. In preferred embodiments, a granule, pellet, powder, prill, or liquid suspension of Humate, Humic acid, Humin, and/or Fulvic acid, such as humate, humic acid, humin, fulvic acid, nitro humic acid, potassium humate, sodium humate, and/or potassium fulvate is mixed, blended, contacted, or coated with the mineral complex at a ratio of 1:5, 1:4, 1:3, 1:2, or 1:1.

In a certain embodiment, the method comprises coating a granule, pellet, powder, or prill comprising Humate, Humic acid, Humin, and/or Fulvic acid, such as humate, humic acid, humin, fulvic acid, nitro humic acid, potassium humate, sodium humate, and/or potassium fulvate with the mineral complex. In another embodiment, the method comprises coating the mineral complex with a granule, pellet, powder, or prill comprising the Humate, Humic acid, Humin, and/or Fulvic acid, such as, such as humate, humic acid, humin, fulvic acid, nitro humic acid, potassium humate, sodium humate, and/or potassium fulvate.

In a further embodiment, the method comprises contacting and/or coating the Humate, Humic acid, Humin, and/or Fulvic acid, such as humate, humic acid, humin, fulvic acid, nitro humic acid, potassium humate, sodium humate, and/or potassium fulvate with the mineral complex and/or the granule, pellet, powder, or prill comprising Humate, Humic acid, Humin, and/or Fulvic acid, such as humate, humic acid, humin, fulvic acid, nitro humic acid, potassium humate, sodium humate, and/or potassium fulvate is coated with a first coating, such as a polymer, surfactant, sugar, starch, fat, fatty acid, cellulose, soap, or wax. In one embodiment the first coating prevents contact of the mineral complex with the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In another embodiment, the first coating covers the mineral complex and the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate. In still another embodiment, the method comprises coating the mineral complex and the granule, pellet, powder, prill, or liquid suspension comprising the Humate, Humic acid, Humin, and/or Fulvic acid, such as humate, humic acid, humin, fulvic acid, nitro humic acid, potassium humate, sodium humate, and/or potassium fulvate with a second coating. In some embodiments the second coating is different than the first coating. The second coating is also the same as the first coating in different embodiments.

In still a further embodiment, the method further comprises adding a granule, pellet, powder, prill, or liquid suspension to the fertilizer or soil amendment. The granule, pellet, powder, prill, or liquid suspension added is any, all, or a combination of: nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate and/or Potassium (K), including potash.

Methods for making soil amendments described herein are applied to various fertilizing methods and systems. It should be understood that the methods are performed at any scale, for example, methods for making soil amendments or fertilizers are carried out at industrial scales where many tons are processed, to non-commercial scales where tens of pounds may be processed. Examples of several systems for manufacturing fertilizers are found in in HENRY D. FOTH AND BOYD G. ELLIS, SOIL FERTILITY (2d ed. 1997), hereby expressly incorporated by reference in its entirety. One example is the creation of compound fertilizers, which have used the Nitrophosphate process or Odda Process. This process uses phosphate rock with up to a 20% phosphorus (P) content that is dissolved with nitric acid (HNO₃) to produce a mixture of phosphoric acid (H₃PO₄) and calcium nitrate (Ca(NO₃)₂). This can be combined with a potassium fertilizer to produce a compound fertilizer with all three N:P:K: plant nutrients in easily dissolved form.

Methods provided herein further comprise bagging the soil amendments or fertilizers described herein. Soil amendments or fertilizers are bagged into containers, for example. Examples of containers comprise, but are not limited to, boxes, crates, and bags. Containers comprise a soil amendment or fertilizer described herein, wherein the amount of soil amendment or fertilizer in the container is less than, greater than, equal to or any number in between 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lbs.

Some of the fertilizers and soil amendments provided herein are useful for inhibiting the growth of pathogenic microbes and/or for reducing odors that may be present in organic waste, e.g., avian, bovine, swine, or human manure, or in contaminated soil. It is contemplated, for example, that fertilizers and/or soil amendments that comprise Humate, Humic acid, Humin, and/or Fulvic acid, such as humate, humic acid, humin, fulvic acid, nitro humic acid, potassium humate, sodium humate, and/or potassium fulvate, and a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel will demonstrate improved odor control, as well as, improved inhibition of proliferation of pathogenic microbes associated with organic waste or contaminated soil, in particular in soil having avian, bovine, swine, or human manure, as compared to said mineral complex and/or said Humate, Humic acid, Humin, and/or Fulvic acid alone. For example, by one approach, the aforementioned fertilizer and/or soil amendment is applied to contaminated soil, for example a poultry house floor or livestock pen having animal manure, thereby allowing for the inhibition of proliferation or growth of pathogenic microbes associated with the contaminated soil. Optionally, the level of pathogenic microbes in the treated soil is measured before and/or after application of the soil amendment and it will be seen that soil amendment comprising the Humate, Humic acid, Humin, and/or Fulvic acid, such as humate, humic acid, humin, fulvic acid, nitro humic acid, potassium humate, sodium humate, and/or potassium fulvate with the mineral complex described herein, will have a lower amount of pathogenic microbes than a soil amendment containing the mineral complex or a soil amendment comprising Humate, Humic acid, Humin, and/or Fulvic acid alone. The microbes, which can be inhibited from proliferation or growth using one or more of the embodiments described herein include, but are not limited to: coliform bacteria, Escherichia coli, Salmonella spp., Salmonella enterai, Salmonella typhimurium, Shigella spp., Shigella dysenteriae, Shigella sonnei, Shigella flexneri, Bacillus pasteuri, Bacillus anthraces, Vibrio cholerae, Brucella abortus, Brucella suis, Brucella melitensis, Mycobacterium tuberculosis, Leptospira interohaemorrhagiae, Leptospira canicola, Leptospira pomona, Yersinia enterocolitica, Campylobacter jejuni, Entamoeba histolytica, Giardia lamblia; fungi; and viruses, such as hepatitis, reovirus, adenovirus, echovirus, or coxsackievirus. Additional embodiments include the aforementioned soil amendment comprising the Humate, Humic acid, Humin, and/or Fulvic acid, such as humate, humic acid, humin, fulvic acid, nitro humic acid, potassium humate, sodium humate, and/or potassium fulvate and the mineral complex mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel further comprising animal manure, such as avian, bovine, swine, or human manure, and such embodiments are useful for the fertilization of plants, especially for organic food production.

Typically, elevated temperatures attained during the creation of some fertilizers can destroy pathogens. However, it has been unexpectedly found that methods described herein can be used to inhibit the growth of pathogenic microbes through additional chemical processes related to heating. Without wishing to be bound to any one theory, the pH of a blended organic waste, Humate, Humic acid, Humin, and/or Fulvic acid, and said mineral complex during the creation of the fertilizer may be reduced such that growth of pathogenic microbes is inhibited. In some such embodiments, elevated temperatures need not be attained to destroy particular pathogenic microbes. Accordingly, the period of time required to attain elevated temperatures may not be needed in some embodiments, thus the total time for creating the fertilizer (e.g., organic compost) is reduced significantly.

Some methods for making the soil amendments or fertilizers described herein can be particularly useful for reducing odors associated with fertilization. Odors may be particularly significant where fertilization occurs anaerobically. Where anaerobic composting occurs, metabolic end products can comprise methane, carbon dioxide and numerous low molecular weight intermediates such as organic acids and alcohols. However, some of the methods provided herein reduce the amount of odor produced during fertilizing application and during fertilizer creation. In particular embodiments, the volume of gases such as ammonia is significantly reduced. In more embodiments, the volume of methane produced during fertilizing is significantly reduced. The following section provides more detail on methods for using the fertilizer or soil amendment.

Some embodiments comprise methods for amending a soil, increasing the bioavailability of plant essential nutrients in a soil, or promoting plant growth. The soil amendments and fertilizers provided herein are particularly useful for increasing the bioavailability of nutrients in a soil, which aids in plant health and growth. Particular methods can comprise providing a fertilizer or soil amendment as discussed herein, and contacting a soil or plant with the fertilizer or soil amendment. In some embodiments, the fertilizer or soil amendment is applied to a field, garden, lawn, and/or flower bed.

Some methods comprise, for example, identifying and/or selecting a soil that may benefit from an application of a soil amendment to improve plant growth. Such an identification or selection can comprise testing the nutrient content of a soil, such as the amount of available nitrogen and/or the pH of the soil. Measuring the available nitrogen content of a soil and a soil amendment or fertilizer can be used to determine the amount and rate at which a soil amendment or fertilizer may be applied to a soil. Testing the pH of the soil can be used to identify basic soils that would require a fertilizer or soil amendment, as described herein, having a greater amount of the mineral complex than the fertilizer or soil amendment that would be beneficial for an acidic soil, for example. Other factors can comprise the type of plant that will be grown and its particular nutrient and pH requirements. For example, particular crops may require different levels of available nitrogen, phosphorus, or potassium for an increase in growth to be observed. In certain embodiments, the pH of a soil will also determine the amount and rate at which a particular soil amendment, as described herein, will be applied to the soil. In certain embodiments, pH is measured before, during and/or subsequent to fertilization. In certain embodiments, the soil amendment or fertilizer will adjust the pH of the soil to 3, 4, 5, 6, or 7. In a preferred embodiment, the soil amendment or fertilizer will adjust the pH of the soil a pH to 6.3-7.

In particular embodiments, a soil amendment or fertilizer described herein is applied at a rate of at least, equal to, or greater than 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, or 900 lb/acre to a soil, wherein the soil has a pH of about 6.3-6.8.

In more embodiments, a soil amendment or fertilizer described herein is applied at a rate of at least, equal to, or greater than 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, or 1100 lb/acre to a soil, wherein the soil has a pH of about 6.8-7.3.

In more embodiments, a soil amendment or fertilizer described herein is applied at a rate of at least, equal to, or greater than 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, or 2100 lb/acre to a soil, where the soil has a pH of about 7.3-7.7.

In more embodiments, a soil amendment or fertilizer described herein is applied at a rate of at least, equal to, or greater than 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, or 3100 lb/acre to a soil, wherein the soil has a pH of about 7.8-8.9.

Methods to apply a soil amendment or fertilizer described herein to a plant or soil are also embodiments. In one example, drop spreaders and spinner spreaders are used. In some embodiments, the soil amendments or fertilizers are applied with plow-down, disking, injection, chiseling or knifing into the soil. In some embodiments, the soil amendments or fertilizers are applied in bands at the bottom of plough furrows, or broadcast, or spread on top of ploughed soil. For deep soil application, this can then be worked into the soil with a harrow before planting. In some embodiments, the fertilizer or soil amendment will be liquid and is applied with spray cans, sprinklers, or furrow irrigation or foliar application.

Some methods for improving plant growth comprise measuring an increase in plant growth or crop yield. For example, an increase in crop yield, crop quality, and/or cell integrity can be readily measured after application of one or more of the fertilizers or soil amendments described herein. The improvement of plant growth and crop yield of plants (e.g., potatoes or sugar beets) fertilized with a soil amendment or fertilizer made by the approaches described herein is compared to the plant growth and crop yield of plants (e.g., potatoes or sugar beets) fertilized with a humate fertilizer alone, or plants fertilized with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. Ideally, the three fertilizers or soil amendments are applied to the soil near the plants in separate field trials and the rate of application of the fertilizer or soil amendment made in accordance with the teachings provided herein is adjusted to match the rate of application of the humate fertilizer. That is, preferably, the amount of humate provided by either the fertilizer or soil amendment made in accordance with the teachings herein and the humate fertilizer are the same. Similarly, the rate of application of the mineral complex is adjusted to match the rate of application of the fertilizer or soil amendment made in accordance with the teachings herein so that the amount of the mineral complex applied to the plants in the separate field trials are the same. Growth characteristics, disease resistance, and crop yield and quality are monitored.

It will be observed that the fertilizer or soil amendment made in accordance with the teachings provided herein allows for greater plant growth, plant quality, and larger crop yield, characterized by for example, greater weight and/or greater sugar content, as compared to the humate fertilizer alone or the mineral complex alone. It will also be seen that the fertilizer or soil amendment made in accordance with the teachings provided herein will provide more bioavailability than the humate fertilizer alone despite having applied the same amount of humate. In separate experiments, wherein the amount of humate provided by the fertilizer or soil amendment made in accordance with the teachings herein is varied and compared to the same amount of humate provided by the humate fertilizer alone, it will be seen that equivalent plant growth, plant quality, and crop yield, characterized by for example, greater weight and/or greater sugar content, is obtained with the fertilizer or soil amendment made in accordance with the teachings herein despite having significantly lower amounts of humate than that provided by the humate fertilizer. Thus, it will be determined that the fertilizer or soil amendment made in accordance with the teachings herein will have more bioavailability of soil nutrients than conventional humate fertilizer when it is applied to the soil. Accordingly, embodiments also comprise methods of increasing the bioavailability of humate comprising providing a mixture or blend of humate that comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. The following provides another use of the fertilizer and/or soil amendments discussed herein to inhibit the growth of pathogenic microbes.

Some embodiments comprise methods for inhibiting the growth of pathogenic microbes. In particular embodiments, the pathogenic microbes may be present in soil, fertilizers, and organic waste, such as manure. Such pathogenic microbes can cause disease in humans and farm animals, leading to suffering and economic loss. The soil amendments and fertilizers provided herein are particularly useful for inhibiting the growth of pathogenic microbes in a soil or organic waste, which prevents disease in humans and farm animals. Particular methods can comprise providing a fertilizer or soil amendment as discussed herein, and contacting a soil or plant with the fertilizer or soil amendment. In some embodiments, the fertilizer or soil amendment is applied to a poultry house and/or a livestock pen.

As used herein, an effective amount of the fertilizer or soil amendment as discussed herein to inhibit the pathogenic growth of microbes refers to an amount of said fertilizer or soil amendment that exhibits antimicrobial activity when applied to soil. The amount will vary according to the conditions of the soil and the period of time the fertilizer or soil amendment as discussed herein contacts the soil. The amount of the fertilizer or soil amendment as discussed herein sufficient to inhibit growth of pathogenic microbes can be readily tested, for example, by measuring the presence of specific microbes in the soil, and/or measuring pH of the soil before, during and/or after application of the fertilizer and/or soil amendment described herein. In some embodiments, the fertilizer or soil amendment as discussed herein can be contacted to a soil to produce a pH of about 3, 4, 5, or 6, wherein the growth of particular pathogenic microbes are inhibited.

In more embodiments, the fertilizer or soil amendment as discussed herein is contacted to a soil for a period of time sufficient to inhibit growth of pathogenic microbes. In some embodiments, the period of time is at least 1 day, 5 days, 10 days, 15 days, 20 days, 25 days, 30 days, 35 days, 40 days, 45 days, 50 days, 55 days, 60 days, 65 days, 70 days, 75 days, 80 days, 85 days, 90 days, 95 days, or 100 days.

Some embodiments used to inhibit the growth of pathogenic microbes comprising Humate, Humic acid, Humin, and/or Fulvic acid, such as humate, humic acid, humin, fulvic acid, nitro humic acid, potassium humate, sodium humate, and/or potassium fulvate and a mineral complex that comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from Zinc, Iron, Iron Sulfate, Manganese, Copper, Boron, Molybdenum, Selenium, and/or Nickel. In more embodiments, a mineral complex contains at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, where the micronutrients comprise one or more minerals selected from the group consisting of Iron, Zinc, Copper, Manganese, Boron, Magnesium, Sodium, and/or Molybdenum. In even more embodiments, a mineral complex contains at least, greater than, or equal to 8% Sulfate, at least, greater than, or equal to 7% Sulfur Trioxide, at least, greater than, or equal to 16% elemental Sulfur, at least, greater than, or equal to 9% Potash, a at least, greater than, or equal to 2% Bisulfite, and at least, greater than, or equal to 3.4% Thiosulfite. Some of the mineral complexes described herein can further comprise a Thiobacillus spp.

Examples of pathogenic microbes, whose growth are inhibited by the fertilizers and/or soil amendments described herein, include coliform bacteria, Escherichia coli, Salmonella spp., Salmonella enterai, Salmonella typhimurium, Shigella spp., Shigella dysenteriae, Shigella sonnei, Shigella flexneri, Bacillus pasteuri, Bacillus anthraces, Vibrio cholerae, Brucella abortus, Brucella suis, Brucella melitensis, Mycobacterium tuberculosis, Leptospira interohaemorrhagiae, Leptospira canicola, Leptospira pomona, Yersinia enterocolitica, and Campylobacter jejuni. Pathogenic microbes can also comprise protozoa such as Entamoeba histolytica, Giardia lamblia; fungi; and viruses such as hepatitis type A, reovirus, adenovirus, echovirus, coxsackievirus.

Some embodiments comprise methods and compositions for reducing noxious odors of organic waste, for example, in poultry houses, bovine, and swine operations. Noxious odors can be produced from a variety of sources, for example, gases such as methane, hydrogen sulfide, and ammonia, and products such as alcohols, amines, aromatics, sulfides, terpenes, and organic acids. Methods for reducing odors can comprise contacting a mineral complex provided herein containing one or more Humate, Humic acid, Humin, and/or Fulvic acid, such as humate, humic acid, humin, fulvic acid, nitro humic acid, potassium humate, sodium humate, and/or potassium fulvate to an organic waste, such as manure, manure ponds, and waste water treatment facilities comprising swine waste, bovine waste, and poultry waste. In preferred embodiments, an effective amount of a mixture or blend of Humate, Humic acid, Humin, and/or Fulvic acid and a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, are contacted to an organic waste to reduce the odor evolved from the organic waste, as compared to an untreated waste. An effective amount is an amount sufficient to reduce the amount of an odor. In some embodiments, the mineral complex may be contacted with the organic waste for a period of time sufficient to reduce an odor. In some embodiments, the period of time can be at least 1 day, 5 days, 10 days, 15 days, 20 days, 25 days, 30 days, 35 days, or 40 days.

Some methods for inhibiting the growth of pathogenic microbes comprise measuring the concentration of nutrients and measuring the amount of pathogens after application to waste. For example, an increase in nutrient concentration and a decrease in pathogens can be readily measured. The concentration of nutrients of the soil amendment or fertilizer made by the approaches described herein after being applied to poultry houses and/or swine operations for 30 days is compared to the concentration of nutrients resulting from application of Humate alone to poultry houses and/or swine operations for 30 days, and the concentration of nutrients resulting with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone applied to poultry houses and/or swine operations for 30 days. Ideally, the three fertilizer or soil amendments are applied to the swine and/or poultry waste in separate field trials and the amount of time the soil amendments or fertilizers are allowed to react is the same, such as 30 days. That is, the amount of Humate provided by either the fertilizer or soil amendment made in accordance with the teachings herein and the Humate fertilizer are the same. Similarly, the amount of the mineral complex is adjusted to match the amount of the fertilizer or soil amendment made in accordance with the teachings herein so that the amount of the mineral complex applied to the poultry waste and/or swine waste in the separate field trials are the same. Concentration of nutrients, disease resistance, odor and pathogen content is monitored.

It will be observed that the fertilizer or soil amendment made in accordance with the teachings herein provides greater concentration of nutrients, characterized by for example, higher nitrogen, phosphorus, and/or potassium content, as compared to the humate fertilizer alone or the mineral complex alone. It will also be seen that the fertilizer or soil amendment made in accordance with the teachings herein will provide more bioavailability than the humate fertilizer alone despite having applied the same amount of humate. It will also be seen that the fertilizer or soil amendment made in accordance with the teachings herein will provide less odor, as characterized by, for example, an olfactometer, as compared to the humate fertilizer alone or the mineral complex alone. Additionally, it will be seen that the fertilizer or soil amendment made in accordance with the teachings herein will provide less pathogens, as characterized by, for example, the amount of yeast, bacteria, mold, fungi, virus, protozoa, and/or helminthes present. The following examples are not intended to limit the invention but rather to provide exemplary embodiments.

### Phosphate Containing Mineral Complex and Plant Nutrient Composition

It has been discovered that fertilization and soil amendment can be significantly improved and the health, growth, disease resistance, bioavailability of Phosphorous in a soil, and crop yield of plants can be improved by providing Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, mixed or blended with or, in some embodiments, coated with, a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. Preferably, the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate is provided in a granule, pellet, powder, prill, or a liquid suspension and desirably, the fertilizer or soil amendment is formulated into a granule, pellet, powder, prill, or a liquid suspension. The resultant fertilizer or soil amendment promotes improved crop yield, better crop quality, and improved disease resistance. The resultant fertilizer or soil amendment also reduces fertilizer burn and increases the bioavailability of said plant nutrients. Accordingly, aspects of the present invention concern the aforementioned fertilizers and soil amendments, methods of making the same, and methods of use or uses of said fertilizers or soil amendments to improve: plant growth, crop yield or quality, disease resistance, bioavailability of plant nutrients, or to reduce, inhibit, or ameliorate fertilizer burn. Such methods of use or use of said fertilizers or soil amendments to improve: plant growth, crop yield or quality, disease resistance, bioavailability of plant nutrients, or to reduce, inhibit, or ameliorate fertilizer burn can be practiced by applying the aforementioned fertilizers or soil amendments to the soil or plants (e.g., roots, stems or leaves of said plants).

The soil amendments and/or fertilizers provided herein also include a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, blended, mixed, or coated with (or vice versa) a granule, pellet, powder, prill, or a liquid suspension comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate or any combination thereof. In preferred embodiments, the resultant soil amendment or fertilizer is in a form suitable for fertilization, such as a granule, pellet, powder, prill, or a liquid suspension. As used herein, “fertilization” and grammatical equivalents thereof, refer to a material that is added to a plant or soil to supply one or more plant nutrients essential or helpful in plant growth. In further embodiments, the fertilizer or soil amendment and/or the granule, pellet, powder, prill, or a liquid suspension comprising Phosphorous (P) or Phosphate (P₂O₅) does not contain a plant material. As used herein “plant material” and grammatical equivalents thereof, can refer to plant fiber, cellulose, green waste, manure, and/or organic waste. In certain embodiments, the granule, pellet, powder, prill, or a liquid suspension comprising Phosphorous (P) or Phosphate (P₂O₅) is in isolated form or free-form. In further embodiments, the fertilizer or soil amendments described herein further comprises a Thiobacillus spp, which may be resident to said mineral complex or added exogenously thereto.

With respect to the mineral complexes used in the embodiments described herein, in certain embodiments, the mineral complexes comprise at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes further include one or more minerals selected from Zinc, Iron, Iron Sulfate, Manganese, Copper, Boron, Molybdenum, Selenium, and/or Nickel.

In more embodiments, the mineral complex used with embodiments described herein comprises at least, greater than, or equal to 8% Potassium, at least, greater than, or equal to 50% Sulfur, at least, greater than, or equal to 17% Calcium Sulfate. Some such mineral complexes also comprise at least, greater than, or equal to 2% micronutrients, wherein the micronutrients comprise one or more minerals selected from the group consisting of Iron, Zinc, Copper, Manganese, Boron, Magnesium, Sodium, and Molybdenum. In even more embodiments, the mineral complex used with embodiments described herein comprise at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. It will be understood that some of the mineral complexes used with the embodiments described herein further include a Thiobacillus spp, which may be resident to said mineral complex or added exogenously thereto.

Phosphorous compounds that are usable by plants in fertilizers are usually in the form of phosphoric acid (“H₃PO₄”). Phosphoric acid can be made by using phosphate rock that has been processed into water-soluble phosphate (P₂O₅) with the addition of sulfuric acid (H₂SO₄). Phosphate can also be reduced in an electric furnace to make high purity Phosphorus.

With respect to Phosphorous (P) or Phosphate (P₂O₅), in certain embodiments, Phosphorous (P) or Phosphate (P₂O₅) includes superphosphate (OSP), concentrated superphosphate (CSP), Monoammonium Phosphate (MAP), Diammonium Phosphate (DAP), Ammonium Polyphosphate (APP), and/or rock Phosphate, including soft rock Phosphate. In a preferred embodiment, the Phosphorous (P) or Phosphate (P₂O₅) is soft rock Phosphate, Diammonium Phosphate, and/or Monoammonium Phosphate.

With respect to Phosphorous (P) or Phosphate (P₂O₅), in certain embodiments, Phosphorous (P) or Phosphates (P₂O₅) comprise at least, greater than, or equal to 1%, 2%, 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% of the fertilizer or soil amendment.

In other embodiments, the Phosphorous (P) or Phosphate (P₂O₅) comprises at least or equal to any number in between 1-99%, 1-90%, 1-80%, 1-70%, 1-60%, 1-50%, 1-40%, 1-30%, 1-20%, 1-10%, 1-5%, 1-4%, 1-3%, or 1-2% of said fertilizer or soil amendment.

In certain embodiments, the fertilizer or soil amendment containing the aforementioned mineral complex and the Phosphorous (P) or Phosphate (P₂O₅) also includes nitrogen (N), such as Ammonium Nitrate (33.5-0-0), Ammonium Sulfate (21-0-0), Urea Nitrogen (46-0-0), Sodium Nitrate (16-0-0); Humate, Humic acid, Humin, Fulvic acid and/or Potassium, such as Potash.

In different embodiments, the aforementioned mineral complex is mixed, blended, or coated with the granule, pellet, powder, prill, or liquid suspension of Phosphorous (P) or Phosphate (P₂O₅) at a variety of rates and ratios so as to produce soil amendments or fertilizers. In a preferred embodiment, the mineral complex is mixed with the granule, pellet, powder, prill, or liquid suspension of Phosphorous (P) or Phosphate (P₂O₅). In certain embodiments, soil amendments or fertilizers are produced by mixing, blending, or coating a mineral complex at a rate of 1, 2, 3, 4, 5, 6, 7, 8, 9, 10, 11, or 12 tons per 24 ton portion of the soil amendment or fertilizer. In particular embodiments, soil amendments or fertilizers are produced by mixing, blending, contacting, or coating a mineral complex and a granule, pellet, powder, prill, or liquid suspension of Phosphorous (P) or Phosphate (P₂O₅) at a ratio of 1:200, 1:100, 1:50 1:20, 1:10, 1:9, 1:8, 1:7, 1:6, 1:5, 1:4, 1:3, 1:2, or 1:1. In preferred embodiments, the mineral complex is mixed, blended, contacted, or coated with a granule, pellet, powder, prill, or liquid suspension of Phosphorous (P) or Phosphate (P₂O₅) at a ratio of 1:5, 1:4, 1:3, 1:2, or 1:1. In other embodiments, a granule, pellet, powder, prill, or liquid suspension of Phosphorous (P) or Phosphate (P₂O₅) is mixed, blended, contacted, or coated with the mineral complex at a ratio of 1:200, 1:100, 1:50 1:20, 1:10, 1:9, 1:8, 1:7, 1:6, 1:5, 1:4, 1:3, 1:2, or 1:1. In preferred embodiments, a granule, pellet, powder, prill, or liquid suspension of Phosphorous (P) or Phosphate (P₂O₅) is mixed, blended, contacted, or coated with the aforementioned mineral complex at a ratio of 1:5, 1:4, 1:3, 1:2, or 1:1.

Controlled release fertilizers can be more efficient in the utilization of applied nutrients and can reduce the impact on the soil and environment, including the contamination of subsurface water. Urea and formaldehyde, reacted together to produce sparingly soluble polymers of various molecular weights, is a controlled-nitrogen-release technology that has 60% of the total nitrogen cold-water-insoluble, and the unreacted (quick release) nitrogen less than 15%. Methylene ureas have 25 to 60% of the nitrogen cold-water-insoluble, and unreacted urea nitrogen in the range of 15 to 30%. Isobutylidene diurea, unlike the methylurea polymers, is a single crystalline solid of relatively uniform properties, with about 90% of the nitrogen being water-insoluble. Urea has also been coated with sulfur to create a controlled release fertilizer. The sulfur can have another wax or polymer, which seals the sulfur. The slow release properties depend on the degradation of the secondary sealant by soil microbes, as well as, mechanical imperfections (cracks, etc.) in the sulfur. The sulfur-coated urea typically provides 6 to 16 weeks of delayed release in turf applications. Other coated products use thermoplastics (and sometimes ethylene-vinyl acetate and surfactants, etc.) to produce diffusion-controlled release of soluble inorganic fertilizers. “Reactive Layer Coating” can produce thinner, hence cheaper, membrane coatings by applying reactive monomers simultaneously to the soluble particles. “Multicote” is a process applying layers of low-cost fatty acid salts with a paraffin topcoat. A secondary coating can be applied to control the release of the same nutrient or a separate nutrient. The secondary coating can be a polymer, surfactant, sugar, starch, fatty acid, soap, or wax, etc. If a hard polymer is used as a secondary coating, the properties are a cross between diffusion-controlled particles and traditional coated particles. In some embodiments, any one or more of the sealing or coating technologies described above is used to coat or seal the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel.

In some embodiments, the mineral complex is coated on a granule, pellet, powder, prill, or liquid suspension comprising the Phosphorous (P) or Phosphate (P₂O₅). In another embodiment, the granule, pellet, powder, prill, or liquid suspension comprising Phosphorous (P) or Phosphate (P₂O₅) is coated on the mineral complex.

In another embodiment, the fertilizer or soil amendment is coated by a first coating such as a polymer, surfactant, sugar, starch, fat, fatty acid, cellulose, soap, or wax. In one embodiment the first coating prevents contact of the mineral complex with the granule, pellet, powder, prill, or liquid suspension comprising the Phosphorous (P) or Phosphate (P₂O₅). In another embodiment, the first coating covers the mineral complex and the granule, pellet, powder, prill, or liquid suspension comprising the Phosphorous (P) or Phosphate (P₂O₅). In still another embodiment, there is a second coating that covers the mineral complex and the granule, pellet, powder, prill, or liquid suspension comprising the Phosphorous (P) or Phosphate (P₂O₅). In some embodiments, the second coating is different than the first coating. The second coating is also the same as the first coating in different embodiments.

In addition to Phosphorous (P) or Phosphate (P₂O₅), some of the soil amendments or fertilizers described herein will provide Ammonium Nitrate and/or Ammonium Sulfate, which will also plant growth. In certain embodiments, soil amendments have an available nitrogen content of at least, greater than, or equal to 15 lb/yard³, 16 lb/yard³, 17 lb/yard³, 18 lb/yard³, 19 lb/yard³, 20 lb/yard³, 21 lb/yard³, 22 lb/yard³, 23 lb/yard³, 24 lb/yard³, 25 lb/yard³, 26 lb/yard³, 27 lb/yard³, 28 lb/yard³, 29 lb/yard³, 30 lb/yard³, 31 lb/yard³, 32 lb/yard³, 33 lb/yard³, 34 lb/yard³, or 35 lb/yard³.

Certain embodiments include containers comprising the soil amendments provided herein. Examples of containers include, but are not limited to, boxes, crates, or bags. Containers can comprise one or more of the soil amendments, wherein the amount of soil amendment is less than, greater than, equal to or any number at least, greater than, or equal 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb. The following section provides more disclosure on methods to improve crop yield and better tasting fruits and vegetables.

The fertilizers or soil amendments provided herein relate to a mineral complex blended with Phosphorous (P) or Phosphate (P₂O₅) for plant fertilization. Accordingly, methods for making soil amendments or fertilizers include providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; providing a granule pellet, powder, prill, or a liquid suspension comprising Phosphorous (P) or Phosphate (P₂O₅), contacting the mineral complex with the granule, powder, prill, or liquid suspension comprising Phosphorous (P) or Phosphate (P₂O₅); and generating a granule, pellet, powder, or a liquid suspension that contains the mineral complex and the Phosphorous (P) or Phosphate (P₂O₅).

Some embodiments include pre-processing the mineral complex and/or Phosphorous (P) or Phosphate (P₂O₅) prior to contacting these components. In certain embodiments, the mineral complex that is used to make soil amendments or fertilizer comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes further comprise one or more minerals selected from the group consisting of Zinc, Iron, Iron Sulfate, Manganese, Copper, Boron, Molybdenum, Selenium, and/or Nickel. In more embodiments, the mineral complex comprises at least, greater than, or equal to 8% Potassium, at least, greater than, or equal to 50% Sulfur, at least, greater than, or equal to 17% Calcium Sulfate. Some such mineral complexes also comprise at least, greater than, or equal to 2% micronutrients, wherein the micronutrients comprise one or more minerals selected from the group consisting of Iron, Zinc, Copper, Manganese, Boron, Magnesium, Sodium, and/or Molybdenum. In even more embodiments, the mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes used with embodiments described herein further comprise a Thiobacillus spp.

The mineral complexes used in some embodiments undergo pre-processing by grinding, milling and/or sizing the material. As will be understood, finer particles provide a larger surface area for mineral complexes to interact with plant nutrients, allowing more efficient dispersion and dissolution of soluble components in blending. In some embodiments, ore samples are crushed using an impact crusher to material <3 inches, further ground, and screened for material <⅛^{th} inch. In some embodiments, mineral complexes are further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

Pre-processing of Phosphorous (P) or Phosphate (P₂O₅) will depend on the source of the Phosphorous (P) or Phosphate (P₂O₅). Sources of Phosphorous (P) or Phosphate (P₂O₅) are described herein. Considerations for Phosphorous (P) or Phosphate (P₂O₅) used in soil amendment and fertilizers are provided in the following: Rehm, George, et. al, Understanding Phosphorous Fertilizers, REGENTS OF THE UNIVERSITY OF MINNESOTA (2002), hereby expressly incorporated by reference in its entirety. In some embodiments, additional materials are added to the Phosphorous (P) or Phosphate (P₂O₅) so as to transform the nutrient into a form that is bioavailable to plants.

Phosphorous (P) or Phosphates (P₂O₅) and mineral complexes are blended by a variety of methods. Mineral complexes are blended with Phosphorous (P) or Phosphate (P₂O₅) at a variety of rates and ratios so as to produce the soil amendments and fertilizers described herein. In certain embodiments, the soil amendments or fertilizers described herein are produced by blending the aforementioned mineral complex at a rate of 1, 2, 3, 4, 5, 6, 7, 8, 9, 10, 11, or 12 tons per 24 ton portion of the soil amendment or fertilizer. In particular embodiments, soil amendments or fertilizers are produced by mixing, blending, contacting, or coating a mineral complex and a granule, pellet, powder, prill, or liquid suspension of a plant nutrient at a ratio of 1:200, 1:100, 1:50 1:20, 1:10, 1:9, 1:8, 1:7, 1:6, 1:5, 1:4, 1:3, 1:2, or 1:1. In preferred embodiments, the mineral complex is mixed, blended, contacted, or coated with a granule, pellet, powder, prill, or liquid suspension of Phosphorous (P) or Phosphates (P₂O₅) at a ratio of 1:5, 1:4, 1:3, 1:2, or 1:1. In another embodiment, a granule, pellet, powder, prill, or liquid suspension of Phosphorous (P) or Phosphates (P₂O₅) is mixed, blended, contacted, or coated with the mineral complex at a ratio of 1:200, 1:100, 1:50 1:20, 1:10, 1:9, 1:8, 1:7, 1:6, 1:5, 1:4, 1:3, 1:2, or 1:1. In preferred embodiments, a granule, pellet, powder, prill, or liquid suspension of Phosphorous (P) or Phosphates (P₂O₅) is mixed, blended, contacted, or coated with the mineral complex at a ratio of 1:5, 1:4, 1:3, 1:2, or 1:1.

In some embodiments, the method of making the soil amendments or fertilizers described herein comprises coating a granule, pellet, powder, or prill comprising Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate with the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. In another embodiment, the method comprises coating the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel with a granule, pellet, powder, or prill comprising the Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate.

In a further embodiment, the method includes contacting and/or coating the mineral complex and/or the granule, pellet, powder, or prill comprising the Phosphorous (P) or Phosphate (P₂O₅) with a first coating such as a polymer, surfactant, sugar, starch, fat, fatty acid, cellulose, soap, or wax. In one embodiment the first coating prevents contact of the mineral complex with the granule, pellet, powder, prill, or liquid suspension comprising the Phosphorous (P) or Phosphate (P₂O₅). In another embodiment, the first coating covers the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or liquid suspension comprising the Phosphorous (P) or Phosphate (P₂O₅). In still another embodiment, the method includes coating the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and the granule, pellet, powder, prill, or liquid suspension comprising the Phosphorous (P) or Phosphate (P₂O₅) with a second coating. In some embodiments the second coating is different than the first coating. The second coating is also the same as the first coating in different embodiments.

In still a further embodiment, the method also includes adding a granule, pellet, powder, prill, or liquid suspension to the fertilizer or soil amendment. The granule, pellet, powder, prill, or liquid suspension added comprises any, all, or a combination of: nitrogen, including ammonium nitrate (33.5-0-0), ammonium sulfate (21-0-0), urea nitrogen (46-0-0), sodium nitrate (16-0-0), potassium, including potash, humate, humic acid, humin and/or fulvic acid.

Methods for making the soil amendments and fertilizers described herein are applied to various fertilizing methods and systems. It should be understood that the methods are performed at any scale, for example, methods for making soil amendments or fertilizers are carried out at industrial scales, wherein many tons are processed, to non-commercial scales where tens of pounds may be processed. Examples of several systems for manufacturing fertilizers are found in HENRY D. FOTH AND BOYD G. ELLIS, SOIL FERTILITY (2d ed. 1997), hereby expressly incorporated by reference in its entirety. More systems and methods of fertilizing are well known. One example is the creation of compound fertilizers, which have used the Nitrophosphate process or Odda Process. This process uses phosphate rock with up to a 20% phosphorus (P) content that is dissolved with nitric acid (HNO₃) to produce a mixture of phosphoric acid (H₃PO₄) and calcium nitrate (Ca(NO₃)₂). This can be combined with a potassium fertilizer to produce a compound fertilizer with all three N:P:K: plant nutrients in an easily dissolved form.

Methods provided herein further include bagging soil amendments or fertilizers. Soil amendments or fertilizers are bagged into containers. Examples of containers include, but are not limited to, boxes, crates, and bags. Containers that comprise a soil amendment or fertilizer described herein will comprise an amount of soil amendment or fertilizer that is less than, greater than, equal to or any number in between 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb.

Some methods for making the soil amendments or fertilizers described herein are particularly useful for reducing odors associated with fertilization. Odors may be particularly significant where fertilization occurs anaerobically. Where anaerobic composting occurs, metabolic end products can include methane, carbon dioxide and numerous low molecular weight intermediates such as organic acids and alcohols. However, some of the methods provided herein reduce the amount of odor produced during fertilizing. In particular embodiments, the volume of gases such as ammonia is significantly reduced. In more embodiments, the volume of methane produced during fertilizing is significantly reduced. The following section provides more detail on methods for using the fertilizer or soil amendment.

Some embodiments include methods for amending a soil, increasing the bioavailability of phosphorous in a soil, promoting plant growth, or improving crop yield. The soil amendments and fertilizers provided herein are particularly desirable because they increase the bioavailability of phosphorous in a soil, which aids in plant health and growth. Particular methods comprise providing a fertilizer or soil amendment as discussed herein, and contacting a soil or plant with the fertilizer or soil amendment. In some embodiments, the fertilizer or soil amendment is applied to a field, garden, lawn, and/or flower bed.

Some methods include identifying and/or selecting a soil or plant in need of an application of a soil amendment comprising Phosphorous (P) or Phosphate (P₂O₅) so to improve plant growth, crop yield flowering, or disease resistance. Such methods comprise testing the nutrient content of a soil, such as the amount of available Phosphorus. Measuring the available Phosphorus content of a soil can be performed by conventional methods. A soil amendment or fertilizer is then applied at a rate that the fertilizer or soil amendment will improve the soil, plant growth, flowering, or crop yield. Other factors that can impact the application rate of the fertilizer of soil amendment described herein include the type of plant that will be grown and the type of soil that is being amended. For example, particular crops require different levels of available Phosphorus for an increase in growth to be observed. In certain embodiments, the pH of a soil determines the amount and rate at which a soil amendment or fertilizer is applied to a soil.

In particular embodiments, a soil amendment or fertilizer as described herein is applied at a rate of at least, equal to, or greater than 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, or 900 lb/acre to a soil, wherein the soil has a pH of 6.3-6.8.

In more embodiments, a soil amendment or fertilizer as described herein is applied at a rate of at least, equal to, or greater than 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, or 1100 lb/acre to a soil, wherein the soil has a pH of 6.8-7.3.

In more embodiments, a soil amendment or fertilizer as described herein is applied at a rate of at least, equal to, or greater than 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, or 2100 lb/acre to a soil, wherein the soil has a pH of 7.3-7.7.

In more embodiments, a soil amendment or fertilizer as described herein is applied at a rate of at least, equal to, or greater than 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, or 3100 lb/acre to a soil, wherein the soil has a pH of 7.8-8.9.

Methods to apply a soil amendment or fertilizers to a plant or soil are well known. In one example, drop spreaders and spinner spreaders are used. In some embodiments, soil amendments or fertilizers are applied with plow-down, disking, injection, chiseling or knifing into the soil. In some embodiments, soil amendment or fertilizers are applied in bands at the bottom of plough furrows, or broadcast, or spread on top of ploughed soil. For deep soil application, this can then be worked into the soil with a harrow before planting. In some embodiments the fertilizer or soil amendment will be liquid and is applied with spray cans, sprinklers, or furrow irrigation or foliar application.

Some methods for improving plant growth comprise measuring an increase in plant growth, a plant quality such as sugar content, or crop yield. For example, an increase in crop yield, crop quality, and/or cell integrity can be readily measured. The improvement of plant growth and crop yield of plants (e.g., potatoes or sugar beets) fertilized with a soil amendment or fertilizer made by the approaches described herein is compared to the plant growth and crop yield of plants (e.g., potatoes or sugar beets) fertilized with a Phosphorus fertilizer alone, or plants fertilized with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. Ideally, the three fertilizer or soil amendments are applied to the soil near the plants in separate field trials and the rate of application of the fertilizer or soil amendment made in accordance with the teachings provided herein is adjusted to match the rate of application of the Phosphorous fertilizer. That is, preferably, the amount of phosphorus provided by either the fertilizer or soil amendment made in accordance with the teachings herein and the phosphorous fertilizer are the same. Similarly, the rate of application of the mineral complex is adjusted to match the rate of application of the fertilizer or soil amendment made in accordance with the teachings herein so that the amount of the mineral complex applied to the plants in the separate field trials are the same. Growth characteristics, disease resistance, and crop yield and quality are monitored.

It will be observed that the fertilizer or soil amendment made in accordance with the teachings provided herein allows for greater plant growth, plant quality, and larger crop yield, characterized by for example, greater weight and/or greater sugar content, as compared to the phosphorus fertilizer alone or the mineral complex alone. It will also be seen that the fertilizer or soil amendment made in accordance with the teachings provided herein will provide more bioavailability than the Phosphorus fertilizer alone despite having applied the same amount of Phosphorus. In separate experiments, wherein the amount of Phosphorus provided by the fertilizer or soil amendment made in accordance with the teachings herein is varied and compared to the same amount of Phosphorus provided by the Phosphorous fertilizer alone, it will be seen that equivalent plant growth, plant quality, and crop yield, characterized by for example, greater weight and/or greater sugar content, is obtained with the fertilizer or soil amendment made in accordance with the teachings herein despite having significantly lower amounts of Phosphorus than that provided by the Phosphorous fertilizer. Thus, it will be determined that the fertilizer or soil amendment made in accordance with the teachings herein will have more bioavailability of Phosphorus than conventional Phosphorous fertilizer when it is applied to the soil. Accordingly, embodiments also include methods of increasing the bioavailability of Phosphorus comprising providing a mixture or blend of Phosphorous that comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. The following examples are not intended to limit the invention but rather to provide exemplary embodiments.

### Biocidal Mixtures

It has been discovered that biocidal mixtures can be significantly improved and the health, growth, disease resistance, and crop yield of plants can be improved by applying to said plant or soil a biocidal mixture comprising a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. Preferably, the mineral complex is applied on plants, crops, vegetation and/or soil that is infected with a fungal disease or insect infestation and, desirably, the plant, crop, vegetation or soil is identified, classified, or selected as one in need of a compound that inhibits, prevents, ameliorates, or treats said plant, crop, vegetation or soil for said fungal disease or insect infestation. In some embodiments, wherein the biocidal mixture is mixed with a surfactant or adjuvant, greater insect/disease inhibition and plant growth is seen.

The biocidal mixtures provided herein comprise a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. blended, mixed, or coated with (or vice versa) a liquid surfactant, adjuvant, oil, or fatty acid. In preferred embodiments, the resultant biocidal mixture can be in a form suitable for spraying, wetting, or soaking plants or soil, such as a liquid suspension.

In more embodiments, the biocidal mixtures comprise a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. blended, mixed, or coated with (or vice versa) an esterified seed oil, neem oil, a petroleum oil, or an essential oil.

In more embodiments, the biocidal mixtures further comprise a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. blended, mixed, or coated with (or vice versa) Potassium salts of fatty acids, neem oil fatty acids, essential oil fatty acids, petroleum fatty acids, or paraffin fatty acids.

In more embodiments, the biocidal mixtures further comprise a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. blended, mixed, or coated with (or vice versa) a non-ionic surfactant, an anionic surfactant, or a cationic surfactant, preferably, akyl aryl polyethoxylate, a silicone-based surfactant, or a polysorbate, such as polysorbate 20.

In more embodiments, the biocidal mixtures further comprise a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. blended, mixed, or coated with (or vice versa) Pinene (terpene) polymers, petrolatum a-(p-Dodecylphenyl-Omega-hydroxypoly (oxyethylene), also known as Sustain.

In more embodiments, the aforementioned biocidal mixtures further comprise mixing said biocidal mixture comprising any of the combinations described herein with a pesticide. In more embodiments, the pesticide comprises Benlate, Captan, Malathion, Pyrethrin, Azadirachtin, Abamectin, Acephate, or Bacillus thuringiensis. Some pesticides break down at a higher pH, losing their ability to inhibit insect infestations The biocidal mixtures described herein maintain a slightly acidic pH, thereby, when the biocidal mixtures described herein are mixed with certain pesticides, such as Benlate, Captan, Malathion, Pyrethrin, Azadirachtin, Abamectin, Acephate, the efficacy and stability of the pesticide is increased. Accordingly, aspects of the invention concern methods to stabilize a pesticide, such as Benlate, Captan, Malathion, Pyrethrin, Azadirachtin, Abamectin, Acephate, wherein said method is practiced by mixing said pesticide, e.g., Benlate, Captan, Malathion, Pyrethrin, Azadirachtin, Abamectin, Acephate, with a a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., wherein the resultant biocidal mixture can further include a liquid surfactant, adjuvant, oil, or fatty acid such as, an esterified seed oil, neem oil, petroleum oil, an essential oil, Potassium salts of fatty acids, neem oil fatty acids, essential oil fatty acids, petroleum fatty acids, paraffin fatty acids, a non-ionic surfactant, an anionic surfactant, or a cationic surfactant, preferably, an akyl aryl polyethoxylate, a silicone-based surfactant, a polysorbate, such as polysorbate 20, or a Pinene (terpene) polymer or petrolatum a-(p-Dodecylphenyl-Omega-hydroxypoly (oxyethylene), also known as Sustain.

In further preferred embodiments, the biocidal mixtures mentioned herein comprise Thiobacillus spp, which may be resident to said mineral complex or added exogenously thereto.

With respect to the mineral complex used in the embodiments described herein, the mineral complex includes at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further include one or more minerals selected from Zinc, Iron, Iron Sulfate, Manganese, Copper, Boron, Molybdenum, Selenium, and Nickel.

In more embodiments, a mineral complex used in the embodiments described herein comprises at least, greater than, or equal to 8% Potassium, at least, greater than, or equal to 50% Sulfur, at least, greater than, or equal to 17% Calcium Sulfate. Some such mineral complexes can also comprise at least, greater than, or equal to 2% micronutrients, where the micronutrients can comprise one or more minerals selected from the group consisting of Iron, Zinc, Copper, Manganese, Boron, Magnesium, Sodium, and Molybdenum. In even more embodiments, a mineral complex used in the embodiments described herein comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and at least, greater than, or equal to 3.4% Thiosulfite. Some of the mineral complexes used in the embodiments described herein further comprise a Thiobacillus spp, which may be resident to said mineral complex or added exogenously thereto.

In more embodiments, the biocidal mixtures further comprise mixing said biocidal mixture comprising any of the combinations described herein with a fertilizer. The fertilizer mixed with said biocidal mixture comprising any of the combinations described herein comprises nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate.

A variety of fertilizers can be blended or mixed with or, in some embodiments, coated on the mineral complexes described herein so as to provide improved biocidal mixtures. In preferred embodiments, the fertilizers used in the biocidal mixtures described herein comprise one or more or a combination of urea, phosphate, phosphorous, humate, humic acid, humin, and/or fulvic acid. In preferred embodiments, the fertilizers used in the embodiments described herein comprise one or more or a combination of nitrogen, such as ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), such as potash. In more embodiments, the plant nutrients used in the embodiments described herein comprise one or more or a combination of Nitrogen (“N”); Phosphorus (“P”); Potassium (“K”); Calcium (“Ca”); Magnesium (“Mg”); Sulfur (“S”); Boron (“B”); Chlorine (“Cl”); Copper (“Cu”); Iron (“Fe”); Manganese (“Mn”); Molybdenum (“Mo”); Zinc (“Zn”); and Nickel (“Ni”). Certain ratios of the aforementioned components are in a form and amount that provides nutrients that aid a plants growth.

In some embodiments, a granule, pellet, powder, prill, or a liquid suspension comprising the fertilizers is used in the biocidal mixtures described herein and said fertilizers comprise Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate. In other embodiments, the granule, pellet, powder, prill, or the liquid suspension comprising the fertilizers comprise urea, and the mineral complex is mixed with the urea, coated on the urea, or blended with the urea. In still other embodiments, the granule, pellet, powder, prill, or the liquid suspension comprising the plant nutrients comprises humate, humic acid, humin, fulvic acid, nitro humic acid, potassium humate, sodium humate, and/or potassium fulvate.

In one embodiment, a granule, pellet, powder, prill, or a liquid suspension comprising the fertilizer that is mixed or blended with the aforementioned mineral complex in the biocidal mixture is urea. In some embodiments, the urea that is added to the biocidal mixture and the mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is in an isolated form free from plant material, such as plant fiber, green waste, manure, and/or organic waste.

With respect to the mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, in certain biocidal mixtures, the mineral complex provided comprises at least, greater than, or equal to 1%, 2%, 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% of the biocidal mixture.

In other embodiments of the biocidal mixture, the mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is present in the biocidal mixture in an amount that is at least or equal to any number in between 1-99%, 10-99%, 20-99%, 30-99%, 40-99%, 50-99%, 60-99%, 70-99%, 80-99%, 90-99%, 95-99%, 96-99%, 97-99%, or 98-99% of said biocidal mixture.

In more embodiments, the mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and, optionally, a Thiobacillus spp., has a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

The biocidal mixtures described herein may be mixed, blended, coated with or coated on the granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a variety of rates and ratios so as to produce said biocidal mixtures. In certain embodiments, biocidal mixtures may be produced by mixing, blending, or coating a mineral complex at a rate of at least or equal to 1, 2, 3, 4, 5, 6, 7, 8, 9, 10, 11, or 12 tons per 24 ton portion of the biocidal mixtures. In particular embodiments, biocidal mixtures may be produced by mixing, blending, contacting, or coating the mineral complex and a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of at least or equal to 1:200, 1:100, 1:50 1:20, 1:10, 1:9, 1:8, 1:7, 1:6, 1:5, 1:4, 1:3, 1:2, and 1:1. In preferred embodiments, the mineral complex can be mixed, blended, contacted, or coated with a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of at least or equal to 1:5, 1:4, 1:3, 1:2, and 1:1.

In another embodiment, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer is mixed, blended, contacted, or coated with the mineral complex at a ratio of at least or equal to 1:200, 1:100, 1:50 1:20, 1:10, 1:9, 1:8, 1:7, 1:6, 1:5, 1:4, 1:3, 1:2, and 1:1. In preferred embodiments, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer is mixed, blended, contacted, or coated with the mineral complex at a ratio of at least or equal to 1:5, 1:4, 1:3, 1:2, and 1:1.

In a certain biocidal mixtures, the mineral complex is coated on a granule, pellet, powder, or prill comprising the fertilizer, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid.

Certain embodiments comprise containers comprising the biocidal mixtures provided herein. Examples of containers include, but are not limited to, sprayers, pump sprayers, backpack sprayers, bottles, buckets, bags, and crates. Containers can comprise biocidal mixtures, wherein the amount of biocidal mixtures is less than, greater than, equal to or any number at least, greater than, or equal 8 oz., 9 oz., 1 pint, 1 quart, 40 oz., ½ gallon, 1 gallon, 2.5 gallons, 5 gallons, 10 gallons, 15 gallons, 20 gallons, 25 gallons, 30 gallons, 35 gallons, 40 gallons, 45 gallons, 50 gallons, 55 gallons, 60 gallons, 65 gallons, 70 gallons, 75 gallons, 80 gallons, 85 gallons, 90 gallons, 95 gallons, 100 gallons, or 500 gallons. The following section provides more disclosure on a method of making the biocidal mixtures discussed herein.

Methods for making the biocidal mixtures described herein comprise: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp.; and mixing said mineral complex with a liquid surfactant, adjuvant, oil, or fatty acid, so as to form a liquid suspension of said biocidal mixture.

In more embodiments, the methods of making the biocidal mixture comprises providing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. mixed with a liquid surfactant, adjuvant, oil, or fatty acid; and further mixing said biocidal mixture with an esterified seed oil, neem oil, a petroleum oil, or an essential oil.

In more embodiments, the methods of making the biocidal mixture comprises providing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. mixed with a liquid surfactant, adjuvant, oil, or fatty acid; and further mixing said biocidal mixture with Potassium salts of fatty acids, neem oil fatty acids, essential oil fatty acids, petroleum fatty acids, or paraffin fatty acids.

In more embodiments, the methods of making the biocidal mixture comprises providing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. mixed with a liquid surfactant, adjuvant, oil, or fatty acid; and further mixing said biocidal mixture with a non-ionic surfactant, an anionic surfactant, or a cationic surfactant, preferably, akyl aryl polyethoxylate, a silicone-based surfactant, or a polysorbate, such as polysorbate 20.

In more embodiments, the methods of making the biocidal mixture comprises providing said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. mixed with a liquid surfactant, adjuvant, oil, or fatty acid; and further mixing said biocidal mixture with Pinene (terpene) polymers, petrolatum a-(p-Dodecylphenyl-Omega-hydroxypoly (oxyethylene), also known as Sustain.

In some embodiments, the methods of making the biocidal mixture further comprise mixing said biocidal mixture comprising any of the combinations described herein with a pesticide. In some embodiments, the pesticide comprises Benlate, Captan, Malathion, Pyrethrin, Azadirachtin, Abamectin, Acephate, or Bacillus thuringiensis. Some pesticides break down at a higher pH, losing their ability to inhibit insect infestations The biocidal mixtures described herein maintain an acidic pH, thereby, when the biocidal mixtures described herein are mixed with certain pesticides, the efficacy of the pesticide is increased.

In some embodiments, the methods of making the biocidal mixture further comprise mixing said biocidal mixture comprising any of the combinations described herein with fertilizer. The fertilizer mixed with said biocidal mixture comprising any of the combinations described herein comprises nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate.

In some embodiments, the granule, pellet, powder, prill, or the liquid suspension comprising the fertilizer will be in the form of urea or anhydrous ammonium nitrate. Urea is a nitrogen fertilizer. Nitrogen fertilizers are well known in the art and are often made using the Haber-Bosch process described in: Erisman, Jan Willem, et. al, How a Century of Ammonia Synthesis Changed the World, 1 NATURE GEOSCIENCE 636 (2008), hereby expressly incorporated by reference. The Haber-Bosch process uses natural gas (CH₄+) for the hydrogen and nitrogen gas (N₂) from the air at an elevated temperature and pressure in the presence of a catalyst to form ammonia (NH₃) as the end product. This ammonia is used as a feedstock for other nitrogen fertilizers, such as anhydrous ammonium nitrate (NH₄NO₃) and urea (CO(NH₂)₂). These concentrated products may be diluted with water to form a concentrated liquid fertilizer.

Some embodiments comprise pre-processing mineral complexes prior to mixing. In certain embodiments, a mineral complex that may be used to make biocidal mixtures comprise at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel and, optionally, a Thiobacillus spp. In more embodiments, a mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, a mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Preferably, the mineral complexes described herein further comprise a Thiobacillus spp.

The mineral complexes can undergo a pre-processing by, for example, grinding, milling and sizing the material. Finer particles of the mineral complex provide a larger surface area for the minerals in the complex to interact with fungus and/or insects, allowing more efficient dispersion and dissolution of soluble components in blending. In some embodiments, ore samples can be crushed using an impact crusher to material <3 inches, further ground, and screened for material <⅛^{th} inch. In some embodiments, mineral complexes can be further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

Mineral complexes can be blended, mixed, or coated by a variety of methods. Such methods are well known. In certain embodiments, the mineral complex described herein may be mixed, blended, coated with or coated on the granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a variety of rates and ratios so as to produce biocidal mixtures. In certain embodiments, soil amendments or fertilizers are produced by blending a mineral complex at a rate of 1, 2, 3, 4, 5, 6, 7, 8, 9, 10, 11, or 12 tons per 24 ton portion of the biocidal mixture. In particular embodiments, soil amendments or fertilizers are produced by mixing, blending, contacting, or coating a mineral complex and a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of about 1:200, 1:100, 1:50 1:20, 1:10, 1:9, 1:8, 1:7, 1:6, 1:5, 1:4, 1:3, 1:2, or 1:1. In preferred embodiments, the mineral complex are mixed, blended, contacted, or coated with a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of about 1:5, 1:4, 1:3, 1:2, and 1:1. In another embodiment, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer are mixed, blended, contacted, or coated with the mineral complex at a ratio of about 1:200, 1:100, 1:50 1:20, 1:10, 1:9, 1:8, 1:7, 1:6, 1:5, 1:4, 1:3, 1:2, and 1:1. In preferred embodiments, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer is mixed, blended, contacted, or coated with the mineral complex at a ratio of about 1:5, 1:4, 1:3, 1:2, and 1:1.

In a certain embodiment, the method comprises coating a granule, pellet, powder, or prill comprising a fertilizer, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. In another embodiment, the method comprises coating the aforementioned mineral complex with a granule, pellet, powder, or prill comprising the fertilizer, such as nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate.

Methods for making biocidal mixtures described herein can be applied to various farming methods and systems. It should be understood that the methods can be performed at any scale, for example, methods for making biocidal mixtures can be carried out at industrial scales where many tons are processed, to non-commercial scales where quarts or pints may be processed. Systems and methods of applying biocidal mixtures or fungicides are well known in the art.

The methods provided above can further comprise bagging and/or packaging the resultant biocidal mixtures. Examples of containers for bagging and/or packaging include, but are not limited to, sprayers, pump sprayers, backpack sprayers, bottles, buckets, bags, and crates. Containers can comprise biocidal mixtures, wherein the amount of biocidal mixtures is less than, greater than, equal to or any number at least, greater than, or equal 8 oz., 9 oz., 1 pint, 1 quart, 40 oz., ½ gallon, 1 gallon, 2.5 gallons, 5 gallons, 10 gallons, 15 gallons, 20 gallons, 25 gallons, 30 gallons, 35 gallons, 40 gallons, 45 gallons, 50 gallons, 55 gallons, 60 gallons, 65 gallons, 70 gallons, 75 gallons, 80 gallons, 85 gallons, 90 gallons, 95 gallons, 100 gallons, or 500 gallons. The following section provides more detail on methods for treating a plant for insect infestation and/or fungal disease.

The methods for inhibiting, ameliorating, preventing, or treating a plant for insect infestation and/or fungal disease, such as scab, powdery mildew, downy mildew, rust, Roya Fungus, blight, brown rot, leaf spots, mites, flies, scales, psyllids, or thrips, comprise providing and/or making one or more of the biocidal mixture described herein and applying the biocidal mixture, such as by spraying, wetting, or soaking, said biocidal mixtures on the plant, such as on the leaves, roots, stems, or flowers or on soil in proximity to a plant or on soil having insects or fungus.

Methods to apply a biocidal mixture to a plant or soil are well known. In some embodiments the biocidal mixture will be liquid and is applied with spray cans, sprinklers, furrow irrigation or foliar application. In one example, drop spreaders and spinner spreaders can be used. In some embodiments, biocidal mixtures are applied with plow-down, disking, injection, chiseling or knifing into the soil. In some embodiments, biocidal mixtures are applied in bands at the bottom of plough furrows, or broadcast, or spread on top of ploughed soil. For deep soil application, this can then be worked into the soil with a harrow before planting.

Some methods include, for example, identifying, selecting, or classifying a plant and/or soil for a reduction of insects and/or a fungus that may benefit from an application of a biocidal mixture to inhibit, ameliorate, or treat a plant for insect infestation and/or fungal disease, such as scab, powdery mildew, downy mildew, rust, Roya Fungus, blight, brown rot, leaf spots, mites, flies, scales, psyllids, or thrips. Such an identification comprises physically looking for signs of pest damage or potential pest problems. Disease spotting is done frequently throughout the growing season, preferably every 1-10 days, 1-9 days, 1-8 days, 1-7 days, 1-6 days, 1-5 days, or 1-4 days, and more preferably every 1-3 days or 1-2 days. Disease spotting comprises examining all aspects of the plant, such as the leaves of plants, the seeds of plants, the roots of plants, and the stems of the plants. Some pests require specialized equipment, well known in the art, to detect. An example of such equipment is a shovel or trowel for detecting underground insects such as wireworm, white grub, seed corn maggot, seed corn beetle, black cutworm, and rootworm larvae, all of which may be treated or prevented or inhibited by one or more of the biocidal mixtures provided herein. Another monitoring method involves burying a grain in a mesh material. Carbon dioxide is given off by the seed as it begins to sprout, attracting larvae of certain insects, which can then be detected feeding on the grain contained in the mesh material. Pheromone traps can also be used to monitor populations of certain insects. Blacklight traps, knives, and sweep nets are additional tools, among the many used, to monitor crops for insect infestation or fungal disease.

In other embodiments methods are provided for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, comprising: providing a biocidal mixture that comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and, optionally, a Thiobacillus spp in a liquid suspension; and applying, such as by spraying, wetting, or soaking, said biocidal mixture on the plant, such as on the leaves, stems, roots, or flowers or on soil in proximity to a plant or on soil having insects or fungus.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and, optionally, a Thiobacillus spp. in a liquid suspension, further comprise determining or monitoring the reduction or inhibition of insects and/or fungus after applying said biocidal mixture.

Determining or monitoring the reduction or inhibition of insects and/or fungus comprises physically looking for signs of pest damage or potential pest problems after application. After application of a biocidal mixture, determining or monitoring the reduction or inhibition of insects and/or fungus is done frequently, preferably every 1-10 days, 1-9 days, 1-8 days, 1-7 days, 1-6 days, 1-5 days, or 1-4 days, and more preferably every 1-3 days or 1-2 days. Monitoring comprises examining all aspects of the plant, such as the leaves of plants, the seeds of plants, the roots of plants, and the stems of the plants. Some pests require specialized equipment, well known in the art, to detect. An example of such equipment is a shovel or trowel for detecting underground insects such as wireworm, white grub, seed corn maggot, seed corn beetle, black cutworm, and rootworm larvae. Another monitoring method involves burying a grain in a mesh material. Carbon dioxide is given off by the seed as it begins to sprout, attracting larvae of certain insects, which can then be detected feeding on the grain contained in the mesh material. Pheromone traps can also be used to monitor populations of certain insects. Blacklight traps, knives, and sweep nets are additional tools, among the many used to monitor crops for insect infestation or fungal disease.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. in a liquid suspension, further comprise identifying, selecting, or classifying a plant and/or soil for a reduction of insects and/or a fungus. Such an identification comprises physically looking for signs of pest damage or potential pest problems. Disease spotting is done frequently throughout the growing season, preferably every 1-10 days, 1-9 days, 1-8 days, 1-7 days, 1-6 days, 1-5 days, or 1-4 days, and more preferably every 1-3 days or 1-2 days. Disease spotting comprises examining all aspects of the plant, such as the leaves of plants, the seeds of plants, the roots of plants, and the stems of the plants. Some pests require specialized equipment, well known in the art, to detect. An example of such equipment is a shovel or trowel for detecting underground insects such as wireworm, white grub, seed corn maggot, seed corn beetle, black cutworm, and rootworm larvae. Another monitoring method involves burying a grain in a mesh material. Carbon dioxide is given off by the seed as it begins to sprout, attracting larvae of certain insects, which can then be detected feeding on the grain contained in the mesh material. Pheromone traps can also be used to monitor populations of certain insects. Blacklight traps, knives, and sweep nets are additional tools, among the many used to monitor crops for insect infestation or fungal disease.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. in a liquid suspension, further comprise mixing said biocidal mixture with an esterified seed oil, neem oil, a petroleum oil, or an essential oil.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. in a liquid suspension, further comprise mixing said biocidal mixture with Potassium salts of fatty acids, neem oil fatty acids, essential oil fatty acids, petroleum fatty acids, or paraffin fatty acids.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. in a liquid suspension, further comprise mixing said biocidal mixture with a non-ionic surfactant, an anionic surfactant, or a cationic surfactant, preferably, akyl aryl polyethoxylate, a silicone-based surfactant, or a polysorbate, such as polysorbate 20.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. in a liquid suspension, further comprise mixing said biocidal mixture with Pinene (terpene) polymers, petrolatum a-(p-Dodecylphenyl-Omega-hydroxypoly (oxyethylene), also known as Sustain.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., further comprises a pesticide. In some embodiments, the pesticide comprises Benlate, Captan, Malathion, Pyrethrin, Azadirachtin, Abamectin, Acephate, or Bacillus thuringiensis.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp., further comprises a fertilizer. In some embodiments the fertilizer comprises nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate.

In some embodiments, the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips are practiced by applying a biocidal mixture comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and a Thiobacillus spp., which may be resident to said mineral complex or added exogenously to said biocidal mixture.

In certain embodiments, the mineral complex described in the methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips herein comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel. In more embodiments, a mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, a mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes described for use with the embodiments herein further comprise a Thiobacillus spp.

The mineral complexes can undergo a pre-processing by, for example, grinding, milling and sizing the material. Finer particles of the mineral complex provide a larger surface area for the minerals in the complex to interact with fungus and/or insects, allowing more efficient dispersion and dissolution of soluble components in blending. In some embodiments, ore samples can be crushed using an impact crusher to material <3 inches, further ground, and screened for material <⅛^{th} inch. In some embodiments, mineral complexes are further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

Mineral complexes are blended, mixed, or coated by a variety of methods. In certain embodiments, the mineral complex described herein is mixed, blended, coated with or coated on the granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a variety of rates and ratios so as to produce biocidal mixtures. In certain embodiments, soil amendments or fertilizers are produced by blending a mineral complex at a rate of 1, 2, 3, 4, 5, 6, 7, 8, 9, 10, 11, or 12 tons per 24 ton portion of the biocidal mixture. In particular embodiments, soil amendments or fertilizers are produced by mixing, blending, contacting, or coating a mineral complex and a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of about 1:200, 1:100, 1:50 1:20, 1:10, 1:9, 1:8, 1:7, 1:6, 1:5, 1:4, 1:3, 1:2, or 1:1. In preferred embodiments, the mineral complex are mixed, blended, contacted, or coated with a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer at a ratio of about 1:5, 1:4, 1:3, 1:2, and 1:1. In another embodiment, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer are mixed, blended, contacted, or coated with the mineral complex at a ratio of about 1:200, 1:100, 1:50 1:20, 1:10, 1:9, 1:8, 1:7, 1:6, 1:5, 1:4, 1:3, 1:2, and 1:1. In preferred embodiments, a granule, pellet, powder, prill, or liquid suspension of one or more of a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain; a pesticide, such as Benlate, Captan, Malathion, Pyrethrin, Azadirachtin, Abamectin, Acephate, or Bacillus thuringiensis; and/or a fertilizer is mixed, blended, contacted, or coated with the mineral complex at a ratio of about 1:5, 1:4, 1:3, 1:2, and 1:1.

In a certain embodiment, the method comprises coating a granule, pellet, powder, or prill comprising a fertilizer, such as nitrogen, including ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), including potash, humate, humic acid, humin, and/or fulvic acid with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. In another embodiment, the method comprises coating the aforementioned mineral complex with a granule, pellet, powder, or prill comprising the fertilizer, such as nitrogen (N), such as ammonium nitrate (33.5-0-0), ammonium sulfate (21-0-0), urea nitrogen (46-0-0), sodium nitrate (16-0-0); Phosphorous (P) or Phosphate (P2O5), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate; potassium (K), such as potash, Humate, Humic acid, Humin, and/or Fulvic acid, such as humate, humic acid, humin, fulvic acid, nitro humic acid, potassium humate, sodium humate, or potassium fulvate.

Methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips using one or more of the biocidal mixtures described herein can be applied to various farming methods and systems. It should be understood that the methods can be performed at any scale, for example, methods for applying biocidal mixtures can be carried out at industrial scales where many tons are processed, to non-commercial scales where quarts or pints may be processed. Systems and methods of applying biocidal mixtures or fungicides are well known in the art.

Some methods for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, comprise a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel is prepared in a liquid suspension. The mineral complex is applied via foliar application to coffee plants infected with Roya fungus, tomato plants infected with powdery mildew, potatoes infected with blight, and/or roses infected with rust. In another method for inhibiting, ameliorating, preventing, or treating a plant and/or soil for insect infestation and/or fungal disease, such as scab, powdery mildew, downy mildew, rust, Roya Fungus, blight, brown rot, leaf spots, mites, flies, scales, psyllids, or thrips, a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. is mixed with one or more surfactants, such as a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain prepared in a liquid suspension to create a biocidal mixture. The biocidal mixture is applied via foliar application to coffee plants infected with Roya fungus, tomato plants infected with powdery mildew, potatoes infected with blight, and/or roses infected with rust. In separate experiments, the coffee plants infected with Roya fungus, tomato plants infected with powdery mildew, potatoes infected with blight, and/or roses infected with rust treated with the mineral complex described herein and the coffee plants infected with Roya fungus, tomato plants infected with powdery mildew, potatoes infected with blight, and/or roses infected with rust treated with the biocidal mixture described herein is compared with a spray comprising Copper Sulfate, which is applied via foliar application to coffee plants infected with Roya fungus, tomato plants infected with powdery mildew, potatoes infected with blight, and/or roses infected with rust and/or a spray comprising sulfur that is applied via foliar application to coffee plants infected with Roya fungus, tomato plants infected with powdery mildew, potatoes infected with blight, and/or roses infected with rust. The level of disease and plant growth is determined one week after foliar application. It will be seen that the mineral complex described herein and the biocidal mixture described herein will inhibit the fungus, blight, and mildew more effectively and allow for greater plant growth than the copper sulfate or sulfur spray. It will also be seen that the biocidal mixture described herein will provide the greatest inhibition and promote the best growth.

Improvement of Soil Contaminated with a Petroleum Containing Material

It has been discovered that by applying a mineral complex (e.g. a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel with or without a Thiobacillus spp.) to a petroleum-containing material, e.g., oil, the mineral complex promotes the decomposition of the petroleum-containing material, e.g., oil, to non-hazardous organic matter that will support seed germination and/or plant growth. By this process, an improved method for treating soil that has been contaminated with a petroleum-containing material, e.g., oil, is obtained.

The methods provided herein comprise a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp. In preferred embodiments, the mineral complex is in a form suitable for application to an oil spill, such as a liquid suspension, granule, pellet, or powder. In preferred embodiments, the mineral complex comprises Thiobacillus spp, which may be resident to said mineral complex or added exogenously thereto.

With respect to the mineral complex used in the embodiments described herein, the mineral complex comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from Zinc, Iron, Iron Sulfate, Manganese, Copper, Boron, Molybdenum, Selenium, and Nickel.

In more embodiments, a mineral complex used in the embodiments described herein comprises at least, greater than, or equal to 8% Potassium, at least, greater than, or equal to 50% Sulfur, at least, greater than, or equal to 17% Calcium Sulfate. Some such mineral complexes can also comprise at least, greater than, or equal to 2% micronutrients, where the micronutrients can comprise one or more minerals selected from the group consisting of Iron, Zinc, Copper, Manganese, Boron, Magnesium, Sodium, and Molybdenum. In even more embodiments, a mineral complex used in the embodiments described herein comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and at least, greater than, or equal to 3.4% Thiosulfite. Some of the mineral complexes used in the embodiments described herein further comprise a Thiobacillus spp, which may be resident to said mineral complex or added exogenously thereto.

A variety of plant nutrients can be blended or mixed with or, in some embodiments, coated on the mineral complexes described herein so as to provide improved formulations for remediation, amelioration, or treatment of soil contaminated with a petroleum-containing material, e.g., oil. As used herein “plant nutrients” and grammatical equivalents thereof, can refer to nutrients that supply one or more chemicals or substances essential or helpful in plant growth and/or plant health and are not generally supplied through carbon dioxide or water. In preferred embodiments, the plant nutrients used in the embodiments described herein comprise one or more or a combination of urea, phosphate, phosphorous, humate, humic acid, humin, and/or fulvic acid. In preferred embodiments, the plant nutrients used in the embodiments described herein comprise one or more of a combination of nitrogen, such as ammonium nitrate (33.5-0-0), ammonium sulfate (21-0-0), urea nitrogen (46-0-0), sodium nitrate (16-0-0), Phosphorous (P) or Phosphate (P₂O₅), such as superphosphate (OSP), concentrated superphosphate (CSP), Monoammonium Phosphate (MAP), Diammonium Phosphate (DAP), Ammonium Polyphosphate (APP), or rock Phosphate, including soft rock Phosphate, and/or potassium (K), such as potash. In more embodiments, the plant nutrients used in the embodiments described herein comprise one or more or a combination of Nitrogen (“N”); Phosphorus (“P”); Potassium (“K”); Calcium (“Ca”); Magnesium (“Mg”); Sulfur (“S”); Boron (“B”); Chlorine (“Cl”); Copper (“Cu”); Iron (“Fe”); Manganese (“Mn”); Molybdenum (“Mo”); Zinc (“Zn”); and Nickel (“Ni”). Certain ratios of the aforementioned components are in a form and amount that provides nutrients that aid or promote plant growth.

Certain embodiments comprise containers comprising a mineral complex provided herein. Examples of containers comprise, but are not limited to, boxes, crates, and bags. Containers can comprise mineral complex, wherein the amount of mineral complex is less than, greater than, equal to or any number at least, greater than, or equal 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb. The following section provides more disclosure on a method of making the mineral complexes, which can be used in the methods described herein.

The methods for remediation, amelioration or treatment of soil contaminated with a petroleum-containing material, e.g., oil, comprise providing and/or making the mineral complex, which may include pre-processing mineral complexes prior to contacting the petroleum-containing material, e.g., oil. In certain embodiments, a mineral complex used in the embodiments described herein comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel. In more embodiments, a mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, a mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes further comprise a Thiobacillus spp.

The mineral complexes can undergo a pre-processing by, for example, grinding, milling, crushing, and/or sizing the material. Finer particles of the mineral complex provide a larger surface area for the minerals in the complex, allowing more efficient dispersion and dissolution of soluble components in blending. In some embodiments, ore samples containing said mineral complex are crushed using an impact crusher to material <3 inches, further ground, and screened for material <⅛^{th} inch. In some embodiments, mineral complexes are further milled and screened for particles using a screen with a mesh size of at least, greater than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh (US standard units).

The methods provided above can further comprise bagging and/or packaging the resultant mineral complexes. Mineral complexes can be bagged or packaged into containers, for instance. Examples of containers comprise, but are not limited to, boxes, crates, and bags. Containers can comprise mineral complexes, wherein the amount of mineral complex can be less than, greater than, equal to or any number in between 1 lb, 5 lb, 10 lb, 15 lb, 20 lb, 25 lb, 30 lb, 35 lb, 40 lb, 45 lb, 50 lb, 55 lb, 60 lb, 65 lb, 70 lb, 75 lb, 80 lb, 85 lb, 90 lb, 95 lb, 100 lb, or 500 lb.

Some methods for making the mineral complexes described herein can be particularly useful for reducing odors associated with a petroleum-containing material, e.g., oil. However, some of the methods provided herein reduce the amount of odor and or volatiles produced or emitted by the petroleum-containing material, e.g., oil, such as, during treatment of the contaminated soil. In particular embodiments, the volume or amount of a gas, which is released by the petroleum-containing material, e.g., oil, is significantly reduced. In more embodiments, the amount of a volatile component of said petroleum-containing material, e.g., oil, is significantly reduced such as a VOC and/or benzene, toluene, ethylbenzene, and xylenes (BTEX), as well, as n-hexane. Accordingly some approaches concern methods of reducing the emission of a volatile component of a petroleum-containing material, e.g., oil including but not limited to a VOC and/or benzene, toluene, ethylbenzene, and xylenes (BTEX), and/or n-hexane comprising contacting said soil contaminated with a petroleum-containing material, e.g., oil, with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp thereby reducing emission of a VOC and/or benzene, toluene, ethylbenzene, and xylenes (BTEX), and/or n-hexane. In some embodiments, the amount of a VOC and/or benzene, toluene, ethylbenzene, and xylenes (BTEX), and/or n-hexane is measured after contacting said contaminated soil with said mineral complex. The following section provides more detail on methods to remove, ameliorate, remediate, or clean-up soil contaminated with a petroleum-containing material, e.g., oil.

Some embodiments comprise methods for removing, remediating, ameliorating or cleaning-up soil that comprises a petroleum-containing material, e.g., oil, by contacting said petroleum-containing material, e.g., oil, with one or more of the mineral complexes described herein for a period sufficient to degrade the petroleum-containing material, e.g., oil, such as for at least equal to or any time in between 1, 2, 3, 4, 5, 6, 7, 8, 9, 10, 11, 12, 13, or 14 days. The mineral complexes provided herein promote the decomposition of the petroleum-containing material, e.g., oil, into an organic matter that supports seed germination and/or plant growth. Particular methods comprise providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and contacting said mineral complex with a petroleum-containing material, e.g., oil for a period of time that is at least, equal to, or any time in between 1, 2, 3, 4, 5, 6, 7, 8, 9, 10, 11, 12, 13, 14 days.

As used herein “oil” and grammatical equivalents thereof, refers to liquid petroleum hydrocarbon. This includes naturally occurring unprocessed crude oils and their by-products, petroleum products that are made up of refined crude oil and their by-products, heavier oils such as bunker fuel, any oily refuse, or any petroleum-based or synthetic oil. in some contexts, oil or a petroleum-containing material can include liquid, gaseous, and solid hydrocarbons, as well as, oil sands such as bitumen, extra heavy oil, or the effluent produced during fracking or natural gas recovery.

In certain embodiments, a mineral complex comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel. In more embodiments, a mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, a mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes described for use with the embodiments herein further comprise a Thiobacillus spp.

Some embodiments of the methods for removing, remediating, ameliorating, or cleaning-up a petroleum-containing material, e.g., oil, comprise a mineral complex that is provided in a liquid suspension, granule, or powder. Some embodiments of the methods for removing, remediating, ameliorating, or cleaning-up a petroleum-containing material, e.g., oil, comprise a mineral complex with a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In some embodiments, the methods for using said mineral complex to remove, remediate, or clean-up an oil spill, said mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, further comprise contacting said oil with a Thiobacillus spp.

In some embodiments, said petroleum-containing material, e.g., oil, does not need to be removed from a site of the oil spill after contact with said mineral complex comprising any of the combinations mentioned herein.

In some embodiments, said petroleum-containing material, e.g., oil, is degraded to non-hazardous and/or non-toxic organic matter after contact with said mineral complex comprising any of the combinations mentioned herein.

In more embodiments, said mineral complex that is used to remove, remediate, ameliorate, or clean-up the petroleum-containing material, e.g., oil, comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel, and said mineral complex is left in contact with said oil spill for at least 3, 4, 5, 6, 7, 8, 9, 10, 11, 12, 13, or 14 days.

In more embodiments, the methods for using said mineral complex to remove, remediate, ameliorate, or clean-up sol that is contaminated with a petroleum-containing material, e.g., oil, produces a soil that supports seed germination and/or plant growth after said mineral complex is left in contact with said petroleum-containing material, e.g., oil, for at least 3, 4, 5, 6, 7, 8, 9, 10, 11, 12, 13, or 14 days.

Some methods comprise the step of identifying and/or selecting a soil that is contaminated with a petroleum-containing material, e.g., oil, such that said identified and/or selected site will benefit from an application of the mineral complexes described herein. Such methods of selection and/or identification can comprise testing the nutrient content of the soil and/or the amount of a petroleum-containing material, e.g., oil, or a component thereof such as a VOC and/or benzene, toluene, ethylbenzene, and xylenes (BTEX), and/or n-hexane. Measuring the amount of a petroleum-containing material, e.g., oil, at a site, such as in a soil, can be used to determine the amount and rate at which the mineral complex should be applied. Other factors can include the type of plant, wildlife, or vegetation that is present at the site. In certain embodiments, the pH of a soil can determine the amount and rate at which the mineral complex may be applied to a soil.

In particular embodiments, the mineral complex is contacted with the petroleum-containing material, e.g., oil, at a rate of about 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, and 900 lb/acre to a soil, where the soil has a pH of about 6.3-6.8.

In more embodiments, the mineral complex is contacted with the petroleum-containing material at a rate of about 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, and 1100 lb/acre to a soil, where the soil has a pH of about 6.8-7.3.

In more embodiments, the mineral complex is contacted with the petroleum-containing material at a rate of about 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, and 2100 lb/acre to a soil, where the soil has a pH of about 7.3-7.7.

In more embodiments, the mineral complex is contacted with the petroleum-containing material at a rate of about 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, and 3100 lb/acre to a soil, where the soil has a pH of about 7.8-8.9.

Methods to apply a mineral complex described herein to a plant or soil are also embodiments. In one example, drop spreaders and spinner spreaders are used. In some embodiments, the mineral complexes are applied with plow-down, disking, injection, chiseling or knifing into the soil. In some embodiments, the mineral complexes are applied in bands at the bottom of plough furrows, or broadcast, or spread on top of ploughed soil. For deep soil application, this can then be worked into the soil with a harrow before planting. In some embodiments, the mineral complexes will be liquid and is applied with spray cans, sprinklers, or furrow irrigation or foliar application.

Aspects of the invention also include methods for restoring fertile soil after contamination with a petroleum-containing material, e.g., oil, comprising: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally a Thiobacillus spp; and contacting soil that has been contaminated with the contacted with the petroleum-containing material with said mineral complex.

In more embodiments, the methods for restoring fertile soil after contamination with a petroleum-containing material, e.g., oil, comprises: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally a Thiobacillus spp.; and contacting soil that has been contaminated with a petroleum-containing material, e.g., oil, with said mineral complex, wherein the mineral complex is provided in a liquid suspension, granule, or powder. In some embodiments, the mineral complex that is contacted with said petroleum-containing material, e.g., oil, has a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In more embodiments, the methods for restoring fertile soil after a soil has been contaminated with a petroleum-containing material, e.g., oil, comprises: providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally, a Thiobacillus spp.; contacting soil that has been contaminated with said petroleum-containing material, e.g., oil, with said mineral complex; and contacting said petroleum-containing material, e.g., oil, with a Thiobacillus spp, which may be a bacteria resident to said mineral complex or may be provided to said petroleum-containing material, e.g., oil, separately.

In some embodiments, soils contaminated with naturally occurring unprocessed crude oils and/or their by-products, or petroleum products that are made up of refined crude oil and their by-products, as well as, heavier oils, such as bunker fuel, oily refuse, or petroleum-based or synthetic oils are effectively treated and/or ameliorated by the contact with said mineral complexes. This includes all liquid, gaseous, and solid hydrocarbons, as well as, oil sands such as bitumen or extra heavy oil or effluent produced by fracking or natural gas recovery.

In certain embodiments, the mineral complex used in these embodiments includes at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel. In more embodiments, the mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, the mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes used in embodiments described herein further comprise a Thiobacillus spp.

In some embodiments, the restoration of fertile soil after the soil was contaminated by a petroleum-containing material, e.g., oil, is rapid and is performed in situ such that the petroleum-containing material, e.g., oil, is not removed from the contaminated site after contact with said mineral complex. In some embodiments of the method of restoring fertile soil after contamination with a petroleum-containing material, e.g., oil, the oil is degraded into non-hazardous and/or non-toxic organic matter in situ after contact with said mineral complex comprising any of the combinations mentioned herein, such as within at least or equal to or any time in between 1, 2, 3, 4, 5, 6, 7, 8, 9, 10, 11, 12, 13, or 14 days.

In preferred embodiments, the methods for restoring fertile soil after an oil spill comprises leaving the mineral complex in contact with said oil spill for at least 3, 4, 5, 6, 7, 8, 9, or 10 days.

In more embodiments, fertile soil is restored to the point that it supports seed germination and/or plant growth after the mineral complex is left in contact with said petroleum-containing material, e.g., oil, for at least or equal to or any time in between 1, 2, 3, 4, 5, 6, 7, 8, 9, 10, 11, 12, 13, or 14 days.

Some methods comprise identifying and/or selecting a site or soil that will benefit from an application of a mineral complex so as to treat, remediate, or ameliorate contamination by the petroleum-containing material, e.g., oil. Such methods may, optionally, include testing the nutrient content of a site and/or the amount of a petroleum-containing material, e.g., oil or a by-product thereof including a VOC and/or benzene, toluene, ethylbenzene, and xylenes (BTEX), and/or n-hexane. Measuring the amount of petroleum-containing material, e.g., oil or by-product thereof found at a site, such as in a soil, can be used to determine the amount and/or rate at which the mineral complex should be applied to the petroleum-containing material, e.g., oil, or contaminated soil. Other factors can include the type of plant, wildlife, or vegetation that is present at the site. In certain embodiments, the pH of a soil can determine the amount and rate at which the mineral complex may be applied to a soil.

In particular embodiments, the mineral complex is contacted with a petroleum-containing material, e.g., oil, at a rate of about 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, and 900 lb/acre to a soil, where the soil has a pH of about 6.3-6.8.

In more embodiments, the mineral complex contacted with a petroleum-containing material, e.g., oil, at a rate of about 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, and 1100 lb/acre to a soil, where the soil has a pH of about 6.8-7.3.

In more embodiments, the mineral complex is contacted with a petroleum-containing material, e.g., oil, at a rate of about 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, and 2100 lb/acre to a soil, where the soil has a pH of about 7.3-7.7.

In more embodiments, the mineral complex is contacted with a petroleum-containing material, e.g., oil, at a rate of about 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, and 3100 lb/acre to a soil, where the soil has a pH of about 7.8-8.9.

Methods to apply a mineral complex described herein to a plant that is in contact with a soil that is contaminated with a petroleum-containing material, e.g., oil, or a soil that is contaminated with a a petroleum-containing material, e.g., oil, are also embodiments. In one example, drop spreaders and spinner spreaders are used. In some embodiments, the mineral complexes are applied with plow-down, disking, injection, chiseling or knifing into the soil. In some embodiments, the mineral complexes are applied in bands at the bottom of plough furrows, or broadcast, or spread on top of ploughed soil. For deep soil application, this can then be worked into the soil with a harrow before planting. In some embodiments, the mineral complexes will be liquid and is applied with spray cans, sprinklers, or furrow irrigation or foliar application.

Aspects of the invention also concern methods for growing a plant on soil that is contaminated with a petroleum-containing material, e.g., oil, comprising: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally a Thiobacillus spp.; and germinating a seed or growing a plant in said soil after contacting said soil with said mineral complex, preferably after at least or equal to or any number in between 1, 2, 3, 4, 5, 6, 7, 8, 9, 10, 11, 12, 13, or 14 days.

In more embodiments, the methods for growing a plant on soil that is contaminated with a petroleum-containing material, e.g., oil, comprise: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and, optionally a Thiobacillus spp.; and germinating a seed or growing a plant in said soil after contacting said soil with said mineral complex, wherein said mineral complex is provided in a liquid suspension, granule, or powder.

In more embodiments, the methods for growing a plant on a soil that is contaminated with a petroleum-containing material, e.g., oil, comprises utilization of one or more of the aforementioned mineral complexes that have a screen size of less than, or equal to 50 mesh, 60 mesh, 70 mesh, 80 mesh, 100 mesh, 120 mesh, 140 mesh, 150 mesh, 170 mesh, 200 mesh, 230 mesh, 250 mesh, 270 mesh, 300 mesh, 325 mesh, 350 mesh, 400 mesh, 500 mesh, or 632 mesh.

In more embodiments, the methods for growing a plant on a soil that is contaminated with a petroleum-containing material, e.g., oil, comprise: contacting the contaminated soil with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and germinating a seed or growing a plant in said soil after contacting said soil with said mineral complex, wherein said contaminated soil is also contacted with a Thiobacillus spp, which may be resident to said mineral complex or may be exogenously added.

In some of these embodiments, soil that is contaminated with naturally occurring unprocessed crude oils and/or their by-products, petroleum products that are made up of refined crude oil and their by-products, heavier oils, such as bunker fuel, oily refuse, or petroleum-based or synthetic oils are degraded or rendered non-hazardous by contact with one or more of the mineral complexes described herein. Additionally, soils contaminated with a liquid, gaseous, and/or solid hydrocarbons, as well as, oil sands such as bitumen or extra heavy oil or effluent produced by oil or gas recovery programs, such as fracking are suitable for remediation by simply contacting said a petroleum-containing materials with one or more of the mineral complexes described herein.

In certain embodiments, the mineral complex used in the methods described herein comprises at least, greater than, or equal to 3%, 4%, 5%, 6%, 7%, 8, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% elemental Sulfur; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% Thiosulfate; at least, greater than, or equal to 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% Sulfate; at least, greater than, or equal to 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% Calcium Sulfate; at least greater than or equal to 3%, 4%, 5%, 6%, 7%, 8%, 9%, or 10% soluble Calcium; at least, greater than, or equal to 8%, 9%, 10%, 11%, 12%, 13%, 14%, or 15% Potassium as Potassium Sulfate, Aluminum Potassium Sulfate, and/or Potassium Silicate. Some such mineral complexes can further comprise one or more minerals selected from the group consisting of Zinc, Iron, Iron Sulfate, Manganese, Copper, Boron, Molybdenum, Selenium, and Nickel. In more embodiments, the mineral complex comprises at least, greater than, or equal to 8% Potassium, at least, greater than, or equal to 50% Sulfur, at least, greater than, or equal to 17% Calcium Sulfate. Some such mineral complexes also contain at least, greater than, or equal to 2% micronutrients, wherein the micronutrients are one or more minerals selected from the group consisting of Iron, Zinc, Copper, Manganese, Boron, Magnesium, Sodium, and Molybdenum. In even more embodiments, a mineral complex comprises at least, greater than, or equal to 8% Sulfate, at least, greater than, or equal to 7% Sulfur Trioxide, at least, greater than, or equal to 16% elemental Sulfur, at least, greater than, or equal to 9% Potash, at least, greater than, or equal to 2% Bisulfite, and/or at least, greater than, or equal to 3.4% Thiosulfite. Some of the mineral complexes described herein further comprise a Thiobacillus spp.

In some embodiments of the methods for growing a plant on soil contaminated with a petroleum-containing material, e.g., oil, the petroleum-containing material, e.g., oil, is not removed from the contaminated site after contact with said mineral complex. In some embodiments of the methods for restoring fertile soil after contamination with a petroleum-containing material, e.g., oil, the petroleum-containing material, e.g., oil, is degraded into a non-hazardous and/or a non-toxic organic matter after contact with said mineral complex.

In more embodiments, the methods for growing a plant on soil contaminated with a petroleum-containing material, e.g., oil, further comprises leaving the mineral complex in contact with said contaminated soil for at least 3, 4, 5, 6, 7, 8, 9, 10, 11, 12, 13, or 14 days before planting a seed or plant.

Some methods comprise identifying and/or selecting a site or soil that will benefit from an application of one or more of the mineral complexes described herein. Such methods include testing the nutrient content of a site or soil and/or the amount of a petroleum-containing material, e.g., oil at said site or soil. Measuring the amount of a petroleum-containing material, e.g., oil, found in a site, such as in a soil, can be used to determine the amount and rate at which the mineral complex should be applied. Other factors can include the type of plant, wildlife, or vegetation that is present at the site. In certain embodiments, the pH of a soil can determine the amount and rate at which the mineral complex may be applied.

In particular embodiments, the mineral complex is contacted with a petroleum-containing material, e.g., oil, at a rate of about 400 lb/acre, 410 lb/acre, 420 lb/acre, 430 lb/acre, 440 lb/acre, 450 lb/acre, 460 lb/acre, 470 lb/acre, 480 lb/acre, 490 lb/acre, 500 lb/acre, 510 lb/acre, 520 lb/acre, 530 lb/acre, 540 lb/acre, 550 lb/acre, 560 lb/acre, 570 lb/acre, 580 lb/acre, 590 lb/acre, 600 lb/acre, 610 lb/acre, 620 lb/acre, 630 lb/acre, 640 lb/acre, 650 lb/acre, 660 lb/acre, 670 lb/acre, 680 lb/acre, 690 lb/acre, 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, and 900 lb/acre to a soil, where the soil has a pH of about 6.3-6.8.

In more embodiments, the mineral complex is contacted with a petroleum-containing material, e.g., oil, at a rate of about 700 lb/acre, 710 lb/acre, 720 lb/acre, 730 lb/acre, 740 lb/acre, 750 lb/acre, 760 lb/acre, 770 lb/acre, 780 lb/acre, 790 lb/acre, and 800 lb/acre, 810 lb/acre, 820 lb/acre, 830 lb/acre, 840 lb/acre, 850 lb/acre, 860 lb/acre, 870 lb/acre, 880 lb/acre, 890 lb/acre, 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, and 1100 lb/acre to a soil, where the soil has a pH of about 6.8-7.3.

In more embodiments, the mineral complex is contacted with a petroleum-containing material, e.g., oil, at a rate of about 900 lb/acre, 910 lb/acre, 920 lb/acre, 930 lb/acre, 940 lb/acre, 950 lb/acre, 960 lb/acre, 970 lb/acre, 980 lb/acre, 990 lb/acre, 1000 lb/acre, 1010 lb/acre, 1020 lb/acre, 1030 lb/acre, 1040 lb/acre, 1050 lb/acre, 1060 lb/acre, 1070 lb/acre, 1080 lb/acre, 1090 lb/acre, 1100 lb/acre, 1110 lb/acre, 1120 lb/acre, 1130 lb/acre, 1140 lb/acre, 1150 lb/acre, 1160 lb/acre, 1170 lb/acre, 1180 lb/acre, 1190 lb/acre, 1200 lb/acre, 1210 lb/acre, 1220 lb/acre, 1230 lb/acre, 1240 lb/acre, 1250 lb/acre, 1260 lb/acre, 1270 lb/acre, 1280 lb/acre, 1290 lb/acre, 1300 lb/acre, 1310 lb/acre, 1320 lb/acre, 1330 lb/acre, 1340 lb/acre, 1350 lb/acre, 1360 lb/acre, 1370 lb/acre, 1380 lb/acre, 1390 lb/acre, 1400 lb/acre, 1410 lb/acre, 1420 lb/acre, 1430 lb/acre, 1440 lb/acre, 1450 lb/acre, 1460 lb/acre, 1460 lb/acre, 1480 lb/acre, 1490 lb/acre, 1500 lb/acre, 1510 lb/acre, 1520 lb/acre, 1530 lb/acre, 1540 lb/acre, 1550 lb/acre, 1560 lb/acre, 1570 lb/acre, 1580 lb/acre, 1590 lb/acre, 1600 lb/acre, 1610 lb/acre, 1620 lb/acre, 1630 lb/acre, 1640 lb/acre, 1650 lb/acre, 1660 lb/acre, 1670 lb/acre, 1680 lb/acre, 1690 lb/acre, 1700 lb/acre, 1710 lb/acre, 1720 lb/acre, 1730 lb/acre, 1740 lb/acre, 1750 lb/acre, 1760 lb/acre, 1770 lb/acre, 1780 lb/acre, 1790 lb/acre, 1800 lb/acre, 1810 lb/acre, 1820 lb/acre, 1830 lb/acre, 1840 lb/acre, 1850 lb/acre, 1860 lb/acre, 1870 lb/acre, 1880 lb/acre, 1890 lb/acre, 1900 lb/acre, 1910 lb/acre, 1920 lb/acre, 1930 lb/acre, 1940 lb/acre, 1950 lb/acre, 1960 lb/acre, 1970 lb/acre, 1980 lb/acre, 1990 lb/acre, 2000 lb/acre, 2010 lb/acre, 2010 lb/acre, 2020 lb/acre, 2030 lb/acre, 2040 lb/acre, 2050 lb/acre, 2060 lb/acre, 2070 lb/acre, 2080 lb/acre, 2090 lb/acre, and 2100 lb/acre to a soil, where the soil has a pH of about 7.3-7.7.

In more embodiments, the mineral complex is contacted with a petroleum-containing material, e.g., oil, at a rate of about 2100 lb/acre, 2110 lb/acre, 2120 lb/acre, 2130 lb/acre, 2140 lb/acre, 2150 lb/acre, 2160 lb/acre, 2170 lb/acre, 2180 lb/acre, 2190 lb/acre, 2200 lb/acre, 2210 lb/acre, 2220 lb/acre, 2230 lb/acre, 2240 lb/acre, 2250 lb/acre, 2260 lb/acre, 2270 lb/acre, 2280 lb/acre, 2290 lb/acre, 2300 lb/acre, 2310 lb/acre, 2320 lb/acre, 2330 lb/acre, 2340 lb/acre, 2350 lb/acre, 2360 lb/acre, 2370 lb/acre, 2380 lb/acre, 2390 lb/acre, 2400 lb/acre, 2410 lb/acre, 2420 lb/acre, 2430 lb/acre, 2440 lb/acre, 2450 lb/acre, 2460 lb/acre, 2460 lb/acre, 2480 lb/acre, 2490 lb/acre, 2500 lb/acre, 2510 lb/acre, 2520 lb/acre, 2530 lb/acre, 2540 lb/acre, 2550 lb/acre, 2560 lb/acre, 2570 lb/acre, 2580 lb/acre, 2590 lb/acre, 2600 lb/acre, 2610 lb/acre, 2620 lb/acre, 2630 lb/acre, 2640 lb/acre, 2650 lb/acre, 2660 lb/acre, 2670 lb/acre, 2680 lb/acre, 2690 lb/acre, 2700 lb/acre, 2710 lb/acre, 2720 lb/acre, 2730 lb/acre, 2740 lb/acre, 2750 lb/acre, 2760 lb/acre, 2770 lb/acre, 2780 lb/acre, 2790 lb/acre, 2800 lb/acre, 2810 lb/acre, 2820 lb/acre, 2830 lb/acre, 2840 lb/acre, 2850 lb/acre, 2860 lb/acre, 2870 lb/acre, 2880 lb/acre, 2890 lb/acre, 2900 lb/acre, 2910 lb/acre, 2920 lb/acre, 2930 lb/acre, 2940 lb/acre, 2950 lb/acre, 2960 lb/acre, 2970 lb/acre, 2980 lb/acre, 2990 lb/acre, 3000 lb/acre, 3010 lb/acre, 3010 lb/acre, 3020 lb/acre, 3030 lb/acre, 3040 lb/acre, 3050 lb/acre, 3060 lb/acre, 3070 lb/acre, 3080 lb/acre, 3090 lb/acre, and 3100 lb/acre to a soil, where the soil has a pH of about 7.8-8.9.

Methods to apply a mineral complex described herein to a plant that is in contact with a soil that is contaminated with a petroleum-containing material, e.g., oil, or soil that is contaminated with a petroleum-containing material, e.g., oil, are also embodiments. In one example, drop spreaders and spinner spreaders are used. In some embodiments, the mineral complexes are applied with plow-down, disking, injection, chiseling or knifing into the soil. In some embodiments, the mineral complexes are applied in bands at the bottom of plough furrows, or broadcast, or spread on top of ploughed soil. For deep soil application, this can then be worked into the soil with a harrow before planting. In some embodiments, the mineral complexes will be liquid and is applied with spray cans, sprinklers, or furrow irrigation or foliar application.

Some methods for treating or ameliorating contamination by a petroleum-containing material, e.g., oil, comprise applying a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. Various amounts of mineral complex have been applied to oil spills on fertile soil, for example, and after 72 hours it was found that the oil spill was decomposed in situ such that the remaining residue and mineral complex did not need to be removed and said treated soil supported seed germination and/or plant growth. In separate experiments, where the improvement of plant growth and crop yield of plants (e.g. grass or sugar beets) treated with a mineral complex made by the approach described herein after an oil spill is compared to plant growth and crop yield of plants (e.g. grass or sugar beets) not treated with mineral complex after an oil spill, it will be seen that germination and plant growth occurs in the field experiment with the mineral complex treated oil spill and germination and plant growth does not occur in the field experiment with the untreated oil spill. The mineral complex is applied to soil in a separate field trial than the untreated oil spills. The fields are chosen based on their similarity in soil composition and character prior to the oil spill. The soil in both field trials is contaminated with the same type and amount of oil at the same rate of application. The soil in one field trial is treated with the mineral complex described herein that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. The soil in the other field is not treated with the mineral complex after the oil application. Grass seed is then spread on both fields using the same rate of application and the same amount of grass seed. Growth characteristics, disease resistance, and yield and quality are monitored for two weeks. It will be determined that the oil spill treated with the mineral complex made in accordance with the teachings herein provides for germination of plant seed and plant growth, whereas the untreated oil spill will not support germination and/or plant growth.

### EXAMPLES

### Example 1—Mineral Complex

In this Example, a soil amendment or fertilizer comprising a mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and Urea was prepared. Granules, pellets, powders, or prills of urea were obtained from a commercially available source and the urea was blended or mixed with the mineral complex. The mineral complex readily absorbed to the urea and the resultant fertilizer or soil amendment retained its granular, pellet, powder, or prill form. The absorption of the mineral complex to the urea can be improved by tumbling the urea with the mineral complex and, optionally, one or more coatings can be applied to the co-formulated mineral complex and urea, for example, to create a single cote or multicote granule.

### Example 2—Improved Crop Yields with Mineral Complex

The improvement of plant growth and crop yield of plants (e.g., potatoes or sugar beets) fertilized with a soil amendment or fertilizer made by the approach described in Example 1 is compared to the plant growth and crop yield of plants (e.g., potatoes or sugar beets) fertilized with a urea fertilizer alone, and plants fertilized with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. The three fertilizer or soil amendments are applied to the soil near the plants in separate field trials. The rate of application of the fertilizer or soil amendment made in accordance with Example 1 is adjusted to match the rate of application of the urea fertilizer. That is, the amount of urea provided by either the fertilizer or soil amendment made in accordance with Example 1 and the urea fertilizer is the same. Similarly, the rate of application of the mineral complex is adjusted to match the rate of application of the fertilizer or soil amendment made in accordance with Example 1 so that the amount of the mineral complex applied to the plants in the separate field trials are the same. Growth characteristics, disease resistance, and crop yield and quality is monitored.

It will be determined that the fertilizer or soil amendment made in accordance with Example 1 provides greater plant growth, plant quality, and larger crop yield, characterized by for example, greater weight and/or greater sugar content, as compared to the urea fertilizer alone or the mineral complex alone. It will also be determined that the fertilizer or soil amendment made in accordance with Example 1 will give less nitrogen burning than the urea fertilizer alone despite having applied the same amount of urea. In separate plant field tests (e.g., potatoes or sugar beets), wherein the amount of urea provided by the fertilizer or soil amendment made in accordance with Example 1 is varied and compared to the same amount of urea provided by the urea fertilizer alone, it will be determined that equivalent plant growth, plant quality, and crop yield, characterized by for example, greater weight and/or greater sugar content, can be obtained with the fertilizer or soil amendment made in accordance with Example 1 having significantly lower amounts of urea than that provided by the urea fertilizer. Accordingly, it will be determined that the fertilizer or soil amendment made in accordance with Example 1 will be subject to less decomposition or volatilization of urea than conventional urea fertilizer.

### Example 3—Humate Containing Mineral Complex

In this Example, a soil amendment or fertilizer comprising a mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and Humate was prepared. Granules, pellets, powders, or prills of Humate were obtained from a commercially available source and the Humate was blended or mixed with the mineral complex. The mineral complex readily mixed with the Humate and the resultant fertilizer or soil amendment retained its granular, pellet, powder, or prill form. The absorption of the mineral complex to the Humate can be improved by tumbling the Humate with the mineral complex and, optionally, one or more coatings can be applied to the co-formulated mineral complex and Humate, for example, to create a single cote or multicote granule.

### Example 4—Improved Crop Yields with Humate Containing Mineral Complex

The improvement of plant growth and crop yield of plants (e.g., potatoes or sugar beets) fertilized with a soil amendment or fertilizer made by the approach described in Example 3 is compared to the plant growth and crop yield of plants (e.g., potatoes or sugar beets) fertilized with a Humate fertilizer alone, and plants fertilized with a mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. The three fertilizer or soil amendments are applied to the soil near the plants in separate field trials. The rate of application of the fertilizer or soil amendment made in accordance with Example 3 is adjusted to match the rate of application of the Humate fertilizer. That is, the amount of Humate provided by either the fertilizer or soil amendment made in accordance with Example 3 and the Humate fertilizer is the same. Similarly, the rate of application of the mineral complex is adjusted to match the rate of application of the fertilizer or soil amendment made in accordance with Example 3 so that the amount of the mineral complex applied to the plants in the separate field trials are the same. Growth characteristics, disease resistance, and crop yield and quality is monitored.

It will be determined that the fertilizer or soil amendment made in accordance with Example 3 provides greater plant growth, plant quality, and larger crop yield, characterized by for example, greater weight and/or greater sugar content, as compared to the humate fertilizer alone or the mineral complex alone. It will also be determined that the fertilizer or soil amendment made in accordance with Example 3 will provide more bioavailability than the humate fertilizer alone despite having applied the same amount of humate. In separate plant field tests (e.g., potatoes or sugar beets), wherein the amount of humate provided by the fertilizer or soil amendment made in accordance with Example 3 is varied and compared to the same amount of humate provided by the humate fertilizer alone, it will be determined that equivalent plant growth, plant quality, and crop yield, characterized by for example, greater weight and/or greater sugar content, can be obtained with the fertilizer or soil amendment made in accordance with Example 3 having significantly lower amounts of humate than that provided by the humate fertilizer. Accordingly, it will be determined that the fertilizer or soil amendment made in accordance with Example 3 will have increased bioavailability of soil nutrients than conventional humate fertilizer.

### Example 5—Analysis of Humate Containing Soil Amendments Applied to Waste

The soil amendment or fertilizer made by the approaches described in Example 3 and Example 4 are applied to waste in a swine operation, bovine operation, and in a poultry house. The operations are composted for a cycle of 30 days. The concentration of nutrients resulting from the approach described in Example 3 are compared to the concentration of nutrients resulting from Humate alone, and the concentration of nutrients resulting with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone.

The three fertilizer or soil amendments are applied to the swine, bovine, and/or poultry waste in separate trials. The amount of Humate provided by either the fertilizer or soil amendment made in accordance with Example 3 and the Humate fertilizer is the same. Similarly, the amount of the mineral complex is adjusted to match the amount of the fertilizer or soil amendment made in accordance with Example 3 so that the amount of the mineral complex applied to the poultry waste, bovine waste, and/or swine waste in the separate field trials are the same. Concentration of nutrients, disease resistance, odor and pathogen content is monitored.

It will be determined that the fertilizer or soil amendment made in accordance with Example 3 provides greater concentration of nutrients, characterized by for example, higher nitrogen, phosphorus, and/or potassium content, as compared to the humate fertilizer alone or the mineral complex alone. It will also be determined that the fertilizer or soil amendment made in accordance with Example 3 will provide greater bioavailability than the humate fertilizer alone despite having applied the same amount of humate. It will also be determined that the fertilizer or soil amendment made in accordance with Example 3 will provide less odor, as characterized by, for example, an olfactometer, as compared to the humate fertilizer alone or the mineral complex alone. Additionally, it will be determined that the fertilizer or soil amendment made in accordance with Example 3 will provide less pathogens, as characterized by, for example, the amount of yeast, bacteria, mold, fungi, virus, protozoa, and/or helminths.

### Example 6—Phosphate Containing Mineral Complex

In this Example, a soil amendment or fertilizer comprising a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel and Phosphorus were prepared. Granules, pellets, powders, or prills of Phosphorous were obtained from a commercially available source and the Phosphorous was blended or mixed with the mineral complex. The mineral complex readily absorbed to the Phosphorous and the resultant fertilizer or soil amendment retained its granular, pellet, powder, or prill form. The absorption of the mineral complex to the Phosphorous can be improved by tumbling the Phosphorous with the mineral complex and, optionally, one or more coatings can be applied to the co-formulated mineral complex and Phosphorous, for example, to create a single cote or multicote granule.

### Example 7—Improved Crop Yields with Phosphate Containing Mineral Complex

The improvement of plant growth and crop yield of plants (e.g., potatoes or sugar beets) fertilized with a soil amendment or fertilizer made by the approach described in Example 6 is compared to the plant growth and crop yield of plants (e.g., potatoes or sugar beets) fertilized with a Phosphorous fertilizer alone, and plants fertilized with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel alone. The three fertilizer or soil amendments are applied to the soil near the plants in separate field trials. The rate of application of the fertilizer or soil amendment made in accordance with Example 6 is adjusted to match the rate of application of the Phosphorous fertilizer. That is, the amount of Phosphorus provided by either the fertilizer or soil amendment made in accordance with Example 6 and the Phosphorous fertilizer is the same. Similarly, the rate of application of the mineral complex is adjusted to match the rate of application of the fertilizer or soil amendment made in accordance with Example 6 so that the amount of the mineral complex applied to the plants in the separate field trials are the same. Growth characteristics, disease resistance, and crop yield and quality is monitored.

It will be determined that the fertilizer or soil amendment made in accordance with Example 6 provides greater plant growth, plant quality, and larger crop yield, characterized by for example, greater weight and/or greater sugar content, as compared to the Phosphorous fertilizer alone or the mineral complex alone. It will also be determined that the fertilizer or soil amendment made in accordance with Example 6 will provide more bioavailability than the Phosphorous fertilizer alone despite having applied the same amount of Phosphorus. In separate plant field tests (e.g., potatoes or sugar beets), wherein the amount of Phosphorus provided by the fertilizer or soil amendment made in accordance with Example 6 is varied and compared to the same amount of Phosphorus provided by the Phosphorous fertilizer alone, it will be determined that equivalent plant growth, plant quality, and crop yield, characterized by for example, greater weight and/or greater sugar content, can be obtained with the fertilizer or soil amendment made in accordance with Example 6 having significantly lower amounts of Phosphorus than that provided by the Phosphorous fertilizer. Accordingly, it will be determined that the fertilizer or soil amendment made in accordance with Example 6 will have increased bioavailability of Phosphorus than conventional phosphorous fertilizer.

### Example 8—Biocidal Mixture

In this Example, a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, Nickel and a Thiobacillus spp. was prepared in a liquid suspension and mixed with the adjuvant petrolatum a-(p-Dodecylphenyl-Omega-hydroxypoly (oxyethylene), also known as Sustain. The biocidal mixture was applied via foliar application to coffee plants that were selected as plants infected with Roya fungus. It was determined that the biocidal mixture effectively inhibited the Roya fungus and promoted new plant growth. In some embodiments, the mineral complex that is provided is coated with one or more coatings and the coated mineral complex is provided in the biocidal mixture.

### Example 9—Biocidal Mixture Application

In this Example, a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, Nickel and a Thiobacillus spp. is mixed with one or more of a surfactant, such as a liquid surfactant, adjuvant, oil, or fatty acid; esterified seed oil, neem oil, a petroleum oil, or an essential oil; Potassium salts of fatty acids, neem oil fatty acids, essential oil fatty acids, petroleum fatty acids, or paraffin fatty acids; non-ionic surfactant, an anionic surfactant, or a cationic surfactant, preferably, akyl aryl polyethoxylate, a silicone-based surfactant, or a polysorbate, such as polysorbate 20; Pinene (terpene) polymers, petrolatum a-(p-Dodecylphenyl-Omega-hydroxypoly (oxyethylene), also known as Sustain and the formulation is prepared in a liquid suspension to create a biocidal mixture. The biocidal mixture is applied via foliar application to tomato plants and potato plants infected with powdery mildew and/or blight. It will be seen that the biocidal mixture preparation will effectively inhibit powdery mildew and/or blight on the tomato and potato plants.

### Example 10—Biocidal Mixture Application

In this Example, the coffee plants infected with Roya fungus are contacted with the biocidal mixture prepared as described in Example 8 or 9 and the effects on the Roya fungus in this first test field are compared to the level or amount of inhibition of the Roya fungus on coffee plants treated with a spray comprising Copper Sulfate (control) in a second field. The level of disease and plant growth is monitored daily for one week after foliar application and it will be seen that the biocidal mixture prepared as described in Examples 8 and 9 will inhibit the Roya fungus and promote greater plant growth than the coffee plants contacted with the Copper sulfate, which is the accepted treatment methodology for Roya fungus.

### Example 11—Mineral Complex Oil Contact

In this Example, a mineral complex comprising 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel was prepared. Oil was applied to fertile soil. The aforementioned mineral complex was then placed in contact with the oil. After 72 hours it was seen that the oil had degraded. In some embodiments, the mineral complex that is provided is coated with one or more coatings and the coated mineral complex is provided or contacted with oil or a petroleum product-containing soil.

### Example 12—Mineral Complex Oil Treatment

In this example, oil that is treated with the mineral complex described in Example 11 is compared to oil that did not receive contact with said mineral complex. Separate field trials are conducted, wherein the application of the mineral complex set forth in Example 11 to oil that has been applied to soil is compared to oil that has been applied to soil without receiving treatment with the mineral complex. The fields are chosen based on their similarity in soil composition and character prior to applying the oil. The soil in both fields is contaminated with the same type and amount of oil at the same rate of application. The mineral complex set forth in Example 11, is then applied to one field but not the other field (control). After 72 hours, it will be seen that the oil-contaminated field, which was not treated with the mineral complex (control), has little or no evidence of decomposition or degradation of the oil. In contrast, the oil-contaminated field that was treated with the mineral complex, will show significant decomposition and/or degradation after the 72 hour test period. Accordingly, it will be determined that oil, which is contacted with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel will be treated and remediated in situ in a short period of time, as compared to oil-contaminated soil, which did not receive the mineral complex.

### Example 13

Seed germination and/or plant growth (e.g. grass or sugar beets) in oil-contaminated soil that is treated with the mineral complex set forth in Example 11 is evaluated and compared to oil-contaminated soil that does not receive treatment with the mineral complex set forth in Example 11. In separate fields of same soil composition, oil is applied at the same rate. After application of the oil and penetration into the soil, one field (experimental) is contacted with a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel. The second oil-contaminated field (control) is not treated with the mineral complex. After 72 hours from the application of the mineral complex to the first field, grass seed is sown on both fields at the same rate of application such that the same amount of grass seed is applied to both the experimental and control fields. The growth characteristics, disease resistance, and quality of plant growth are then monitored for two weeks. It will be determined that experimental field will have significant seed germination and plant growth, whereas, the control field, which lacked application of the mineral complex, will show very little if any seed germination and/or plant growth.

1. A fertilizer or soil amendment comprising:
a mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and
1-9% humic acid; and
1-2% fulvic acid,
wherein said fertilizer or soil amendment is in a granule, pellet, powder, prill, or a liquid suspension.

2. The fertilizer or soil amendment of claim 1, wherein the 1-9% humic acid is in isolated form.

3. The fertilizer or soil amendment of claim 1, wherein the 1-2% fulvic acid is in isolated form.

4. The fertilizer or soil amendment of claim 1 comprising 7-9% humic acid.

5. The fertilizer or soil amendment of claim 4, wherein the 7-9% humic acid is in isolated form.

6. The fertilizer or soil amendment of claim 1, wherein said fertilizer or soil amendment does not contain plant fiber.

7. The fertilizer or soil amendment of claim 1, wherein said fertilizer or soil amendment further comprises Nitrogen (N), Phosphorous (P), Phosphate (P2O5), or Potassium (K).

8. The fertilizer or soil amendment of claim 1, wherein said fertilizer or soil amendment further comprises a Thiobacillus species.

9. The fertilizer or soil amendment of claim 1, wherein said fertilizer or soil amendment is a granule, pellet, powder, or prill and said granule, pellet, powder, or prill further comprises a coating, which comprises a polymer, surfactant, sugar, starch, fat, fatty acid, cellulose, soap, or wax.

10. A method of using the fertilizer or soil amendment of claim 1 to amend a soil or to promote plant growth comprising:
providing a fertilizer or soil amendment as set forth in claim 1; and
contacting a soil or plant with said fertilizer or soil amendment.

11. A method of making the fertilizer or soil amendment of claim 1 comprising:
providing a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel;
providing 7-9% humic acid and 1-2% fulvic acid in isolated form;
contacting said mineral complex with said 7-9% humic acid and 1-2% fulvic acid in isolated form; and
generating a granule, pellet, powder, prill, or a liquid suspension that comprises said mineral complex and said 7-9% humic acid and 1-2% fulvic acid in isolated form.

12. The method of claim 11, wherein said fertilizer or soil amendment does not contain a plant fiber.

13. The method of claim 11, wherein said fertilizer or soil amendment further comprises nitrogen (N), Phosphorous (P), Phosphate (P2O5) or potassium (K).

14. The method of claim 11, wherein said fertilizer or soil amendment further comprises a Thiobacillus species.

15. The method of claim 11, wherein said fertilizer or soil amendment is a granule, pellet, powder, or prill and said granule, pellet, powder, prill further comprises a coating, which comprises a polymer, surfactant, sugar, starch, fat, fatty acid, cellulose, soap or wax.

16. A biocide liquid suspension comprising:
a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel; and
a surfactant, adjuvant, oil, or fatty acid, wherein said biocide is formulated into a liquid suspension.

17. The biocide of claim 16, wherein said biocide comprises an esterified seed oil, neem oil, or an essential oil.

18. The biocide of claim 16, wherein said biocide comprises Potassium salts of fatty acids, neem oil fatty acids, essential oil fatty acids, or paraffin fatty acids.

19. A method of making a biocide liquid suspension comprising:
mixing a mineral complex that comprises 3-35% elemental Sulfur, 5%-90% Thiosulfate, 8%-70% Sulfate, 5%-35% Calcium Sulfate, 3%40% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel with a liquid surfactant, adjuvant, oil, or fatty acid, so as to form a liquid suspension of said biocide.

20. A method of inhibiting a fungal disease on a plant comprising:
contacting the plant or soil in proximity to the plant with a biocide, which comprises a mineral complex that comprises 3-35% elemental Sulfur, 5%-90% Thiosulfate, 8%-70% Sulfate, 5%-35% Calcium Sulfate, 3%-10% soluble Calcium, 8%-15% Potassium as Potassium Sulfate, Aluminum Potassium Sulfate, Potassium Silicate, Zinc, Iron, Iron Sulfate, Manganese, Copper, Boron, Molybdenum, and Nickel mixed with a liquid surfactant, adjuvant, oil, or fatty acid.
